(19) United States
(12) Patent Application Publication
(10) Pub. No.: US 2010/0075049 A1
(43) Pub. Date: Mar. 25, 2010

(54) INKJET RECORDING METHOD

(75) Inventor: Hideki KAIMOTO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/554,999

(22) Filed: Sep. 8, 2009

(30) Foreign Application Priority Data
Sep. 25, 2008 (JP) 2008-246530

(51) Int. Cl. B05D 5/06

(52) U.S. Cl. 427/258; 427/256

(57) ABSTRACT

The present invention provides an inkjet recording method that includes imparting a yellow ink that contains a water soluble azo dye represented by the following Formula (Y-I) in an amount of 50% by mass or more with respect to a total amount of yellow dye in the yellow ink by use of an inkjet method on a recording medium containing a support and an ink receiving layer disposed on the support and containing polyallylamine derivative, with which high image density is obtained and discoloration after image recording is inhibited from occurring;

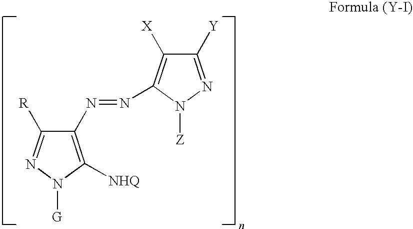

wherein, in Formula (Y-I), G represents a heterocyclic group, R, X, Y, Z and Q each independently represent a substituent, and n represents an integer of 1 to 3.

### CROSS-REFERENCE TO RELATED APPLICATION

This application claims priority under 35 USC 119 from Japanese Patent Application No. 2008-246530 filed on Sep. 25, 2008, the disclosure of which is incorporated by reference herein.

### BACKGROUND OF THE INVENTION

1. Field of the Invention

The present invention relates to an inkjet recording method.

2. Description of the Related Art

Accompanying recent rapid progress in the communication industry, various information processing systems have been developed, and various recording methods and devices suitable for use in these information processing systems have also been developed and are already in use. Among the recording methods above, for example, the inkjet recording process has been widely used not only in office use but also in so-called home use, because the inkjet process allows printing on various recording materials and the hardware (devices) therefor is relatively cheaper, more compact, and more silent.

In addition, accompanying the recent trend of inkjet printers toward higher resolution, there are some inkjet printers available that allow printing of so-called photographic-like high-quality images, and accompanying the progress of the hardware (devices), a variety of media for inkjet recording has been developed.

Generally properties that are required for a recording sheet for use in inkjet recording include (1) high drying speed (high ink-absorbing speed), (2) favorable and uniform ink dot diameter (without ink bleeding), (3) favorable granularity, (4) high dot circularity, (5) high color density, (6) high color saturation (absence of dullness), (7) excellent water resistance, light fastness and ozone gas resistance of printed image portions, (8) higher whiteness of the recording sheet, (9) favorable storage stability of the recording sheet (absence of yellowing and image bleeding during long term storage), (10) deformation resistance and favorable dimensional stability (suppressed curling), (11) favorable traveling characteristics through a machine, and the like. In addition, for application as photographic glossy sheets, which are used for printing so-called photographic-like high-quality images, glossiness, surface smoothness, a texture similar to silver halide photographic paper, and the like are also demanded in addition to the properties above.

In recent years, an inkjet recording medium having a porous structure in an ink receiving layer has been developed to improve the various properties described above and has been put to practical use. When the inkjet recording medium has such a porous structure, excellent ink receiving property (quick-drying property) and high glossiness are obtained.

However, image storability is still insufficient as compared with a silver salt photograph, and large improvement thereof is demanded. As for the image storability, the light resistance to deterioration caused by light has been considered important. However, a recording material comprising a colorant-receiving layer having a porous structure as described above has many voids, whereby a recorded image may be discolored owing to traces of various gases in the air in some cases. In particular, ozone is a main factor in the time-lapse discoloration of a recorded image. Accordingly, resistance to ozone in the air (ozone resistance) is a very important property for a recording material having the aforementioned colorant-receiving layer having a porous structure.

A recording medium incorporating polyallylamine has been proposed to improve such ozone resistance (see, for example, Japanese Patent Application Laid-Open (JP-A) Nos. 7-266689, 2003-300380 and 2008-132787).

### SUMMARY OF THE INVENTION

According to the invention, there is provided an inkjet recording method capable of obtaining high image density and of inhibiting discoloration (color drift) from occurring after image recording. More specifically, according to an aspect of the invention, an inkjet recording method including recording an image, on a recording medium containing a support and an ink receiving layer that is disposed on the support and contains a polyallylamine derivative, by imparting a yellow ink that contains a water soluble azo dye represented by the following Formula (Y-I) in an amount of 50% by mass or more with respect to a total amount of yellow dye in the yellow ink by use of an inkjet method.

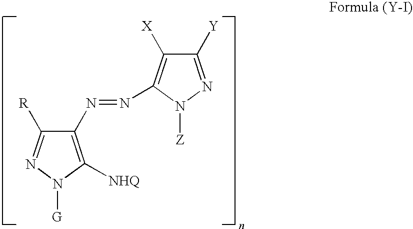

wherein, in Formula (Y-I), G represents a heterocyclic group; R, X, Y, Z and Q each independently represent a substituent; n represents an integer of 1 to 3; in a case where n is 1, R, X, Y, Z, Q and G each independently represent a monovalent substituent; in a case where n is 2, R, X, Y, Z, Q and G each independently represent a monovalent substituent or a divalent substituent, provided that at least one of R, X, Y, Z, Q and G represents a divalent substituent; and in a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

### DETAILED DESCRIPTION

In the recording medium described in each of patent literatures described above, while the ozone resistance is improved to some extent, however, sufficient density is not obtained or discoloration is caused after image recording, in some cases when the recording medium is used in inkjet recording in a combination with a specific dye in particular.

The invention intends to provide an inkjet recording method capable of obtaining high image density and of inhibiting occurrence of discoloration (color drift) after image recording.

The inventors studied hard and found that the foregoing problems are addressed by the following items <1> to <13>.

<1> An inkjet recording method including recording an image, on a recording medium containing a support and an ink receiving layer that is disposed on the support and contains a polyallylamine derivative, by imparting a yellow ink that contains a water soluble azo dye represented by the following Formula (Y-I) in an amount of 50% by mass or more with respect to a total amount of yellow dye in the yellow ink by use of an inkjet method.

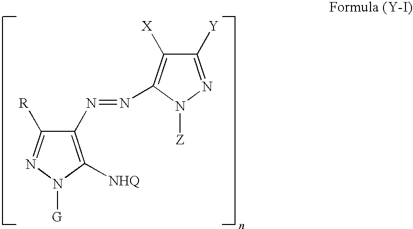

In Formula (Y-I), G represents a heterocyclic group; R, X, Y, Z and Q each independently represent a substituent; n represents an integer of 1 to 3; in a case where n is 1, R, X, Y, Z, Q and G each independently represent a monovalent substituent; in a case where n is 2, R, X, Y, Z, Q and G each independently represent a monovalent substituent or a divalent substituent, provided that at least one of R, X, Y, Z, Q and G represents a divalent substituent; and in a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

<2> The inkjet recording method of the item <1>, wherein the recording includes recording an image by use of an ink set that contains: the yellow ink; a cyan ink that contains a water soluble phthalocyanine dye represented by the following Formula (C-I) in an amount of 50% by mass or more with respect to a total amount of cyan dye in the cyan ink; a magenta ink that contains a water soluble azo dye represented by the following Formula (M-I) in an amount of 50% by mass or more with respect to a total amount of magenta dye in the magenta ink; and a black ink that contains a water soluble azo dye represented by the following Formula (B-I) in an amount of 50% by mass or more with respect to a total amount of black dye in the black ink.

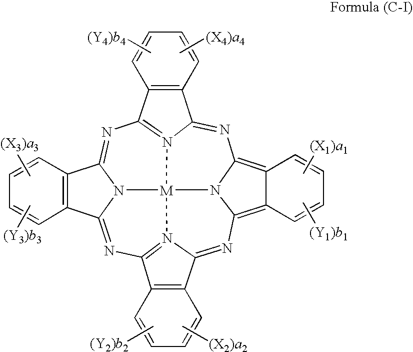

In Formula (C-I), each of X₁, X₂, X₃ and X₄ independently represents any of SO-Z, —SO₂-Z, —SO₂NV₁V₂, —CONV₁V₂, —CO₂Z, —CO-Z, or a sulfo group; Z independently represents an alkyl group, a cycloalkyl group, an alkenyl group, an alkynyl group, an aralkyl group, an aryl group, or a heterocyclic group; V₁ and V₂, which may be the same or different, each represent a hydrogen atom, an alkyl group, a cycloalkyl group, an alkenyl group, an alkynyl group, an aralkyl group, an aryl group, or a heterocyclic group; each of Y₁, Y₂, Y₃ and Y₄ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, of which each group may further have a substituent; a₁ to a₄ and b₁ to b₄ respectively represent numbers of substituents of X₁ to X₄ and Y₁ to Y₄, each of a₁ to a₄ independently representing an integer of from 0 to 4, provided that all of a₁ to a₄ do not represent 0 at the same time, and each of b₁ to b₄ independently representing an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent;

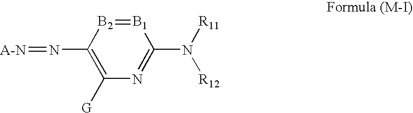

wherein, in Formula (M-I), A represents a residue of a 5-membered heterocyclic diazo component A-NH₂; each of B₁ and B₂ independently represents —CR₁₃═ or CR₁₄═, or either one represents a nitrogen atom and the other represents —CR₁₃═ or —CR₁₄═; each of R₁₁ and R₁₂ independently represents a hydrogen atom, an alkyl group, a cycloalkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, an arylsulfonyl group, or a sulfamoyl group, of which each group may further have a substituent; each of G, R₁₃ and R₁₄ independently represents a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, a nitro group, an alkylthio group, an arylthio group, an alkylsulfonyl group, an arylsulfonyl group, an alkylsulfinyl group, an arylsulfinyl group, a sulfamoyl group, a heterocyclic thio group, or an ionic hydrophilic group, of which each group may further have a substituent; and R₁₃ and R₁₁, or R₁₁ and R₁₂ may be bonded to each other form a 5- or 6-membered ring, provided that the dye represented by Formula (M-I) has at least one ionic hydrophilic group;

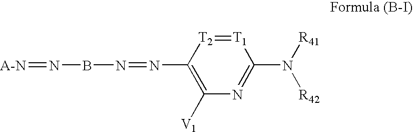

wherein, in Formula (B-I), A represents a monovalent aromatic group or heterocyclic group, and B represents a divalent aromatic group or heterocyclic group; T₁ and T₂ each independently represent ═CR₄₃— or —CR₄₄═, or either one of them represents a nitrogen atom and the other one represents ═CR₄₃— or —CR₄₄═; V₁, R₄₃, and R₄₄ each independently represent a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, a heterocyclic oxycarbonyl group, an acyl group, a hydroxy group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an alkylamino group, an arylamino group, and a heterocyclic amino group), an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfo group, of which each group may be further substituted; R₄₁ and R₄₂ each independently represent a hydrogen atom, an alkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, arylsulfonyl group, or a sulfamoyl group, of which each group may further have a substituent; R₄₁ and R₄₂ are not simultaneously hydrogen atoms; and R₄₃ and R₄₁ or R₄₁ and R₄₂ may be bonded to each other to form a 5- to 6-membered ring.

<3> The inkjet recording method of the items <1> or <2>, wherein the polyallylamine derivative comprises a structural unit derived from allylamine and a structural unit derived from dialkylallylamine.

<4> The inkjet recording method of any one of the items <1> to <3>, wherein a weight-average molecular weight of the polyallylamine derivative is 2,000 or less.

<5> The inkjet recording method of any one of the items <1> to <4>, wherein a content of the polyallylamine derivative in the ink receiving layer is in a range of from 0.01 g/m² to 2 g/m²

<6> The inkjet recording method of any one of the items <1> to <5>, wherein an oxidation potential of the water soluble azo dye represented by Formula (Y-I) is more noble than 1.0 V (vs SCE).

<7> The inkjet recording method of item <2>, wherein an oxidation potential of each of the water soluble phthalocyanine dye represented by Formula (C-I), the water soluble azo dye represented by Formula (M-I) and the water soluble azo dye represented by Formula (B-I) is more noble than 1.0 V (vs SCE).

<8> The inkjet recording method of any one of the items <1> to <7>, wherein, in Formula (Y-I), G represents a group derived from an S-triazine ring, a pyrimidine ring, a pyridazine ring, or a pyrazine ring; R represents a straight chain or branched alkyl group having 1 to 8 carbon atoms; X represents a cyano group or an alkylsulfonyl group having 1 to 12 carbon atoms; Y represents a hydrogen atom or a straight chain or branched alkyl group having 1 to 8 carbon atoms; Z represents a substituted aryl group or a substituted heterocyclic group; Q represents a hydrogen atom, a substituted or unsubstituted alkyl group or a substituted or unsubstituted acyl group; and n represents 1 or 2.

<9> The inkjet recording method of any one of the items <1> to <8>, wherein a surface tension of the yellow ink at 20° C. is in a range of 20 mN/m to 70 mN/m.

<10> The inkjet recording method of item <2>, wherein Formula (C-I) is the following Formula (C-1);

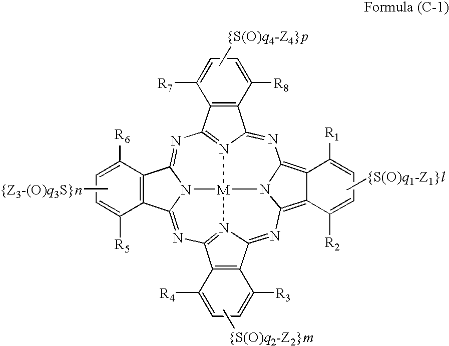

wherein in Formula (C-1), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃ or Z₄ has an ionic hydrophilic group as a substituent; each of l, m, n, p, q₁, q₂, q₃ and q₄ independently represents 1 or 2; and M has the same meaning as in Formula (C-I).

<11> The inkjet recording method of item <2>, wherein Formula (M-I) is the following Formula (M-1):

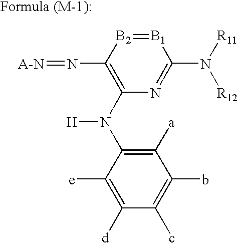

wherein in Formula (M-1), A, B₁, B₂, R₁₁ and R₁₂ each have the same meaning as A, B₁, B₂, R₁₁ and R₁₂ in Formula (M-I) respectively; each of a and e independently represents an alkyl group, an alkoxy group or a halogen atom, and in a case where both a and e represent an alkyl group, the total number of carbon atoms constituting the alkyl groups represented by a and e is 3 or more, which may further be substituted; each of b, c and d independently has the same meaning as R₁₁ and R₁₂ in Formula (M-I); and a and b, or e and d may be condensed to each other, provided that the dye represented by Formula (M-1) has at least one ionic hydrophilic group.

<12> The inkjet recording method of any one of the items <1> to <11>, wherein 50% by mass or more of the total amount of the polyallylamine derivative is contained in a region of the ink receiving layer extending to a depth of 10 μm from a surface of the ink receiving layer.

<13> The inkjet recording method of any one of the items <1> to <12>, wherein the recording medium is produced according to a producing method that includes coating a coating solution containing fine particles and a water soluble resin on the support; and coating a basic coating solution containing the polyallylamine derivative on the coated layer either (1) simultaneously with coating of the coating solution or (2) during drying of the coating solution coated on the support before a decreasing rate of drying is exhibited.

An inkjet recording method of the present invention includes a step of imparting a yellow ink by use of an inkjet recording method on a recording medium that contains a support and an ink receiving layer containing a polyallylamine derivative disposed on the support to record an image, wherein the yellow ink contains a water-soluble azo dye represented by the following Formula (Y-I) in an amount of 50% by mass or more with respect to a total amount of yellow dye in the yellow ink.

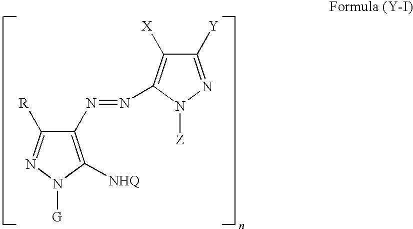

In Formula (Y-I), G represents a heterocyclic group. R, X, Y, Z and Q each independently represent a substituent. n represents an integer of 1 to 3. In a case where n is 1, R, X, Y, Z, Q and G each independently represent a monovalent substituent. In a case where n is 2, R, X, Y, Z, Q and G each independently represent a monovalent substituent or a divalent substituent, provided that at least one of R, X, Y, Z, Q and G represents a divalent substituent. In a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

When n is 2 or 3, the water-soluble azo dye represented by Formula (Y-I) has a structure in which one partial structure is linked to another partial structure(s) via the divalent or trivalent group(s) represented by R, X, Y, Z, Q and G, in which the partial structure has the structure shown in the parenthesis in Formula (Y-I) except for the divalent or trivalent group(s).

When an image is formed by imparting a yellow ink containing a water-soluble azo dye represented by Formula (Y-I) on a recording medium containing an ink receiving layer containing a polyallylamine derivative, an image that is high in image density, inhibited from discoloring (color drift) after image recording, and excellent in the ozone resistance may be formed.

[Recording Medium]

The recording medium in the invention includes a support and an ink receiving layer containing at least one of polyallylamine derivative disposed on the support.

The polyallylamine derivative is not particularly restricted as long as it is a polymer compound having a structural unit derived from allylamine. For example, a compound that is obtained by polymerizing a monomer shown below may be used.

Examples of the monomer constituting a polyallylamine derivative in the invention include allylamine, diallylamine, a derivative thereof (for example, dialkylallylamine), and a salt thereof. Specific examples thereof include allylamine, allylamine hydrochloride, allylamine acetate, allylamine sulfate, diallylamine, diallylamine hydrochloride, diallylamine acetate, diallylamine sulfate, diallylmethylamine and salts thereof (e.g., hydrochloride, acetate salts, and sulfate salts), diallylethylamine and salts thereof (e.g., hydrochloride, acetate salts, and sulfate salts), diallyldimethylammonium salts (counter anions thereof including chloride, acetate ions, and sulfate ions), dimethylallylamine, diethylallylamine and salts thereof. The allylamine and diallylamine derivatives are less polymerizable in the amine form, and thus are commonly polymerized in the salt form and desalted thereafter as required.

Any one of known various allylamine polymers and derivatives thereof may be used as the polyallylamine derivative of the invention. Examples of the derivatives include salts of polyallylamine with an acid (acids including inorganic acids such as hydrochloric acid, sulfuric acid, phosphoric acid, and nitric acid; and organic acids such as methanesulfonic acid, toluenesulfonic acid, acetic acid, propionic acid, cinnamic acid, and (meth)acrylic acid, or mixtures thereof or partial salts of polyallylamine); derivatives of polyallylamine formed owing to a polymerization reaction; copolymers of polyallylamine and other copolymerizable monomer (specific examples of the monomers including (meth)acrylic acid esters, styrenes, (meth)acrylamides, acrylonitrile, and vinyl esters).

Examples of the polyallylamine and derivatives thereof include compounds described in, for example, Japanese Patent Application Publication (JP-B) Nos. 62-31722, 2-14364, 63-43402, 63-43403, 63-45721, 63-29881, 1-26362, 2-56365, 2-57084, 4-41686, 6-2780, 6-45649, 6-15592, and 4-68622, Japanese Patent (JP) Nos. 9199227 and 3008369, JP-A Nos. 10-330427, 11-21321, 2000-281728, 2001-106736, 62-256801, 7-173286, 7-213897, 9-235318, 9-302026, 11-21321, WO99/21901, WO99/19372, JP-A No. 5-140213 and Japanese Patent National Phase Publication No. 11-506488.

The polyallylamine derivative in the invention is preferably a polyallylamine derivative containing at least one of a structural unit derived from allylamine and a structural unit derived from dialkylallylamine, and more preferably a polyallylamine derivative where an alkyl group of the dialkylallylamine has 1 to 3 carbon atoms, from the viewpoints of the image density and inhibiting discoloration (color drift) after image recording from occurring.

Furthermore, a weight-average molecular weight of the polyallylamine derivative in the invention is not particularly restricted. However, the weight-average molecular weight is preferably 5,000 or less, more preferably 2,000 or less, even more preferably from 500 to 2,000, and further more preferably from 500 to 1,500, from the viewpoints of the image density, inhibition of discoloration (color drift) after image recording, ink absorptivity and inhibition of bronze glossiness.

A content of the polyallylamine derivative in an ink receiving layer is not particularly restricted. However, the content is preferably from 0.01 g/m² to 2 g/m² and more preferably from 0.03 to 1 g/m², from the viewpoint of the image density and inhibition of discoloration (color drift) after image recording.

A distribution of the polyallylamine derivative in an ink receiving layer is not particularly restricted as long as the polyallylamine derivative is contained in the ink receiving layer. That is, the polyallylamine derivative may be distributed uniformly or non-uniformly in the ink receiving layer.

In the invention, an amount of the polyallylamine derivative contained in a region of the ink receiving layer extending to a depth of 10 μm from a surface (front face of the ink receiving layer) on a side opposite from a face facing the support, with respect to the total amount of the polyallylamine derivative in the ink receiving layer, is preferably 50% by mass or more and more preferably 75% by mass or more. When the polyallylamine derivative is present in the proximity of a surface of the recording medium, the image density is more effectively improved and the discoloration after image recording (color drift) is more effectively inhibited from occurring.

Herein, as a method of measuring a distribution of a polyallylamine derivative in the ink receiving layer, for example, a method where primary amino groups in a cross section of an ink receiving layer are chemically modified with an appropriate compound and thereafter a TOF-SIMS method is applied to measure is cited.

The ink receiving layer in the invention includes, in a region of the ink receiving layer extending to a depth of 10 μm from a surface of the ink receiving layer, preferably a polyallylamine derivative having a weight-average molecular weight of from 500 to 2,000 in an amount of 50% by mass or more of the total amount of the polyallylamine derivative, and more preferably a polyallylamine derivative having a weight-average molecular weight of from 500 to 1,500 in an amount of 75% by mass or more of the total amount of the polyallylamine derivative, from the viewpoints of image density and suppression of discoloration.

It is considered that the polyallylamine derivative in the invention works as a mordant and fixes a dye in the proximity of a surface of the ink receiving layer, and thereby the recorded image is improved in the density thereof and inhibited from discoloring.

The ink receiving layer in the invention may be constituted by containing, in addition to the polyallylamine derivative, as required, fine particles, a water-soluble resin, a crosslinking agent and other additives.

(Fine Particles)

The ink receiving layer in the present invention preferably contains at least one kind of fine particles. The fine particles have a function of enhancing ink absorbency by creating a porous structure in a case where the ink receiving layer is formed with them.

It is favorable when the solid content of the fine particles in the ink receiving layer is 50% by mass or more, and more preferably 60% by mass or more, because it becomes possible to create a better porous structure, and to contribute to formation of an inkjet recording material (recording medium) with sufficient ink absorptivity. Herein, the expression “solid content” of fine particles in the ink receiving layer refers to the content calculated on the basis of all ingredients except water in the composition for the ink receiving layer. As the fine particles in the invention, although any kind of organic particles or inorganic particles may be used, inorganic particles is preferably contained in the ink receiving layer from the viewpoints of ink absorptivity and image stability.

Preferable examples of the organic fine particles include polymer fine particles obtained by the emulsification polymerization, microemulsion polymerization, soap-free polymerization, seeds polymerization, dispersion polymerization or suspension polymerization. Specific examples thereof include powder of polyethylene, polypropylene, polystyrene, polyacrylate, polyamide, a silicone resin, a phenol resin, or a natural polymer, latexes, and polymer fine particles in the form of emulsion.

An average particle diameter of the organic fine particles is preferably 10 μm or less and more preferably in a range of from 0.2 μm to 5 μm.

Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Among these, silica fine particles, colloidal silica, alumina fine particles or pseudo-boehmite is preferred from the viewpoint of forming an excellent porous structure. The above fine particles may be used in the form of primary or secondary particles, and preferably have an average primary particle diameter of 2 μm or less and more preferably 200 nm or less.

In addition, silica fine particles having an average primary particle diameter of 30 nm or less, colloidal silica having an average primary particle diameter of 30 nm or less, alumina fine particles having an average primary particle diameter of 20 nm or less, and pseudo-boehmite having an average pore radius of 2 nm to 15 nm are preferred. Silica fine particles, alumina fine particles and pseudo-boehmite are particularly preferred.

Silica fine particles are commonly classified roughly into wet method particles and dry method (vapor phase process) particles according to the method of manufacture. By the wet method, silica fine particles are mainly produced by generating activated silica by acid decomposition of a silicate, polymerizing the activated silica to a proper degree, and coagulating the resulting polymeric silica to give hydrated silica. Alternatively by the vapor phase process, anhydrous silica particles are mainly produced by high-temperature vapor phase hydrolysis of a silicon halide (flame hydrolysis process), or by reductively heating and vaporizing quartz sand and coke in an electric furnace by applying an are discharge and then oxidizing the vaporized silica with air (arc method). The “vapor-phase process silica” means an anhydrous silica fine particle produced by a vapor phase process. As silica fine particles used in the present invention, the vapor-phase process silica is particularly preferable.

The vapor-phase process silica is different in the density of silanol groups on the surface and the presence of voids therein and exhibits different properties from hydrated silica. The vapor-phase process silica is suitable for forming a three-dimensional structure having a higher void percentage. The reason is not clearly understood. The hydrated silica fine particles have a higher density of 5 silanol groups/nm² to 8 silanol groups/nm² on their surface. Thus the silica fine particles tend to coagulate (aggregate) densely. While the vapor phase process silica particles have a lower density of 2 silanol groups/nm² to 3 silanol groups/nm² on their surface. Therefore, vapor-phase process silica seems to cause more scarce, softer coagulations (flocculates), consequently leading to a structure having a higher void percentage.

The vapor-phase process silica is particularly large in the specific surface area to be high in the ink absorptivity and retention efficiency, and is low in the refractive index and thereby, when it is dispersed to an appropriate particle diameter, transparency may be imparted to the receiving layer and high color density and excellent coloring properties are obtained. The transparency of the receiving layer is important not only in the usage such as OHP where the transparency is necessary but also in the case where the receiving layer is applied to a recording medium such as a photographic glossy sheet, from the viewpoints of obtaining high color density and excellent coloring glossiness.

The average primary particle diameter of the vapor-phase process silica particles is preferably 30 nm or less, more preferably 20 nm or less, particularly preferably 10 nm or less, and most preferably in a range of from 3 nm to 10 nm. In particular with the vapor-phase process silica, since the surface has silanol groups, there is easy adhesion between the particles through the hydrogen bonding of the silanol groups. Hence, if the average primary particle diameter of the particles is 30 nm or below, then a structure with high void percentage ratio of the ink receiving layer can be formed, and the ink absorption characteristics can be effectively raised.

Furthermore, silica fine particles may be used together with the other fine particles. When the other fine particles and the vapor-phase process silica are used together, a content of the vapor-phase process silica with respect to total of the fine particles is preferably 30% by mass or more, and more preferably 50% by mass or more.

Preferable examples of inorganic fine particles of the invention include alumina fine particles, alumina hydrate, mixtures thereof or composites thereof. Among these, alumina hydrate is preferred because it well absorbs an ink to fix. Pseudo-boehmite (Al₂O₃.nH₂O) is particularly preferred. The alumina hydrate may be used in various forms. Sol boehmite is preferably used as a raw material because a smooth layer is readily obtained.

A pore structure of pseudo-boehmite has an average pore radius preferably in the range of 1 nm to 30 nm and more preferably in the range of 2 nm to 15 nm. Furthermore, a pore volume thereof is preferably from 0.3 mL/g to 2.0 mL/g and more preferably from 0.5 mL/g to 1.5 mL/g. Herein, the pore radius and pore volume are measured according to a nitrogen absorption/desorption method using, for example, a gas absorption/desorption analyzer (such as “OMNISORP 369” (trade name, manufactured by Coulter Corporation)).

Among alumina fine particles, vapor-phase process alumina fine particles are preferred because of a large specific surface area thereof. An average primary particle diameter of the vapor-phase process alumina is preferably 30 nm or less and more preferably 20 nm or less.

An exemplary embodiment of the inkjet recording material using the fine particles in the invention is preferably applicable in the embodiments described in, for example, JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091 8-2093, 8-174992, 11-192777, 2001-301314.

(Water-Soluble Resin)

The ink receiving layer in the invention contains at least one kind of water-soluble resin. Examples of the water-soluble resins include polyvinyl alcohol resin having a hydroxy group as a hydrophilic structural unit such as polyvinyl alcohol (PVA), acetoacetic modified polyvinyl alcohols, cation modified polyvinyl alcohols, anion modified polyvinyl alcohols, silanol-modified polyvinyl alcohols, polyvinylacetal and the like; cellulosic resins such as methyl cellulose (MC), ethyl cellulose (EC), hydroxyethyl cellulose (HEC), carboxymethyl cellulose (CMC), hydroxypropyl cellulose (HPC), hydroxyethyl methyl cellulose, hydroxypropyl methyl cellulose and the like; chitins, chitosans, and starch; hydrophilic ether bond-containing resins such as polyethylene oxide (PEO), polypropylene oxide (PPO), polyethylene glycol (PEG), polyvinyl ether (PVE) and the like; carbamoyl group-containing resins such as polyacrylamide (PAAM), polyvinyl pyrrolidone (PVP), polyacrylic hydrazide and the like. Other examples include compounds having a carboxy group as a dissociative group such as polyacrylate salts, maleic acid resins, alginate salts, gelatins, and the like.

Among these resins, at least one kind of resin selected from polyvinyl alcohol resins, cellulose resins, ether bond-containing resins, carbamoyl group-containing resins, resins having carboxy groups or gelatins, notably polyvinyl alcohol (PVA) resins, is preferable as the water-soluble resin used in the invention.

Examples of the polyvinyl alcohol resins include the substances described in JP-B Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105, 11-348417, 58-181687, 10-259213, 2001-72711, 2002-103805, 2000-63427, 2002-308928, 2001-205919 and 2002-264489.

In addition, examples of water-soluble resins other than the polyvinyl alcohol resins include the compounds described in JP-A No. 11-165461, paragraphs [0011] and [0012], and the compounds described in JP-A Nos. 2001-205919 and 2002-264489.

These water-soluble resins may be used singly or in a combination of two or more of them. The water-soluble resin content in the invention is preferably from 9% by mass to 40% by mass, and more preferably from 12% by mass to 33% by mass, with respect to the total solid matter in the ink receiving layer.

In the invention, each of main components of the ink receiving layer, namely, the water-soluble resin and the fine particles, may be a single material, or a mixture of multiple materials may be used for each main component.

Additionally, the kind of water-soluble resin used in combination with the fine particles, and silica fine particles in particular, is important from the viewpoint of transparency retention. When the vapor-phase process silica is used, the water-soluble resin used in combination is preferably a polyvinyl alcohol resin, more preferably a polyvinyl alcohol resin having a saponification degree of from 70% to 100%, and particularly preferably a polyvinyl alcohol resin having a saponification degree of from 80% to 99.5%.

The polyvinyl alcohol resins have hydroxy groups in their respective structural units, and hydrogen bonds are formed between these hydroxy groups and silanol groups present on the surfaces of silica fine particles; as a result, it becomes easy to form a three-dimensional network structure having secondary particles of silica fine particles as network chain units. It is thought that formation of such a three-dimensional network structure allows the ink receiving layer formed to have a porous structure of a high void percentage and sufficient strength.

When inkjet recording is performed, the porous ink receiving layer formed in the foregoing manner can quickly absorb ink through capillary action and form dots of high circularity without generating ink bleeding.

The polyvinyl alcohol resin may be used in combination with other water-soluble resins. When another water-soluble resin is used in combination with the polyvinyl alcohol resin, the content of the polyvinyl alcohol resin is preferably 50% by mass or more, and more preferably 70% by mass or more with respect to the total mass of water-soluble resins used in the ink receiving layer.

(Ratio of Fine Particle Content to Water-soluble Resin Content)

The ratio of the fine particle content (x) by mass to the water-soluble resin content (y) by mass [PB ratio (x/y)] may affect significantly to the film structure and film strength of the ink receiving layer. In a larger content ratio [PB ratio (x/y)], although a lager void percentage, a bigger volume of fine pore, and a bigger surface area (per mass unit) of the ink receiving layer may be obtained, the density and the strength of the ink receiving layer, however, may be lowered.

In the invention, the ratio of mass content [PB ratio (x/y)] of the ink receiving layer is preferably in a range of from 1.5 to 10 from the viewpoints of preventing a decrease in film strength and the appearance of cracks under drying, which are caused by excessively high PB ratios, and avoiding a reduction in ink absorptivity by a decrease in void percentage resulting from a tendency to pores being clogged by the resins, which develops when PB ratios are excessively low.

At the time of passage through the transfer system of an inkjet printer, the recording medium is subjected to stress in some cases, so the ink receiving layer is preferable to have sufficient film strength. In addition, from the standpoint of avoiding the occurrence of cracking and exfoliation in the ink receiving layer when the recording medium is cut into sheets, the ink receiving layer is preferable to have sufficient film strength. In view of these cases, the mass ratio (x/y) is preferably 5 or less, while it is preferably 2 or more from the viewpoint of ensuring quick ink absorptivity in inkjet printer.

For example, when a coating liquid prepared by completely dispersing vapor-phase process silica fine particles having an average primary particle diameter of 20 nm or less and a water-soluble resin at a mass ratio (x/y) of 2 to 5 is applied onto a support and dried, a three-dimensional network is formed having secondary particles of the silica fine particles as network chains, whereby a light-transmitting porous film having an average pore diameter of 30 nm or less, a void percentage of 50% to 80%, a specific pore volume of 0.5 ml/g or more, and a specific surface area of 100 m²/g or more can be easily formed.

(Crosslinking Agent)

In point of crosslinking the water-soluble resin, it is preferable that the ink receiving layer in the invention contains at least one kind of crosslinking agent.

Adoption of the ink receiving layer in a mode of porous layer formed by using the foregoing combination of inorganic fine particles and water-soluble resin in particular and hardening the water-soluble resin by crosslinking reaction with a crosslinking agent is one embodiment of the invention.

For crosslinking of the water-soluble resins, notably polyvinyl alcohol, boron compounds are suitably used.

Examples of such boron compounds include borax, boric acid, borates (such as orthoborate, InBO₃, ScBO₃, YBO₃, LaBO₃, Mg₃(BO₃)₂ and CO₃(BO₃)₂), diborates (such as Mg₂B₂O₅ and CO₂B₂O₅), metaborates (such as LiBO₂, Ca(BO₂)₂, NaBO₂ and KBO₂), tetraborates (such as Na₂B₄O₇.10H₂O), pentaborates (such as KB₅O₈.4H₂O and CsB₅O₅) and hexaborates (such as Ca₂B₆O₁₁.7H₂O). Among these boron compounds, borax, boric acid and borates, especially boric acid, are used to advantage in point of quick induction of crosslinking reaction.

As crosslinking agents for the water-soluble resins, the following compounds other than the boron compounds can also be used.

For example, the compounds usable as the crosslinking agents include aldehyde compounds, such as formaldehyde, glyoxal and gurtaraldehyde; ketone compounds, such as diacetyl and cyclopentanedione; active halogen compounds, such as bis(2-chloroethylurea), 2-hydroxy-4,6-dichloro-1,3,5-triazine and sodium 2,4-dichloro-6-hydroxy-s-triazine); active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins; isocyanate compounds, such as 1,6-hexamethylene diisocyanate; aziridine compounds described in U.S. Pat. Nos. 3,017,280 and 2,983,611; carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate and chromium acetate; polyamine compounds, such as tetraethylenepentamine; hydrazide compounds, such as adipic dihydrazide; and low-molecular compounds and polymers each having at least two oxazoline groups.

The crosslinking agents as recited above can be used alone or as a combination of any two or more of them.

The amount of crosslinking agent(s) used is preferably from 1% by mass to 50% by mass, more preferably from 5% by mass to 40% by mass, based on the water-soluble resin.

(Mordant)

The ink receiving layer in the invention may further contain at least one of an organic mordant and an inorganic mordant in the range that does not disturb the advantage of the invention.

A cationic polymer (cationic mordant) is preferred as the organic mordant. When the mordant is added to the ink receiving layer, it interacts with a liquid ink having an anionic dye as a colorant to stabilize the colorant, and thereby the water resistance and time-lapse bleeding resistance may be improved. A plurality of kinds of each of organic mordants and inorganic mordants may be combined and used.

As the cationic mordant, a polymer mordant having a primary to tertiary amino group or a quaternary ammonium salt group is preferably used as a cationic group. However, a cationic non-polymer mordant as well may be used.

Examples of preferable polymer mordant include a homopolymer of a monomer (mordant monomer) having a primary to tertiary amino group and a salt thereof, or a quaternary ammonium salt group, or a copolymer or polycondensate of the mordant monomer and other monomer (hereinafter, referred to as “non-mordant monomer”). The polymer mordant may be used in any one of forms of water soluble polymer and water-dispersible latex particles.

Examples of the monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride,

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate,

quaternarized products prepared by reacting N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide or N,N-diethylaminopropyl (meth)acrylamide with methyl chloride, ethyl chloride, methyl bromide, ethyl bromide, methyl iodide or ethyl iodide, and sulfonates, alkylsulfonates, acetates or alkylcarboxyates obtained by anion substitution of these quaternarized products.

Examples of such products include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, triethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate and trimethyl-3-(acryloylamino)propylammonium acetate. In addition to the monomers recited above, N-vinylimidazole and N-vinyl-2-methylimidazole can be used as monomers copolymerizable with these monomers. Moreover, it is possible to utilize polymers having vinylamine units converted from their original polymerizing units, such as N-vinylacetamide and N-vinylformamide, by hydrolysis after polymerization, and the polymers having salt-form units converted from these vinylamine units.

The non-mordant monomers are referred to monomers having neither basic nor cationic moieties, such as primary, secondary and tertiary amino groups, salts thereof, or quaternary ammonium bases, and showing no or substantially weak interaction with dyes in inkjet ink. Examples of such non-mordant monomers include alkyl esters of (meth)acrylic acid; cycloalkyl esters of (meth)acrylic acid, such as cyclohexyl (meth)acrylate; aryl esters of (meth)acrylic acid, such as phenyl (meth)acrylate; aralkyl esters, such as benzyl (meth)acrylate; aromatic vinyl compounds, such as styrene, vinyltoluene and α-methylstyrene; vinyl esters, such as vinyl acetate, vinyl propionate and vinyl versatates; allyl esters, such as allyl acetate; halogen-containing monomers, such as vinylidene chloride and vinyl chloride; vinyl cyanides, such as (meth)acrylonitrile; and olefins, such as ethylene and propylene.

The alkyl esters of (meth)acrylic acid are preferably those containing 1 to 18 carbon atoms in their respective alkyl moieties, with examples including methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate. Among these (meth)acrylates, methyl acrylate, ethyl acrylate, methyl methacrylate, ethyl methacrylate and hydroxyethyl methacrylate are preferable over the others. The non-mordant monomers can be used alone or in a combination of two or more of them.

Examples of the polymer mordant preferably include cyclic amine resins typical in polydiallyldimethylammonium chloride, a copolymer of diallyldimethylammonium chloride and other monomer (mordant monomer, non-mordant monomer), a copolymer of diallyldimethylammonium chloride and SO₂, polydiallylmethylamine hydrochloride, and polydiallyl hydrochloride, and derivatives thereof (including copolymers); secondary amino, tertiary amino or quaternary ammonium salt-substituted alkyl (meth)acrylate polymers typical in polydiethylmethacryloyloxyethylamine, polytrimethylmethacryloyloxyethylammonium chloride, polydimethylbenzylmethacryloloxyethylammonium chloride, and polydimethylhydroxyethylacryloyloxyethylammonium chloride and copolymers with other monomers; polyamine resins typical in polyethyleneimine and derivatives thereof, polyallylamine and derivatives thereof, and polyvinylamine and derivatives thereof; polyamide resins typical in a polyamide-polyamine resin and a polyamide epichlorohydrin resin; polysaccharides typical in cationized starch, chitosan and chitosan derivatives; dicyandiamide derivatives typical in dicyandiamido formalin polycondensates and dicyandiamidodiethylene triamine polycondensates; polyamidine and polyamidine derivatives; dialkylamine epichlorohydrin addition polymer typical in dimethylamine epichlorohydrin addition polymer and derivatives thereof; and copolymers of a styrene polymer having a quaternary ammonium salt-substituted alkyl group and other monomer.

Examples of the polymer mordant include polymers described in, for example, JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, 1-161236, U.S. Pat. Nos. 2,484,430, 2,548,564, 3,148,061, 3,309,690, 4,115,124, 4,124,386, 4,193,800, 4,273,853, 4,282,305, 4,450,224, JP-A Nos. 1-161236, 10-81064, 10-157277, 10-217601, 2001-138621, 2000-211235, 2001-138627, 8-174992, JP-B Nos. 5-35162, 5-35163, 5-35164, 5-88846, JP Nos. 2648847, 2661677, etc.

An ink receiving layer of the invention preferably contains at least one of inorganic mordant. As the inorganic mordant, polyvalent water-soluble metal salts and hydrophobic metal salt compounds are cited.

Examples of the inorganic mordant include salts and complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Specific examples of the inorganic mordant include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, ammonium chloride copper (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic polyaluminum hydroxide, aluminum sulfite, aluminum thiosulfate, aluminum polychloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconyl acetylacetonate, zirconyl acetate, zirconyl sulfate, ammonium zirconium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26 hydrate, molybdenum chloride, dodecamolybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

As an inorganic mordant of the invention, aluminum-containing compounds, titanium-containing compounds, zirconium-containing compounds, and metal compounds (salts or complexes) of metals belonging to Group IIIB of Periodic Table are preferable.

An amount of the inorganic mordant contained in a colorant-receiving layer of the invention is preferably from 0.01 g/m² to 5 g/m² and more preferably from 0.1 g/m² to 3 g/m².

(Other Components)

The ink receiving layer of the invention, as required, may further contain various known additives such as an acid, a UV absorber, an antioxidant, a fluorescent whitening agent, a monomer, a polymerization initiator, a polymerization inhibitor, a bleed inhibitor, a preservative, a viscosity stabilizer, an antifoaming agent, a surfactant, an antistatic agent, a matting agent, a curling inhibitor and a water-resistance imparting agent.

In the invention, the ink receiving layer may contain an acid. The surface pH of the ink receiving layer is adjusted to from 3 to 8 and preferably from 4 to 6 by adding an acid. Thereby, the yellowing resistance of a white background is preferably improved. The surface pH is measured by a method A (coating method) of surface pH measurement methods determined by Japan Technical Association of the Pulp and Paper Industry (J. TAPPI). For example, a paper pH measurement set “type MPC” (trade name, manufactured by KYORITSU CHEMICAL-CHECK Lab., Corp.) corresponding to the method A may be used for the measurement.

Specific examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salicylate (Zn, Al, Ca or Mg salicylate), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid, boronic acid and acidic ones of the above-described organic and inorganic mordants. An addition amount of the acid may be determined so that the pH of the surface of the ink receiving layer may be adjusted to 3 to 8.

The acid may be used in the form of a metal salt (for example, a salt of sodium, potassium, calcium, cesium, zinc, copper, iron, aluminum, zirconium, lanthanum, yttrium, magnesium, strontium or cerium) or an amine salt (for example, ammonia, triethylamine, tributylamine, piperazine, 2-methylpiperazine or polyallylamine).

In the invention, the ink receiving layer preferably contains a storability improver such as a UV absorber, an antioxidant or a bleed inhibitor.

Examples of the UV absorber, antioxidant and bleed inhibitor include alkylated phenolic compounds (including hindered phenol compounds), alkylthiomethyl phenolic compounds, hydroquinone compounds, alkylated hydroquinone compounds, tocopherol compounds, aliphatic, aromatic and/or heterocyclic compounds having a thioether bond, bisphenolic compounds, O-, N- or S-benzyl compounds, hydroxybenzyl compounds, triazine compounds, phosphonate compounds, acylaminophenolic compounds, ester compounds, amide compounds, ascorbic acid, amine-based antioxidants, 2-(2-hydroxyphenyl)benzotriazole compounds, 2-hydroxybenzophenone compounds, acrylates, water-soluble or hydrophobic metal salts, organometallic compounds, metal complexes, hindered amine compounds (including TEMPO compound), 2-(2-hydroxyphenyl)-1,3,5-triazine compound, metal inactivating agents, phosphite compounds, phosphonite compounds, hydroxyamine compounds, nitron compounds, peroxide scavengers, polyamide stabilizers, polyether compounds, basic assistant stabilizers, nucleating agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

Among these, alkylated phenolic compounds, aliphatic, aromatic and/or heterocyclic compounds each having a thioether bond, bisphenolic compounds, ascorbic acid, amine-based antioxidants, water-soluble or hydrophobic metal salts, organometallic compounds, metal complexes, hindered amine compounds, hydroxyamine compounds, polyamine compounds, thiourea compounds, hydrazide compounds, hydroxybenzoic acid compounds, dihydroxybenzoic acid compounds and trihydroxybenzoic acid compounds are preferred.

Specific compound examples of the other components above include compounds described in JP-A Nos. 2002-36717, 2002-86904, 2002-307822, 10-182621, 2001-260519, 11-170686, JP-B Nos. 4-34953, 4-34512, 4-34513, European Patent No. 1138509, JP-A Nos. 60-67190, 7-276808, 2001-94829, 47-10537, 58-111942, 58-212844, 59-19945, 59-46646, 59-109055, 63-53544, JP-B Nos. 36-10466, 42-26187, 48-30492, 48-31255, 48-41572, 48-54965, 50-10726, U.S. Pat. Nos. 2,719,086, 3,707,375, 3,754,919, 4,220,711,

JP-B Nos. 45-4699, 54-5324, European Patent Publication Nos. 223739, 309401, 309402, 310551, 310552, 459416, German Patent Publication No. 3435443, JP-A 54-48535, 60-107383, 60-107384, 60-287485, 60-287486, 60-287487, 60-287488, 61-160287, 61-185483, 61-211079, 62-146678, 62-146679, 62-146680, 62-262047, 63-051174, 63-113536,

63-163351, 63-203372, 63-224989, 63-251382, 63-267594, 63-182484, 1-239282, 2-262654, 2-71262, 3-121449, 4-291684, 4-291685, 5-61166, 5-119449, 5-188687, 5-188686, 5-110490, 5-1108437, 5-170361, JP-B Nos. 48-43295, 48-33212, U.S. Pat. Nos. 4,814,262, 4,980,275, etc.

The other components may be used singularly or in a combination of at least two of them. Such other components may be added in a water-solubilized form, a dispersion form, a polymer dispersion form, an emulsified form or an oil-droplet form, or may be incorporated in microcapsules. An addition amount of the other component in the recording medium of the invention is preferably from 0.01 g/m² to 10 g/m².

Furthermore, an inorganic surface of the inorganic fine particles may be processed with a silane coupling agent to improve the dispersibility thereof. The silane coupling agent preferably has, other than a site that conducts a silane coupling process, an organic functional group (for example, a vinyl group, an amino group (primary to tertiary amino group, quaternary ammonium salt group), an epoxy group, a mercapto group, a chloro group, an alkyl group, a phenyl group, an ester group, or a thioether group).

In the invention, the ink receiving layer preferably contains a surfactant. The surfactant to be used may be any one of cationic, anionic, nonionic, amphoteric, fluorocarbon and silicone-based surfactants.

Examples of the nonionic surfactant include polyoxyalkylene alkyl ethers and polyoxyalkylene alkylphenyl ethers (for example, diethylene glycol monoethyl ether, diethylene glycol diethyl ether, polyoxyethylene lauryl ether, polyoxyethylene stearyl ether, and polyoxyethylene nonylphenyl ether), an oxyethylene-oxypropylene block copolymer, sorbitan fatty acid esters (for example, sorbitan monolaurate, sorbitan monooleate and sorbitan trioleate), polyoxyethylene sorbitan fatty acid esters (for example, polyoxyethylene sorbitan monolaurate, polyoxyethylene sorbitan monooleate, and polyoxyethylene sorbitan trioleate), polyoxyethylene sorbitol fatty acid esters (for example, polyoxyethylene sorbit tetraoleate), glycerin fatty acid esters (for example, glycerol monooleate), polyoxyethylene glycerin fatty acid esters (for example, polyoxyethylene glycerin monostearate, and polyoxyethylene glycerin monooleate), polyoxyethylene fatty acid esters (for example, polyethylene glycol monolaurate and polyethylene glycol monooleate), polyoxyethylene alkylamine, acetylene glycols (for example, 2,4,7,9-tetramethyl-5-decyne-4,7-diol, ethylene oxide adduct of 2,4,7,9-tetramethyl-5-decyne-4,7-diol, and propylene oxide adduct of 2,4,7,9-tetramethyl-5-decyne-4,7-diol). Among these, polyoxyalkylene alkyl ethers are preferred. The nonionic surfactant may be used in a coating solution A and a coating solution B. The nonionic surfactants may be used singularly or in a combination of at least two of them.

The amphoteric surfactant may be an amino acid amphoteric surfactant, a carboxy ammonium betaine amphoteric surfactant, a sulfone ammonium betaine amphoteric surfactant, an ammonium sulfate betaine amphoteric surfactant, or an imidazolium betaine amphoteric surfactant. Preferable examples thereof include the amphoteric surfactants described in U.S. Pat. No. 3,843,368, JP-A Nos. 59-49535, 63-236546, 5-303205, 8-262742 and 10-282619, Japanese Patent Nos. 2514194 and 2759795, and JP-A No. 2000-351269. Among the amphoteric surfactants, an amino acid amphoteric surfactant, a carboxy ammonium betaine amphoteric surfactant and a sulfone ammonium betaine amphoteric surfactant are preferred. The amphoteric surfactants may be used singularly or in a combination of at least two of them.

Examples of the anionic surfactant include fatty acid salts (for example, sodium stearate and potassium oleate), alkyl sulfate ester salts (for example, sodium lauryl sulfate and triethanol amine lauryl sulfate), sulfonates (for example, sodium dodecylbenzenesulfonate), alkylsulfo succinic acid salts (for example, sodium dioctylsulfo succinate), alkyldiphenyl ether disulfonate and alkyl phosphate.

Examples of the cationic surfactant include alkyl amine salts, quaternary ammonium salts, pyridinium salts, and imidazolium salts.

As the fluorocarbon surfactant, compounds derived from an intermediate having a perfluoroalkyl group produced by a method such as electrolysis fluorination, telomerization and oligomerization are cited.

Examples thereof include perfluoroalkyl sulfonates, perfluoroalkyl carboxyates, perfluoroalkyl ethylene oxide adducts, perfluoroalkyl trialkyl ammonium salts, perfluoroalkyl group-containing oligomers, and perfluoroalkyl phosphate esters.

The silicone-based surfactant is preferably a silicone oil modified with an organic group, and may have a structure in which a side chain of the siloxane structure is modified with an organic group, a structure where both of terminals are modified with an organic group, or a structure where one of the terminals is modified with an organic group. Examples of the modification with an organic group include amino modification, polyether modification, epoxy modification, carboxy modification, carbinol modification, alkyl modification, aralkyl modification, phenol modification, and fluorine modification.

In the invention, a content of the surfactant in the ink receiving layer is preferably from 0.001% by mass to 2.0% by mass, and more preferably from 0.01% by mass to 1.0% by mass. When two or more coating solutions for the ink receiving layer are used for the formation of the ink receiving layer, it is preferable that the surfactant is added to each of coating solutions.

The ink receiving layer in the invention preferably contains a high-boiling point organic solvent to inhibit the ink receiving layer from curling. The high-boiling point organic solvent is an organic compound having a boiling point of 150° C. or higher under ordinary pressure, and may be water-soluble one or hydrophobic one. The high-boiling point organic solvent may be liquid or solid and may be a low molecule or a high molecule.

Specific examples thereof include aromatic carboxylic acid esters (for example, dibutyl phthalate, diphenyl phthalate and phenyl benzoate), aliphatic carboxylic acid esters (for example, dioctyl adipate, dibutyl sebacate, methyl stearate, dibutyl maleate, dibutyl fumarate, and triethyl acetylcitrate), phosphate esters (for example, trioctyl phosphate and tricresyl phosphate), epoxies (for example, epoxidized soybean oil and epoxidized fatty acid methyl ester), alcohols (for example, stearyl alcohol, ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine and polyethylene glycol), vegetable oils (for example, soybean oil and sunflower oil), and higher aliphatic carboxylic acid (for example, linoleic acid and oleic acid).

<Support>

As a support in the invention, any one of a transparent support made of a transparent material such as plastics and an opaque support made of an opaque material such as paper may be used. A transparent support or a high-gloss and opaque support is preferably used from the viewpoint of taking full advantage of the transparency of the ink receiving layer. It is also possible to use a read-only optical disc such as a CD-ROM or a DVD-ROM, a write-once optical disc such as a CD-R or a DVD-R, or a rewritable optical disc as a support, and to form an ink receiving layer on a label face thereof.

A transparent material resistant to radiant heat applied thereto when the medium is used on an OHP or back light display is preferable as the material for the transparent support. Examples of the material include polyesters such as polyethylene terephthalate (PET), polysulfone, polyphenylene oxide, polyimide, polycarbonate, polyamide and the like. Among them, polyesters are preferable, and polyethylene terephthalate is particularly preferable.

The thickness of the transparent support has no particular limitation, but it is preferably from 50 μm to 200 μm in point of easy handling.

The high-gloss opaque support preferably has a glossiness of 40% or more on the surface where the ink receiving layer is formed. The glossiness is a value determined by a known method taught by ISO 8254-1, i.e., Paper and board—Measurement of specular gloss

Part 1: 75 degree gloss with a converging beam. Specific examples of the supports include the following:

Specific examples of the high-gloss opaque support include: high-gloss paper supports such as art paper, coated paper, cast-coated paper, baryta paper commonly used as a silver salt photographic support and the like; high-gloss films opacified by adding a white pigment or the like to any one of plastic films such as polyesters such as polyethylene terephthalate (PET), nitrocellulose, cellulose acetate, cellulose esters such as cellulose acetate butylate, polysulfone, polyphenylene oxide, polyimide, polycarbonate, polyamide or the like (which may be additionally surface calendared); supports having a polyolefin coating layer containing or not containing a white pigment formed on the surface of these various paper and transparent supports or the high-gloss films containing a white pigment; or the like.

Foamed polyester films containing a white pigment (e.g., a foamed polyester formed by expanding a polyolefin fine particle-containing PET film so as to forming voids therein) are favorable and also included as examples. In addition, resin coated papers commonly used as photographic papers for silver salt photographs are also preferable.

While the thickness of the opaque support is not particularly limited, it is preferably in a range of 50 μm to 300 μm from the viewpoint of ease of handling.

The surface of the support may be subjected to corona discharge treatment, glow discharge treatment, flame treatment, ultraviolet ray irradiation treatment or the like for improvement in wetting property and adhesive property.

Then, base paper used in the resin-coated papers is described in detail.

The base paper is made from wood pulp as a principal material and, if needed, synthetic pulp made from, e.g., polypropylene, or synthetic fiber, such as nylon fiber or polyester fiber, as an additional material. As the wood pulp, any of LBKP, LBSP, NBKP, NBSP, LDP, NDP, LUKP and NUKP can be used. It is advantageous to use wood pulp with a high content of short fibers, such as LBKP, NBSP, LBSP, NDP and LDP.

However, the proportion of LBSP and/or LDP is preferably from 10% by mass to 70% by mass.

Chemical pulps (such as sulfate salt pulp or sulfite pulp) containing a smaller amount of impurities are preferably used as the pulp used in the invention. Bleached pulps which are improved in whiteness are also useful.

Various additives including a sizing agent such as higher fatty acid or alkylketene dimer, a white pigment such as calcium carbonate, talc or titanium oxide, a paper-strength additive such as starch, polyacrylamide or polyvinyl alcohol, a fluorescent whitening agent, a moisturizing agent such as polyethylene glycols, a dispersant, a softener such as quaternary ammonium, and the like may be added to the base paper in accordance with necessity.

The freeness of the pulp for use in sheeting is preferably 200 mL to 500 mL as per CSF (Canadian Standard Freeness) regulations. In regard to the fiber length after beating, the pulps remaining on 24- and 42-mesh screens is preferably 30% by mass to 70% by mass, as determined by the known method taught by ISO 534, i.e., Paper and board—Determination of thickness and density. Further, the pulp remaining on 4-mesh screen is preferably 20% by mass or less.

The basis weight of base paper is preferably from 30 g/m² to 250 g/m², particularly preferably from 50 g/m² to 200 g/m². The thickness of base paper is preferably from 40 μm to 250 μm. It is also possible to impart high smoothness to base paper by performing calendar treatment during a papermaking stage or after the papermaking has finished. The base paper density is generally from 0.7 g/cm³ to 1.2 g/cm³ (JIS P-8118).

Furthermore, the stiffness of base paper is preferably from 20 g to 200 g under conditions defined by JIS P-8143.

The base paper surface may be coated with a surface sizing agent, and the same sizing agent as added for internal sizing of base paper can also be used as the surface sizing agent.

The pH of base paper is preferably from 5 to 9 as measured according to the hydrothermal extraction method defined by JIS P-8113.

The polyethylene covering the front and rear surfaces of the base paper is mainly a low-density polyethylene (LDPE) and/or a high-density polyethylene (HDPE), but other LLDPE, polypropylene, or the like may also be used partially.

In particular, the polyethylene layer on which the ink receiving layer is provided is preferably formed of polyethylenes containing rutile-titanium oxide, anatase-titanium oxide, a fluorescent whitening agent, and/or ultramarine that are improved in opacity, whiteness and hue, which are commonly used in photographic papers. The content of the titanium oxide is preferably in a range of from about 3% by mass to about 20% by mass and more preferably in a range of from 4% by mass to 13% by mass with respect to the polyethylene. The thickness of the polyethylene layer, either front or rear, is not particularly limited, but is favorably in a range of from 10 μm to 50 μm. In addition, an undercoat layer may be formed on the polyethylene layer for increasing the adhesive property thereof to an ink receiving layer. Hydrophilic polyester, gelatin, and PVA are preferable for the undercoat layer. The thickness of the undercoat layer is preferably in a range of from 0.01 μm to 5 μm.

The polyethylene-coated paper may be used as a glossy paper.

The polyethylene layer coated on the surface of the base paper by melt-extrusion may be further subjected to a surface modification treatment such as embossing so that it has a mat or silky surface similar to that of common photographic printing papers.

The support can be provided with a backcoat layer. To the backcoat layer, white pigment, aqueous binder and other ingredients can be added.

Examples of white pigment which can be incorporated into the backcoat layer include inorganic white pigments, such as precipitated calcium carbonate, ground calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrous halloysite, magnesium carbonate and magnesium hydroxide; and organic pigments, such as styrene-base plastic pigment, acrylic plastic pigment, polyethylene, microcapsules, urea resin and melamine resin.

Examples of the water soluble binders for use in the backcoat layer include water-soluble polymers such as copolymers of styrene/maleic acid salt, copolymers of styrene/acrylic acid salt, polyvinyl alcohol, silanol-modified polyvinyl alcohols, starch, cationic starch, casein, gelatin, carboxymethyl cellulose, hydroxyethyl cellulose, or polyvinyl pyrrolidone; water-dispersible polymers such as styrene butadiene latexes or acryl emulsions; and the like.

The other components contained in the backcoat layer include an antifoaming agent, foam inhibitor, dye, fluorescent whitening agent, antiseptic, water-resistance imparting agent, and the like.

<Preparation of Recording Medium>

The recording medium in the invention may be prepared by forming the ink receiving layer on the support. A method of forming an ink receiving layer on a support is not restricted to a particular method. However, the ink receiving layer is preferably produced according to a producing method that contains a step of coating a coating solution A on the support, the coating solution A containing fine particles and a water-soluble resin, and a step of coating a basic coating solution B on the coated layer, the coating solution B containing the polyallylamine derivative, either (1) simultaneously with coating of the coating solution or (2) during drying the coating solution A coated on the support before a decreasing rate of drying is exhibited, from the viewpoint of the recording density and inhibition of discoloration.

When the ink receiving layer is produced according to a method like this, the polyallylamine derivative may be more efficiently distributed in the proximity of a surface layer of the ink receiving layer.

In the invention, a coating solution A containing at least fine particles (for example, vapor-phase process silica) and a water-soluble resin (for example, polyvinyl alcohol) may be produced, for example, as shown below.

That is, the coating solution A is prepared in such a manner that fine particles of vapor-phase process silica and a dispersant are added in water (for example, silica fine particles are contained at a content of from 10% by mass to 20% by mass in water), followed by dispersing using a high-speed rotation wet colloid mill (for example, CLEARMIX (trade name, manufactured by M-Technic Co., Ltd.)) over, for example, 20 min (preferably 10 min to 30 min) under conditions of high-speed rotation of, for example, 10000 rpm (preferably, 5000 rpm to 20000 rpm), further followed by adding a crosslinking agent (for example, boric acid), and an aqueous solution of polyvinyl alcohol (PVA) (for example, so as for PVA to be a mass of substantially one third the vapor-phase process silica), still further followed by adding a compound having at least two kinds of divalent or more metallic atoms in the molecule (for example, basic polyaluminum hydroxide), followed by dispersing the rotation conditions same as that mentioned above. The resulted coating solution is in a uniform sol state, and, when the coating solution is coated on a support according to a coating method shown below and dried, a porous ink receiving layer having a three-dimensional network structure may be formed.

An aqueous dispersion made of the vapor-phase process silica and a dispersant may be prepared in such a manner that an aqueous dispersion of vapor-phase process silica is prepared in advance, followed by adding the aqueous dispersion in an aqueous solution of dispersant, or an aqueous solution of dispersant may be added to an aqueous dispersion of vapor-phase process silica, or these may be simultaneously mixed. Furthermore, not an aqueous dispersion of vapor-phase process silica but powdery vapor-phase process silica may be added to an aqueous solution of dispersant as mentioned above.

When the vapor-phase process silica and a dispersant are mixed and thereafter the mixed liquid is pulverized using a dispersing device, an aqueous dispersion of particles having an average particle diameter from 50 nm to 300 nm may be obtained. As a dispersing device that is used to obtain the aqueous dispersion, various kinds of known dispersing devices such as a high-speed rotary dispersing device, a media-stirring dispersing device (for example, ball mill and sand mill), a ultrasonic dispersing device, a colloid mill dispersing device or a high-pressure dispersing device may be used. Among these, a stirring dispersing device, a colloid mill dispersing device or a high-pressure dispersing mill is preferred from the viewpoint of capable of efficiently dispersing the formed flocculated fine particles.

As a solvent in the respective steps, water, an organic solvent, or a mixed solvent thereof may be used. Examples of the organic solvent usable in the coating include alcohols such as methanol, ethanol, n-propanol, i-propanol or methoxy propanol, ketones such as acetone or methyl ethyl ketone, tetrahydrofuran, acetonitrile, ethyl acetate, and toluene.

Furthermore, a cationic polymer may be used as the dispersant. Examples of the cationic polymer include known organic mordants. As the dispersant, a silane coupling agent may be preferably used as well.

An addition amount of the dispersant with respect to the fine particles is preferably from 0.1% by mass to 30% by mass and more preferably from 1% by mass to 10% by mass.

In the invention, the pH of the basic coating solution B containing a polyallylamine derivative is preferably 7.1 or more, more preferably 7.5 or more and particularly preferably 8 or more. A content of the polyallylamine derivative in the basic coating solution B is preferably from 0.05% by mass to 10% by mass and more preferably from 0.1% by mass to 5% by mass.

Furthermore, the coating solution B may further contain a crosslinking agent.

Method available for applying the coating solution A include methods known in the art such as using an extrusion die coater, air doctor coater, blade coater, rod coater, knife coater, squeeze coater, reverse roll coater and bar coater.

A coating solution B is coated on a coated layer simultaneously with coating of the coating solution A or after coating of the coating solution A. However, the coating solution B is coated before a coated layer after coating of the coating solution A may show a decreasing rate of drying. That is, the recording medium is preferably produced when a coating solution B is introduced after a coating solution A is coated and during the coated layer shows a constant-rate drying.

The expression “before the coating layer exhibits a decreasing rate of drying” usually refers to a period of several minutes from immediately after the application of coating solutions for the ink receiving layer, and in this course the coating layer applied exhibits the phenomenon of “constant-rate drying” in which the solvent (dispersion medium) content in the coating layer applied decreases in proportion to a lapse of time. On the time for such “constant-rate drying”, there are descriptions in, e.g., Kagaku Kogaku Binran (Handbook of Chemical Technology), pp. 707-712, MARUZEN Co., Ltd. (Oct. 25, 1980).

As described above, after applying the coating solution A, the coating layer is dried until it comes to show a decreasing rate of drying, and the drying is generally carried out under conditions of the drying temperature range of 40° C. to 180° C. and the drying time range of from 0.5 minutes to 10 minutes (preferably from 0.5 minutes to 5 minutes). Although it is natural that the drying time varies according to the application quantity, the range specified above is usually appropriate.

A method applying the coating solution B, before the coating layer formed with the coating solution A shows a decreasing rate of drying, includes (1) a method of further applying the coating solution B to the coating layer formed, (2) a method of spraying the coating solution B on the coating layer formed, or (3) a method of immersing the coating layer-provided support in the coating solution B.

Method available for applying the coating solution B in the method (1) include methods known in the art such as using a curtain flow coater, extrusion die coater, air doctor coater, blade coater, rod coater, knife coater, squeeze coater, reverse roll coater and bar coater. The methods of using an extrusion die coater, curtain flow coater or bar coater are preferable, since these methods are able to apply the coat without making direct contact with the already formed first coated layer.

After the coating solution B is coated, a drying and curing process is conducted by heating generally at a temperature of from 40° C. to 180° C. for 0.5 min to 30 min. It is preferred to heat at a temperature of from 40° C. to 150° C. for 1 min to 20 min.

When the coating solution B is coated simultaneously with coating of the coating solution A, the coating solutions A and B are simultaneously coated on a support (multilayer coating) so that the coating solution A may come into contact with the support, followed by drying and curing, and thereby an ink receiving layer is formed.

The simultaneous coating (multilayer coating) may be conducted by use of a coating method that uses, for instance, an extrusion die coater, or a curtain flow coater. After the simultaneous coating, the resulting coated layer is dried. In this case, the coated layer is generally dried by heating at a temperature of from 40° C. to 150° C. for 0.5 min to 10 min and more preferably by heating at a temperature of from 40° C. to 100° C. for 0.5 min to 5 min.

When the simultaneous coating (multilayer coating) is conducted using, for instance, an extrusion die coater, two kinds of coating solution simultaneously discharged are formed into layers around a discharging exit of the extrusion die coater, that is, before being transferred on a support, and coated in this state in layers on a support. Two kinds of coating solutions formed in layers before coating tend to cause a crosslinking reaction at an interface of two liquids at the time of transferring on the support; accordingly, around the discharging exit of the extrusion die coater, two liquids being discharged are mixed to be likely viscous, and thereby a coating operation is disturbed in some cases. Accordingly, when a simultaneous coating is conducted as mentioned above, a simultaneous three-layer coating is preferably conducted, where simultaneously with coating of the coating solutions A and B, a barrier layer solution (intermediate layer solution) is coated interposed therebetween.

The barrier layer solution may be selected without particular restriction. For example, a water soluble solution containing a trace of a water-soluble resin and water are cited. The water-soluble resin is used for the purpose of a thickening agent by considering coating property. Examples thereof include polymers such as a cellulose resin (for example, hydroxypropyl methylcellulose, methylcellulose, and hydroxyethyl methylcellulose), polyvinyl pyrrolidone or gelatin. In the barrier layer solution, the cationic polymer may be contained.

After an ink receiving layer is formed on a support, the ink receiving layer may be improved in surface flatness, glossiness, transparency and coated film strength by applying a calendar process through a nip roll under heating and pressure using, for example, a super calendar or a gloss calendar. However, the calendar process may be a factor of lowering the void percentage (that is, the ink absorptivity may be lowered) in some cases; accordingly, conditions less lowering the void percentage have to be set to conduct.

A roll temperature when the calendar process is applied is preferably from 30° C. to 150° C. and more preferably from 40° C. to 100° C.

The linear pressure between rolls during the calendar process is preferably from 50 kg/cm to 400 kg/cm and more preferably from 100 kg/cm to 200 kg/cm.

In the case of inkjet recording, a layer thickness of the ink receiving layer has to be determined in association with the void percentage in a layer because absorption capacity by which all droplets are absorbed is necessary. For example, when an ink amount is 8 nL/mm² and the void percentage is 60%, a film having a layer thickness of substantially 15 μm or more is necessary.

When this point is considered, in the case of the inkjet recording, a layer thickness of an ink receiving layer is preferred to be 10 μm to 50 μm.

A pore diameter of the ink receiving layer is, by median diameter, preferably from 0.005 μm to 0.030 μm and more preferably from 0.01 μm to 0.025 μm.

The void percentage and pore median diameter are measured with a mercury porosimeter (trade name: PORESIZER 9320-PC2, manufactured by Shimadzu Corporation).

The ink receiving layer is preferred to be excellent in the transparency. As the measure thereof, a haze value when an ink receiving layer is formed on a transparent film support is preferably 30% or less and more preferably 20% or less.

The haze value is measured using a haze meter (trade name: HGM-2DP, manufactured by Suga Test Instrument Co., Ltd.).

A polymer fine particle dispersion may be added to a constituent layer (for example, an ink receiving layer or a back layer) of a recording medium in the invention. The polymer fine particle dispersion is used for the purpose of improving film physical property such as dimensional stabilization, curling inhibition, adhesion inhibition or film crack inhibition. The polymer fine particle dispersion is described in JP-A Nos. 62-245258, 62-1316648 and 62-110066. When a polymer fine particle dispersion of a polymer low in the glass transition temperature (40° C. or less) is added to a layer containing the cationic polymer, the layer is inhibited from cracking or curling. When polymer fine particle dispersion of a polymer high in the glass transition temperature is added to a back layer, the back layer is inhibited from curling.

An inkjet recording method of the invention includes a step of recording an image by imparting a yellow ink containing at least one of water soluble azo dye represented by Formula (Y-1) shown below in an amount of 50% by mass or more with respect to a total amount of yellow dye in the yellow ink on the recording medium by use of an inkjet recording method.

When the inkjet recording method is thus configured, a high image density is obtained and discoloration after image recording (color drift) is inhibited. Inkjet recording excellent in the storage stability such as the light resistance and ozone resistance of a recorded image is realized.

[Inkjet Recording Method]

As for the inkjet recording method in the invention, one of known methods may be applied without particular restriction. For example, a charge control method where an ink is discharged by making use of electrostatic attraction, a drop-on demand method that makes use of vibration pressure of a piezo device (pressure-pulse method), an acoustic inkjet method where a electric signal is, after converting into an acoustic beam, illuminated on an ink to discharge an ink by making use of radiation pressure, and a thermal inkjet method where an ink is heated to generate foams and generated pressure is made use of may be used. Furthermore, the inkjet recording method includes a method where an ink that is called a photo-ink and low in the concentration is discharged a lot with a small volume, a method where a plurality of inks that have substantially same hue and are different in concentration is used to improve an image quality, and a method where a transparent and colorless ink is used.

(Yellow Ink)

A content of the water soluble azo dye represented by Formula (Y-I) in a yellow ink of the present invention is 50% by mass or more with respect to the total mass of the yellow dye, preferably 60% by mass or more, and more preferably 70% by mass or more from the viewpoint of storage stability of an image formed with the ink.

Moreover, it is preferable that the oxidation potential of the water soluble azo dye (yellow dye) represented by Formula (Y-I) in the ink be more noble than 1.0 V (vs. SCE).

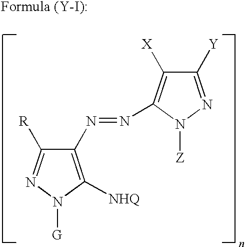

In Formula (Y-I), G represents a heterocyclic group. R, X, Y, Z and Q each independently represent a substituent. n represents an integer of 1 to 3. In a case where n is 1, R, X, Y, Z, Q and G each independently represent a monovalent substituent. In a case where n is 2, R, X, Y, Z, Q and G each independently represent a monovalent substituent or a divalent substituent, provided that at least one of R, X, Y, Z, Q and G represents a divalent substituent. In a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

In Formula (Y-I), G preferably represents a 5- to 8-membered heterocyclic group, more preferably a saturated or unsaturated 5- or 6-membered aromatic heterocyclic group, or a saturated or unsaturated 5- or 6-membered non-aromatic heterocyclic group, which may be further condensed.

G represents still more preferably a 5- or 6-membered aromatic heterocyclic group having 3 to 30 carbon atoms.

Examples of the heterocyclic group represented by G include, with no limitation on substitution sites, substituents derived from heterocycle compounds such as pyridine, pyrazine, pyridazine, pyrimidine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, thiazoline and sulfolane.

When the heterocyclic group is a group capable of further having a substituent, the following substituents may be further contained.

Examples include a straight chain or branched alkyl group having 1 to 12 carbon atoms, a straight chain or branched aralkyl group having 7 to 18 carbon atoms, a straight chain or branched alkenyl group having 2 to 12 carbon atoms, a straight chain or branched alkynyl group having 2 to 12 carbon atoms, an unsubstituted or substituted cycloalkyl group having 3 to 12 carbon atoms, an unsubstituted or substituted cycloalkenyl group having 3 to 12 carbon atoms (Among the above-mentioned respective groups, those having branched chains are preferable because they increase solubility of dyes and stability of inks, and those having asymmetrical carbons are particularly preferable. Examples include methyl, ethyl, propyl, isopropyl, sec-butyl, t-butyl, 2-ethylhexyl, 2-methylsulfonyl ethyl, 3-phenoxypropyl, trifluoromethyl, and cyclopentyl), a halogen atom (e.g., a chlorine atom or a bromine atom), an aryl group (e.g., phenyl, 4-t-butylphenyl, or 2,4-di-t-amyl phenyl), hetero 2-pyrimidinyl or 2-benzothiazolyl), a cyano group, a hydroxy group, a nitro group, a carboxy group, an amino group, an alkyloxy group (e.g., methoxy, ethoxy, 2-methoxyethoxy, or 2-methylsulfonyl ethoxy), an aryloxy group (e.g., phenoxy, 2-methylphenoxy, 4-t-butylphenoxy, 3-nitrophenoxy, 3-t-butyloxy carbonyl phenoxy, or 3-methoxycarbonyl phenyloxy), an acylamino group (e.g., acetamide, benzamide, or 4-(3-t-butyl-4-hydroxyphenoxy)butaneamide), an alkylamino group (e.g., methylamino, butylamino, diethylamino, or methylbutylamino), an anilino group (e.g., phenylamino or 2-chloroanilino), a ureido group (e.g., phenylureido, methylureido, or N,N-dibutylureido), a sulfamoylamino group (e.g., N,N-dipropylsulfamoylamino), an alkylthio group (e.g., methylthio, octylthio, or 2-phenoxyethylthio), an arylthio group (e.g., phenylthio, 2-butoxy-5-t-octyl phenylthio, or 2-carboxy phenylthio), an alkyloxy carbonylamino group (e.g., methoxycarbonylamino), an alkylsulfonylamino group and arylsulfonylamino group (e.g., methylsulfonylamino, phenylsulfonylamino, or p-toluenesulfonylamino), a carbamoyl group (e.g., N-ethylcarbamoyl or N,N-dibutylcarbamoyl), a sulfamoyl group (e.g., N-ethyl sulfamoyl, N,N-dipropyl sulfamoyl, or N-phenyl sulfamoyl), a sulfonyl group (e.g., methylsulfonyl, octylsulfonyl, phenylsulfonyl, or p-toluenesulfonyl), an alkyloxy carbonyl group (e.g., methoxy carbonyl or butyloxy carbonyl), a heterocyclic oxy group (e.g., 1-phenyltetrazole-5-oxy or 2-tetrahydropyranyloxy), an azo group (e.g., phenylazo, 4-methoxy phenylazo, 4-pivaloyl amino phenylazo, or 2-hydroxy-4-propanoyl phenylazo), an acyloxy group (e.g., acetoxy), a carbamoyloxy group (e.g., N-methylcarbamoyloxy or N-phenylcarbamoyloxy), a silyloxy group (e.g., trimethylsilyloxy or dibutylmethyl silyloxy), an aryloxycarbonylamino group (e.g., phenoxycarbonylamino), an imido group (e.g., N-succinimide or N-phthalimide), a heterocyclic thio group (e.g., 2-benzothiazolylthio, 2,4-di-phenoxy-1,3,5-triazole-6-thio, or 2-pyridylthio), a sulfinyl group (e.g., 3-phenoxypropylsulfinyl), a phosphonyl group (e.g., phenoxy phosphonyl, octyloxy phosphonyl, or phenyl phosphonyl), an aryloxycarbonyl group (e.g., phenoxycarbonyl), an acyl group (e.g., acetyl, 3-phenylpropanoly, or benzoyl), and ionic hydrophilic groups (e.g., a carboxy group, a sulfo group, a phosphono group, and a quaternary ammonium group).

Preferable examples of substituents of Q, R, X, Y, and Z in Formula (Y-I) will be described in detail. When Q, R, X, Y, and Z represent a monovalent group, they each represent hydrogen atom or a monovalent substituent as a monovalent group. The monovalent substituent will be described in more detail. Examples of the monovalent substituent include a halogen atom, an alkyl group, a cycloalkyl group, an aralkyl group, an alkenyl group, an alkynyl group, an aryl group, a heterocyclic group, a cyano group, a hydroxy group, a nitro group, an alkoxy group, an aryloxy group, a silyloxy group, a heterocyclic oxy group, an acyloxy group, a carbamoyloxy group, an alkoxy carbonyloxy group, an aryloxycarbonyloxy group, an amino group (an alkylamino group or an arylamino group), an acylamino group (an amido group), an aminocarbonyl amino group (a ureido group), an alkoxycarbonylamino group, an aryloxycarbonylamino group, a sulfamoylamino group, an alkylsulfonylamino group, an arylsulfonylamino group, an alkylthio group, an arylthio group, a heterocyclic thio group, a sulfamoyl group, an alkylsulfinyl group, an arylsulfinyl group, an alkylsulfonyl group, an arylsulfonyl group, an acyl group, an aryloxycarbonyl group, an alkoxycarbonyl group, a carbamoyl group, a phosphino group, a phosphinyl group, a phosphinyloxy group, a phosphinylamino group, a silyl group, an azo group, and an imido group. Each group may further have a substituent.

Among the above, a hydrogen atom, a halogen atom, an alkyl group, an aryl group, a heterocyclic group, a cyano group, an alkoxy group, an amido group, a ureido group, an alkylsulfonylamino group, an arylsulfonylamino group, a sulfamoyl group, an alkylsulfonyl group, an arylsulfonyl group, a carbamoyl group, or an alkoxycarbonyl group is particularly preferable. In particular, a hydrogen atom, a halogen atom, an alkyl group, an aryl group, a cyano group, an alkylsulfonyl group, an arylsulfonyl group, or a heterocyclic group is preferable, and a hydrogen atom, an alkyl group, an aryl group, a cyano group, or an alkylsulfonyl group is the most preferable.

Hereinafter, the Q, R, X, Y, and Z will be described in more detail. The halogen atoms represented by Q, R, X, Y, and Z each represent a chlorine atom, a bromine atom, or an iodine atom. Among the above, a chlorine atom or a bromine atom is preferable, and particularly a chlorine atom is preferable.

The alkyl group represented by Q, R, X, Y, and Z includes a substituted or unsubstituted alkyl group. As the substituted or unsubstituted alkyl group, an alkyl group having 1 to 30 carbon atoms is preferable. Examples of the substituent are the same as exemplified about in the case when G represents a group that may further have a substituent. In particular, a hydroxy group, an alkoxy group, a cyano group, a halogen atom, a sulfo group (which may be in the form of a salt), or a carboxy group (which may be in the form of a salt) is preferable. Examples of the alkyl group may include methyl, ethyl, butyl, t-butyl, n-octyl, eicosyl, 2-chloroethyl, hydroxyethyl, cyanoethyl, and 4-sulfobutyl.

The cycloalkyl group represented by Q, R, X, Y, and Z includes a substituted or unsubstituted cycloalkyl group. As the substituted or unsubstituted cycloalkyl group, a cycloalkyl group having 5 to 30 carbon atoms is preferable. Examples of the substituent are the same as exemplified about in the case when G represents a group that may further have a substituent. Examples of the cycloalkyl group may include cyclohexyl, cyclopentyl, and 4-n-dodecylcyclohexyl.

The aralkyl group represented by Q, R, X, Y, and Z includes a substituted or unsubstituted aralkyl group. As the substituted or unsubstituted aralkyl group, an aralkyl group having 7 to 30 carbon atoms is preferable. Examples of the substituent are the same as exemplified about in the case when G represents a group that may further have a substituent. Examples of the aralkyl group may include benzyl and 2-phenethyl.

The alkenyl group represented by Q, R, X, Y, and Z each represents a substituted or unsubstituted alkenyl group that may be a straight chain, branched, or cyclic form. Preferable examples include a substituted or unsubstituted alkenyl group having 2 to 30 carbon atoms, such as vinyl, allyl, prenyl, geranyl, oleyl, 2-cyclopentene-1-yl, and 2-cyclohexen-1-yl.

The alkynyl group represented by Q, R, X, Y, and Z may be a substituted or unsubstituted alkynyl group having 2 to 30 carbon atoms, such as, for example, ethynyl or propargyl.

The aryl group represented by Q, R, X, Y, and Z may be a substituted or unsubstituted aryl group having 6 to 30 carbon atoms, and examples may include phenyl, p-tolyl, naphthyl, m-chlorophenyl, and o-hexadecanoyl aminophenyl. Examples of the substituent are the same as exemplified about in the case when G represents a group that may further have a substituent.

The heterocyclic group represented by Q, R, X, Y, and Z may be a monovalent group obtained by removing one hydrogen atom from a 5- or 6-membered substituted or unsubstituted aromatic or non-aromatic heterocyclic compound, which may be further condensed. A 5- or 6-membered aromatic heterocyclic group having 3 to 30 carbon atoms is more preferable. Examples of the substituent are the same as exemplified about in the case when G represents a group that may further have a substituent. Examples of the heterocyclic group include, with no limitation on substitution sites, pyridine, pyrazine, pyridazine, pyrimidine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, and thiazoline.

The alkoxy group represented by Q, R, X, Y, and Z includes a substituted or unsubstituted alkoxy group. As the substituted or unsubstituted alkoxy group, an alkoxy group having 1 to 30 carbon atoms is preferable. Examples of the substituent are the same as exemplified about in the case when G represents a group that may further have a substituent. Examples of the alkoxy group may include methoxy, ethoxy, isopropoxy, n-octyloxy, methoxyethoxy, hydroxyethoxy, and 3-carboxypropoxy.

The aryloxy group represented by Q, R, X, Y, and Z may preferably be a substituted or unsubstituted aryloxy group having 6 to 30 carbon atoms. Examples of the substituent are the same as exemplified about in the case when G represents a group that may further have a substituent. Examples of the aryloxy group may include phenoxy, 2-methylphenoxy, 4-t-butylphenoxy, 3-nitrophenoxy, and 2-tetradecanoylamino phenoxy.

The silyloxy group represented by Q, R, X, Y, and Z may preferably be a silyloxy group having 3 to 20 carbon atoms, and examples may include trimethylsilyloxy and t-butyldimethylsilyloxy.

The heterocyclic oxy group represented by Q, R, X, Y, and Z may preferably be a substituted or unsubstituted heterocyclic oxy group having 2 to 30 carbon atoms. Examples of the substituent are the same as exemplified about in the case when G represents a group that may further have a substituent. Examples of the heterocyclic oxy group may include 1-phenyltetrazole-5-oxy and 2-tetrahydropyranyloxy.

The acyloxy group represented by Q, R, X, Y, and Z may preferably be a formyloxy group, a substituted or unsubstituted alkylcarbonyloxy group having 2 to 30 carbon atoms, or a substituted or unsubstituted arylcarbonyloxy group having 6 to 30 carbon atoms. Examples of the substituent are the same as exemplified about in the case when G represents a group that may further have a substituent. Examples of the acyloxy group may include formyloxy, acetyloxy, pivaloyloxy, stearoyloxy, benzoyloxy, and p-methoxyphenyl carbonyloxy.

The carbamoyloxy group represented by Q, R, X, Y, and Z may preferably be a substituted or unsubstituted carbamoyloxy group having 1 to 30 carbon atoms. Examples of the substituent are the same as exemplified about in the case when G represents a group that may further have a substituent. Examples of the carbamoyloxy group may include N,N-dimethylcarbamoyloxy, N,N-diethylcarbamoyloxy, morpholino carbonyloxy, N,N-di-n-octyl aminocarbonyloxy, and N-n-octyl carbamoyloxy.

The alkoxy carbonyloxy group represented by Q, R, X, Y, and Z may preferably be a substituted or unsubstituted alkoxy carbonyloxy group having 2 to 30 carbon atoms. Examples of the substituent are the same as exemplified about in the case when G represents a group that may further have a substituent. Examples of the alkoxy carbonyloxy group may include methoxycarbonyloxy, ethoxycarbonyloxy, t-butoxycarbonyloxy, and n-octyl carbonyloxy.

The aryloxycarbonyloxy group represented by Q, R, X, Y, and Z may preferably be a substituted or unsubstituted aryloxycarbonyloxy group having 7 to 30 carbon atoms. Examples of the substituent are the same as exemplified about in the case when G represents a group that may further have a substituent. Example of the aryloxycarbonyloxy group may include phenoxy carbonyloxy, p-methoxy phenoxy carbonyloxy, and p-n-hexadecyloxyphenoxy carbonyloxy.

The amino group represented by Q, R, X, Y, and Z may preferably be a substituted or unsubstituted alkylamino group having 1 to 30 carbon atoms or a substituted or unsubstituted arylamino group having 6 to 30 carbon atoms. Examples of the substituent are the same as exemplified about in the case when G represents a group that may further have a substituent. Examples of the amino group may include amino, methylamino, dimethylamino, anilino, N-methyl-anilino, diphenylamino, hydroxyethylamino, carboxy ethylamino, sulfoethylamino, and 3,5-dicarboxyanilino.

The acylamino group represented by Q, R, X, Y, and Z may preferably be a formylamino group, a substituted or unsubstituted alkyl carbonylamino group having 1 to 30 carbon atoms, and a substituted or unsubstituted aryl carbonylamino group having 6 to 30 carbon atoms. Examples of the substituent are the same as exemplified about in the case when G represents a group that may further have a substituent. Examples of the acylamino group may include formylamino, acetylamino, pivaloylamino, lauroylamino, benzoylamino, and 3,4,5-tri-n-octyloxyphenylcarbonylamino.

The aminocarbonylamino group represented by Q, R, X, Y, and Z may preferably be a substituted or unsubstituted aminocarbonylamino group having 1 to 30 carbon atoms. Examples of the substituent are the same as exemplified about in the case when G represents a group that may further have a substituent. Examples of the aminocarbonylamino group may include carbamoylamino, N,N-dimethylaminocarbonylamino, N,N-diethylaminocarbonylamino, and morpholinocarbonylamino.

The alkoxycarbonylamino group represented by Q, R, X, Y, and Z may preferably be a substituted or unsubstituted alkoxycarbonylamino group having 2 to 30 carbon atoms. Examples of the substituent are the same as exemplified about in the case when G represents a group that may further have a substituent. Examples of the alkoxycarbonylamino group may include methoxycarbonylamino, ethoxycarbonylamino, t-butoxycarbonylamino, n-octadecyloxycarbonylamino, and N-methyl-methoxycarbonylamino.

The aryloxycarbonylamino group represented by Q, R, X, Y, and Z may preferably be a substituted or unsubstituted aryloxycarbonylamino group having 7 to 30 carbon atoms. Examples of the substituent are the same as exemplified about in the case when G represents a group that may further have a substituent. Examples of the aryloxycarbonylamino group may include phenoxycarbonylamino, p-chlorophenoxycarbonylamino, and m-n-octyloxyphenoxycarbonylamino.

The sulfamoylamino group represented by Q, R, X, Y, and Z may preferably be a substituted or unsubstituted sulfamoylamino group having 0 to 30 carbon atoms. Examples of the substituent are the same as exemplified about in the case when G represents a group that may further have a substituent. Examples of the sulfamoylamino group may include sulfamoylamino, N,N-dimethylamino sulfonylamino, and N-n-octylamino sulfonylamino.

The alkylsulfonylamino group and the arylsulfonylamino group represented by Q, R, X, Y, and Z may preferably be a substituted or unsubstituted alkylsulfonylamino group having 1 to 30 carbon atoms or a substituted or unsubstituted arylsulfonylamino group having 6 to 30 carbon atoms. Examples of the substituent are the same as exemplified about in the case when G represents a group that may further have a substituent. Examples of the alkylsulfonylamino group and the arylsulfonylamino group may include methylsulfonylamino, butylsulfonylamino, phenylsulfonylamino, 2,3,5-trichlorophenyl sulfonylamino, and p-methylphenyl sulfonylamino.

The alkylthio group represented by Q, R, X, Y, and Z may preferably be a substituted or unsubstituted alkylthio group having 1 to 30 carbon atoms. Examples of the substituent are the same as exemplified about in the case when G represents a group that may further have a substituent. Examples of the alkylthio group may include methylthio, ethylthio, and n-hexadecylthio.

The arylthio group represented by Q, R, X, Y, and Z may preferably be a substituted or unsubstituted arylthio group having 6 to 30 carbon atoms. Examples of the substituent are the same as exemplified about in the case when G represents a group that may further have a substituent. Examples of the arylthio group may include phenylthio, p-chlorophenylthio, and m-methoxyphenylthio.

The heterocyclic thio group represented by Q, R, X, Y, and Z may preferably be a substituted or unsubstituted heterocyclic thio group having 2 to 30 carbon atoms. Examples of the substituent are the same as exemplified about in the case when G represents a group that may further have a substituent. Examples of the heterocyclic thio group may include 2-benzothiazolylthio and 1-phenyltetrazol-5-yl thio.

The sulfamoyl group represented by Q, R, X, Y, and Z may preferably be a substituted or unsubstituted sulfamoyl group having 0 to 30 carbon atoms. Examples of the substituent are the same as exemplified about in the case when G represents a group that may further have a substituent. Examples of the sulfamoyl group may include N-ethyl sulfamoyl, N-(3-dodecyloxypropyl)sulfamoyl, N,N-dimethyl sulfamoyl, N-acetyl sulfamoyl, N-benzoyl sulfamoyl, and N—(N′-phenylcarbamoyl)sulfamoyl.

The alkylsulfinyl group and the arylsulfinyl group represented by Q, R, X, Y, and Z may preferably be a substituted or unsubstituted alkyl sulfinyl group having 1 to 30 carbon atoms or a substituted or unsubstituted aryl sulfinyl group having 6 to 30 carbon atoms. Examples of the substituent are the same as exemplified about in the case when G represents a group that may further have a substituent. Examples of the alkyl sulfinyl group and the aryl sulfinyl group may include methylsulfinyl, ethylsulfinyl, phenylsulfinyl, and p-methylphenylsulfinyl.

The alkylsulfonyl group and the arylsulfonyl group represented by Q, R, X, Y, and Z may preferably be a substituted or unsubstituted alkylsulfonyl group having 1 to 30 carbon atoms and a substituted or unsubstituted arylsulfonyl group having 6 to 30 carbon atoms. Examples of the substituent are the same as exemplified about in the case when G represents a group that may further have a substituent. Examples of the alkylsulfonyl group and the arylsulfonyl group may include methylsulfonyl, ethylsulfonyl, phenylsulfonyl, and p-toluenesulfonyl.

The acyl group represented by Q, R, X, Y, and Z may preferably be a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms that is bonded to a carbonyl group via a carbon atom. Examples of the substituent are the same as exemplified about in the case when G represents a group that may further have a substituent. Examples of the acyl group may include acetyl, pivaloyl, 2-chloroacetyl, stearoyl, benzoyl, p-n-octyloxyphenyl carbonyl, 2-pyridylcarbonyl, and 2-furylcarbonyl.

The aryloxycarbonyl group represented by Q, R, X, Y, and Z may preferably be a substituted or unsubstituted aryloxycarbonyl group having 7 to 30 carbon atoms. Examples of the substituent are the same as exemplified about in the case when G represents a group that may further have a substituent. Examples of the aryloxycarbonyl group may include phenoxycarbonyl, o-chlorophenoxycarbonyl, m-nitrophenoxycarbonyl, and p-t-butylphenoxycarbonyl.

The alkoxycarbonyl group represented by Q, R, X, Y, and Z may preferably be a substituted or unsubstituted alkoxycarbonyl group having 2 to 30 carbon atoms. Examples of the substituent are the same as exemplified about in the case when G represents a group that may further have a substituent. Examples of the alkoxycarbonyl group may include methoxycarbonyl, ethoxycarbonyl, t-butoxycarbonyl, and n-octadecyloxycarbonyl.

The carbamoyl group represented by Q, R, X, Y, and Z may preferably be a substituted or unsubstituted carbamoyl group having 1 to 30 carbon atoms. Examples of the substituent are the same as exemplified about in the case when G represents a group that may further have a substituent. Examples of the carbamoyl group may include carbamoyl, N-methylcarbamoyl, N,N-dimethylcarbamoyl, N,N-di-n-octyl carbamoyl, and N-(methylsulfonyl)carbamoyl.

The phosphino group represented by Q, R, X, Y, and Z may preferably be a substituted or unsubstituted phosphino group having 2 to 30 carbon atoms. Examples of the substituent are the same as exemplified about in the case when G represents a group that may further have a substituent. Examples of the phosphino group may include dimethylphosphino, diphenylphosphino, and methylphenoxyphosphino.

The phosphinyl group represented by Q, R, X, Y, and Z may preferably be a substituted or unsubstituted phosphinyl group having 2 to 30 carbon atoms. Examples of the substituent are the same as exemplified about in the case when G represents a group that may further have a substituent. Examples of the phosphinyl group may include phosphinyl, dioctyloxyphosphinyl, and diethoxyphosphinyl.

The phosphinyloxy group represented by Q, R, X, Y, and Z may preferably be a substituted or unsubstituted phosphinyloxy group having 2 to 30 carbon atoms. Examples of the substituent are the same as exemplified about in the case when G represents a group that may further have a substituent. Examples of the phosphinyloxy group may include diphenoxyphosphinyloxy and dioctyloxyphosphinyloxy.

The phosphinylamino group represented by Q, R, X, Y, and Z may preferably be a substituted or unsubstituted phosphinylamino group having 2 to 30 carbon atoms. Examples of the substituent are the same as exemplified about in the case when G represents a group that may further have a substituent. Examples of the phosphinylamino group may include dimethoxyphosphinylamino and dimethylaminophosphinylamino.

The silyl group represented by Q, R, X, Y, and Z may preferably be a substituted or unsubstituted silyl group having 3 to 30 carbon atoms. Examples of the substituent are the same as exemplified about in the case when G represents a group that may further have a substituent. Examples of the silyl group may include trimethylsilyl, t-butyldimethylsilyl, and phenyldimethylsilyl.

Examples of the azo group represented by Q, R, X, Y, and Z may include phenylazo, 4-methoxyphenylazo, 4-pivaloylaminophenylazo, and 2-hydroxy-4-propanoylphenylazo.

Examples of the imido group represented by Q, R, X, Y, and Z may include N-succinimide and N-phthalimide.

When Q, R, X, Y, and Z represent a divalent group, the divalent group is preferably an alkylene group (e.g., methylene, ethylene, propylene, butylene, or pentylene), an alkenylene group (e.g., ethenylene or propenylene), an alkynylene group (e.g., ethynylene or propynylene), an arylene group (e.g., phenylene or naphthylene), a divalent heterocyclic group (e.g., 6-chloro-1,3,5-triazine-2,4-diyl group, pyrimidine-2,4-diyl group, pyrimidine-4,6-diyl group, quinoxaline-2,3-diyl group, or pyridazine 3,6-diyl), —O—, —CO—, —NR′—(R′ represents a hydrogen atom, an alkyl group, or an aryl group.) —S—, —SO₂—, —SO—, or combination thereof (e.g., —NHCH₂CH₂NH—, —NHCONH—, and the like).

An alkylene group, an alkenylene group, an alkynylene group, an arylene group, a divalent heterocyclic group, and an alkyl group or an aryl group of R' may further have a substituent. Examples of the substituent are the same as the substituents described for the G.

The alkyl group and the aryl group of the R' are the same as the examples of the substituent of the G.

More preferable examples of divalent group as the divalent substituent may include an alkylene group having 10 or less carbon atoms, an alkenylene group having 10 or less carbon atoms, an alkynylene group having 10 or less carbon atoms, an arylene group having 6 to 10 carbon atoms, a divalent heterocyclic group, —S—, —SO—, —SO₂—, and a combination thereof (e.g., —SCH₂CH₂S— or —SCH₂CH₂CH₂S—) is more preferable.

The total number of carbon atoms of the divalent substituent is preferably from 0 to 50, more preferably from 0 to 30, and most preferably from 0 to 10.

When Q, R, X, Y, and Z each represent a trivalent substituent, the trivalent substituent is preferably a trivalent hydrocarbon group, a trivalent heterocyclic group, >N—, or a combination thereof and a divalent substituent (e.g., >NCH₂CH₂NH—, >NCONH—, and the like).

The total number of carbon atoms of the trivalent substituent is preferably from 0 to 50, more preferably from 0 to 30, and most preferably from 0 to 10.

In Formula (Y-I), preferable examples of n is 1 or 2, and 2 is particularly preferable.

In Formula (Y-I), preferable examples of a substituent of X is an electron attracting group. In particular, an electron attracting group having a Hammett's substituent constant δp value of 0.20 or more is preferable, and an electron attracting group having a δp value of 0.30 or more is more preferable. The upper limit of the δp value of the electron attracting group is 1.0.

Specific examples of X which is an electron attracting group having a δp value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, an alkyl halide group, an alkoxy halide group, an aryloxy halide group, an alkylamino halide group, an alkylthio halide group, an aryl group substituted by another electron attracting group having a δp value of 0.20 or more, a heterocyclic group, a halogen atom, an azo group, and a selenocyanate group.

Preferable examples of X may include an acyl group having 2 to 12 carbon atoms, an acyloxy group having 2 to 12 carbon atoms, a carbamoyl group having 1 to 12 carbon atoms, an alkyloxycarbonyl group having 2 to 12 carbon atoms, an aryloxycarbonyl group having 7 to 18 carbon atoms, a cyano group, a nitro group, an alkylsulfinyl group having 1 to 12 carbon atoms, an arylsulfinyl group having 6 to 18 carbon atoms, an alkylsulfonyl group having 1 to 12 carbon atoms, an arylsulfonyl group having 6 to 18 carbon atoms, a sulfamoyl group having 0 to 12 carbon atoms, an alkyl halide group having 1 to 12 carbon atoms, an alkyloxy halide group having 1 to 12 carbon atoms, an alkyl thio halide group having 1 to 12 carbon atoms, an aryloxy halide group having 7 to 18 carbon atoms, an aryl group having 7 to 18 carbon atoms, substituted by two or more electron attracting groups having a δp of 0.20 or more, and a 5- to 8-membered heterocyclic group having 1 to 18 carbon atoms and including a nitrogen atom, an oxygen atom, or a sulfur atom.

More preferable examples include a cyano group, an alkylsulfonyl group having 1 to 12 carbon atoms, an arylsulfonyl group having 6 to 18 carbon atoms, and a sulfamoyl group having 0 to 12 carbon atoms.

Particularly preferable examples of X include a cyano group, an alkylsulfonyl group having 1 to 12 carbon atoms, and a sulfamoyl group having 0 to 12 carbon atoms. Most preferable examples of X include a cyano group and an alkylsulfonyl group having 1 to 12 carbon atoms.

In Formula (Y-I), preferable examples of the substituent of Z include a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, and a substituted or unsubstituted heterocyclic group.

Detailed examples of the substituent represented by Z are the same as the corresponding substituent examples described for the examples of the heterocyclic group represented by the G, and preferable examples thereof are also the same.

A particularly preferable substituents represented by Z include a substituted aryl group and a substituted heterocyclic group. Among the above, a substituted aryl group is particularly preferable.

In Formula (Y-I), preferable examples of the substituent of Q include a hydrogen atom, a substituted or unsubstituted alkyl group, a substituted or unsubstituted acyl group, a substituted or unsubstituted alkylsulfonyl group, and a substituted or unsubstituted arylsulfonyl group. Particularly preferable examples include a hydrogen atom, a substituted or unsubstituted alkyl group, and a substituted or unsubstituted acyl group. Among the above, a hydrogen atom is particularly preferable.

In Formula (Y-I), R is preferably a substituted or unsubstituted alkyl group having a total carbon number of 1 to 12, a substituted or unsubstituted aryl group having a total carbon number of 6 to 18, or a substituted or unsubstituted heterocyclic group having a total carbon number of 4 to 12. Among the above, a straight chain or branched alkyl group having a total carbon number of 1 to 8 is preferable, a secondary or tertiary alkyl group is particularly preferable, and a t-butyl group is most preferable.

In Formula (Y-I), Y is preferably a hydrogen atom, a substituted or unsubstituted alkyl group having a total carbon number of 1 to 12, a substituted or unsubstituted aryl group having a total carbon number of 6 to 18, or a substituted or unsubstituted heterocyclic group having a total carbon number of 4 to 12. Among the above, a hydrogen atom or a straight chain and/or branched alkyl group having a total carbon number of 1 to 8 are/is preferable, a hydrogen atom or an alkyl group having 1 to 8 carbon atoms is particularly preferable, and a hydrogen atom is most preferable.

As the combination of the preferable substituents of the water-soluble azo dye represented by Formula (Y-I) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-I) of the invention include the following (A) to (G):

(A) G is preferably a 5- to 8-membered nitrogen-containing heterocyclic group. In particular, a group derived from an S-triazine ring, a pyrimidine ring, a pyridazine ring, a pyrazine ring, a pyridine ring, an imidazole ring, a pyrazole ring, or a pyrrole ring is preferable. Among the above, a group derived from an S-triazine ring, a pyrimidine ring, a pyridazine ring, or a pyrazine ring is preferable, with an S-triazine ring is most preferable.

(B) R is preferably a substituted or unsubstituted alkyl group having a total carbon number of 1 to 12, a substituted or unsubstituted aryl group having a total carbon number of 6 to 18, or a substituted or unsubstituted heterocyclic group having a total carbon number of 4 to 12. Among the above, a straight chain or branched alkyl group having a total carbon number of 1 to 8 is preferable, a secondary or tertiary alkyl group is particularly preferable, and a t-butyl group is most preferable.

(C) As X, a cyano group, an alkylsulfonyl group having 1 to 12 carbon atoms, an arylsulfonyl group having 6 to 18 carbon atoms, or a sulfamoyl group having 0 to 12 carbon atoms is particularly preferably. Among the above, a cyano group or an alkylsulfonyl group having 1 to 12 carbon atoms is preferable, and a cyano group is most preferable.

(D) Y is preferably a hydrogen atom, a substituted or unsubstituted alkyl group having a total carbon number of 1 to 12, a substituted or unsubstituted aryl group having a total carbon number of 6 to 18, or a substituted or unsubstituted heterocyclic group having a total carbon number of 4 to 12. Among the above, a hydrogen atom or a straight chain or branched alkyl group having a total carbon number of 1 to 8 is preferable, a hydrogen atom or an alkyl group having 1 to 8 carbon atoms is particularly preferable, and a hydrogen atom is most preferable.

(E) Z is preferably a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, further, a substituted aryl group or a substituted heterocyclic group is more preferable substituents. Among the above, a substituted aryl group is particularly preferable.

(F) Q is preferably a hydrogen atom, a substituted or unsubstituted alkyl group, a substituted or unsubstituted acyl group, a substituted or unsubstituted alkylsulfonyl group, or a substituted or unsubstituted arylsulfonyl group, further, a hydrogen atom, a substituted or unsubstituted alkyl group, or a substituted or unsubstituted acyl group is more preferable. Among the above, a hydrogen atom is particularly preferable.

(G) n represents an integer of 1 to 3, preferably 1 or 2, and 2 is most preferable.

Among the azo dyes represented by Formula (Y-I), the dyes represented by Formulae (Y-1) to (Y-5) are preferable:

Hereinafter, Formula (Y-1) will be described in detail.

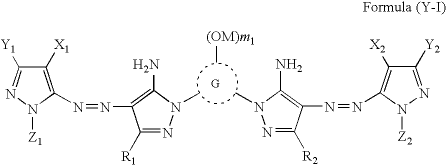

R₁, R₂, X₁, X₂, Y₁, Y₂, Z₁, and Z₂ each represent a monovalent group.

The monovalent group represents a hydrogen atom or a monovalent substituent. Examples of the monovalent substituent are the same as the examples of the monovalent substituents of R, X, Y, and Z in Formula (Y-I), and preferable examples thereof are also the same. m₁ represents an integer of 0 to 3.

Hereinafter, the R₁, R₂, X₁, X₂, Y₁, Y₂, Z₁, and Z₂ will be described in more detail. Examples of the substituents of R₁ and R₂ are each independently the same as the examples of R in Formula (Y-I), and preferable examples thereof are also the same. Examples of the substituents of Y₁ and Y₂ are each independently the same as the examples of Y in Formula (Y-I), and preferable examples thereof are also the same. Examples of the substituents of Z₁ and Z₂ are each independently the same as the examples of Z in Formula (Y-I), and preferable examples thereof are also the same.

Hereinafter, the G and m₁ will be described in more detail. G represents an atomic group forming a 5- to 8-membered nitrogen-containing heterocyclic group. Preferable examples of the 5- to 8-membered nitrogen-containing heterocyclic group represented by G include an S-triazine ring, a pyrimidine ring, a pyridazine ring, a pyrazine ring, a pyridine ring, an imidazole ring, a pyrazole ring, and a pyrrole ring. Among the above, an S-triazine ring, a pyrimidine ring, a pyridazine ring, or a pyrazine ring is more preferable, further an S-triazine ring is most preferable.

m₁ is an integer of 0 to 3. When an —OM group may be substituted on a structure of a preferable example of the 5- to 8-membered nitrogen-containing heterocyclic group represented by G, m₁ is preferably from 0 to 2. Among the above, m₁ is preferably 0 or 1, and particularly m₁=1 is most preferable.

Hereinafter, the M will be described in more detail. M represents a hydrogen atom or cation. The cation represented by M includes an alkali metal ion, ammonium, and quaternary ammonium cation, and preferably Li, Na, K, NH₄ or NR₄. R includes an alkyl group and an aryl group, and the examples thereof are the same as the examples of the alkyl group and the aryl group represented by R₁. Among the above, preferable examples of the cation represented by M include Li, Na, K, and NH₄, further, Li, Na, or K is particularly preferable.

As the combination of the preferable substituents of the dye represented by Formula (Y-1) of the invention, a compound in which at least one of various substituents is the above mentioned preferable group is preferable, a compound in which a larger number of various substituents are the above mentioned preferable groups is more preferable, and a compound in which all the substituents are the above mentioned preferable groups is most preferable.

The particularly preferable combinations for the dye represented by Formula (Y-1) of the invention include the following (A) to (G):

(A) R₁ and R₂ may be the same or different from each other, and preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Among the above, a straight chain or branched alkyl group having a total number of carbon atoms of from 1 to 8 is preferable, a secondary or tertiary alkyl group is particularly preferable, and a t-butyl group is most preferable.

(B) X₁ and X₂ may be the same or different from each other, and preferably X₁ and X₂ each independently represent an electron attracting group having a Hammett's substituent constant δp value of 0.20 or more. Further, an electron attracting group having a δp value of 0.30 or more is preferable. The upper limit of the δp value of the electron attracting group is 1.0. Among the above, a cyano group, an alkylsulfonyl group having 1 to 12 carbon atoms, an arylsulfonyl group having 6 to 18 carbon atoms, or a sulfamoyl group having 0 to 12 carbon atoms is preferable, and a cyano group or an alkylsulfonyl group having 1 to 12 carbon atoms is most preferable.

(C) Y₁ and Y₂ may be the same or different from each other, and preferable examples thereof include a hydrogen atom, a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Further, a hydrogen atom or a substituted or unsubstituted alkyl group is more preferable. Among the above, a hydrogen atom is most preferable.

(D) Z₁ and Z₂ may be the same or different from each other, and preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Further, a substituted or unsubstituted aryl group or a substituted or unsubstituted heterocyclic group is more preferable. In particular, a substituted aryl group is most preferable.

(E) G represents an atomic group forming a 5- to 8-membered nitrogen-containing heterocyclic group. Preferable examples of the 5- to 8-membered nitrogen-containing heterocyclic group include a group derived from an S-triazine ring, a pyrimidine ring, a pyridazine ring, a pyrazine ring, a pyridine ring, an imidazole ring, a pyrazole ring, and a pyrrole ring. Among the above, a group derived from an S-triazine ring, a pyrimidine ring, a pyridazine ring, or a pyrazine ring is more preferable, and a group derived from an S-triazine ring is most preferable.

(F) m₁ is an integer from 0 to 3. When an —OM group may be substituted to a structure of a preferable example of the 5- to 8-membered nitrogen-containing heterocyclic group represented by G, m₁ is preferably from 0 to 2. Among the above, m₁ is preferably 0 or 1, and particularly m₁=1 is most preferable.

(G) M is preferably a hydrogen atom or a cation, particularly preferably a hydrogen atom, an alkali metal ion, or an ammonium or quaternary ammonium cation, and more preferably Li, Na, K, or NH₄.

Hereinafter, Formula (Y-2) will be described in detail.

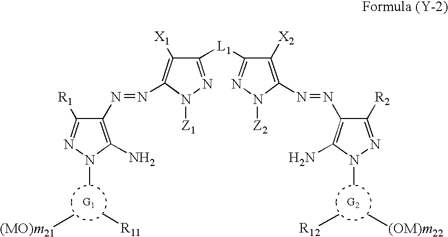

R₁, R₂, R₁₁, R₁₂, X₁, X₂, Z₁, and Z₂ each represent a monovalent group. The monovalent group represents a hydrogen atom or a monovalent substituent. L₁ represents a divalent linking group. G₁ and G₂ each independently represent an atomic group forming a 5- to 8-membered nitrogen-containing heterocyclic group.

m₂₁ and m₂₂ each independently represent an integer from 0 to 3. When an —OM group may be substituted to a structure of a preferable example of the 5- to 8-membered nitrogen-containing heterocyclic group represented by G₁ or G₂, m₂₁ and m₂₂ each independently is preferably from 0 to 2 and more preferably 0 or 1. In particular, it is most preferable that m₂₁ is 1 and m₂₂ is also 1.

M represents a hydrogen atom or cation. Hereinafter, Formula (Y-2) mentioned above will be described in more detail.

In Formula (Y-2), preferable examples of the substituents of R₁ and R₂ are the same as the examples of the substituents of R₁, R₂, Y₁, and Y₂ described for Formula (Y-1), and preferable examples thereof are also the same.

In Formula (Y-2), preferable examples of the substituents of X₁ and X₂ are the same as the examples of the substituents of X₁ and X₂ described for Formula (Y-1), and preferable examples thereof are also the same.

In Formula (Y-2), preferable examples of the substituents of Z₁ and Z₂ are the same as the examples of the substituents of Z₁ and Z₂ described for Formula (Y-1), and preferable examples thereof are also the same.

In Formula (Y-2), preferable examples of G₁ and G₂ are the same as the examples of G described for Formula (Y-1), and preferable examples thereof are also the same.

In Formula (Y-2), preferable examples of M are the same as the examples of M described for Formula (Y-1), and preferable examples thereof are also the same.

In Formula (Y-2), preferable examples of the substituents of R₁₁ and R₁₂ are the same as the examples of the substituents of R₁, R₂, Y₁, and Y₂ described for Formula (Y-1). Preferable examples thereof include an —OM group (wherein M is a hydrogen atom or cation), a substituted or unsubstituted amino group; an alkylamino group having 1 to 12 carbon atoms, an arylamino group having 6 to 18 carbon atoms, a substituted or unsubstituted alkylthio group having 1 to 12 carbon atoms, and a substituted or unsubstituted arylthio group having 6 to 18 carbon atoms.

In Formula (Y-2), the divalent linking group represented by L₁ is preferably an alkylene group (e.g., methylene, ethylene, propylene, butylene, or pentylene), an alkenylene group (e.g., ethenylene or propenylene), an alkynylene group (e.g., ethynylene or propynylene), an arylene group (e.g., phenylene or naphthylene), a divalent heterocyclic group (e.g., a 6-chloro-1,3,5-triazine-2,4-diyl group, a pyrimidine-2,4-diyl group, a pyrimidine-4,6-diyl group, a quinoxaline-2,3-diyl group, or a pyridazine-3,6-diyl), —O—, —CO—, —NR— (wherein R is a hydrogen atom, an alkyl group, or an aryl group), —S—, —SO₂—, —SO—, or a combination thereof (e.g., —NHCH₂CH₂NH—, —NHCONH—, and the like).

An alkylene group, an alkenylene group, an alkynylene group, an arylene group, a divalent heterocyclic group, or an alkyl group or an aryl group of R may each have a substituent. Examples of the substituent are the same as the substituents of R₁, R₂, Y₁, and Y₂ in Formula (Y-1).

The alkyl group and the aryl group of the R are the same as the examples of the substituents of R₁, R₂, Y₁, and Y₂ in Formula (Y-1).

More preferable examples of the divalent linking group include an alkylene group having 10 or less carbon atoms, an alkenylene group having 10 or less carbon atoms, an alkynylene group having 10 or less carbon atoms, an arylene group having 6 to 10 carbon atoms, —S—, —SO—, —SO₂—, or a combination thereof (e.g., —SCH₂CH₂S—, —SCH₂CH₂CH₂S—, and the like).

The total number of carbon atoms of the divalent linking group is preferably 0 to 50, more preferably 0 to 30, and most preferably 0 to 10.

As the combination of the preferable substituents of the dye represented by Formula (Y-2) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-2) of the invention include the following (A) to (H):

(A) R₁ and R₂ may be the same or different from each other, and preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Among the above, a straight chain or branched alkyl group having a total number of carbon atoms of from 1 to 8 is more preferable, a secondary or tertiary alkyl group is particularly preferable, and a t-butyl group is most preferable.

(B) X₁ and X₂ may be the same or different from each other and preferably X₁ and X₂ each independently represent an electron attracting group having a Hammett's substituent constant δp value of 0.20 or more is preferable. An electron attracting group with a δp value of 0.30 or more is more preferable. The upper limit of the δp value of the electron attracting group is 1.0. Among the above, a cyano group, an alkylsulfonyl group having 1 to 12 carbon atoms, an arylsulfonyl group having 6 to 18 carbon atoms, or a sulfamoyl group having 0 to 12 carbon atoms is preferable, and a cyano group or an alkylsulfonyl group having 1 to 12 carbon atoms is most preferable.

(C) Z₁ and Z₂ may be the same or different from each other, and preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. A substituted or unsubstituted aryl group or a substituted or unsubstituted heterocyclic group is more preferable, and particularly, a substituted aryl group is most preferable.

(D) G₁ and G₂ may be the same or different from each other, and represent an atomic group forming a 5- to 8-membered nitrogen-containing heterocyclic group. Preferable examples of the 5- to 8-membered nitrogen-containing heterocycle include an S-triazine ring, a pyrimidine ring, a pyridazine ring, a pyrazine ring, a pyridine ring, an imidazole ring, a pyrazole ring, and a pyrrole ring. Among the above, an S-triazine ring, a pyrimidine ring, a pyridazine ring, or a pyrazine ring is more preferable, and an S-triazine ring is most preferable.

(E) m₂₁ and m₂₂ each independently represent an integer from 0 to 3. When an —OM group may be substituted on a structure of a preferable example of the 5- to 8-membered nitrogen-containing heterocyclic group represented by G₁ or G₂, m₂₁ and m₂₂ each independently is preferably from 0 to 2 and more preferably 0 or 1. In particular, it is most preferable that m₂₁ is 1 and m₂₂ is also 1.

(F) M is preferably a hydrogen atom or a cation, particularly preferably a hydrogen atom, an alkali metal ion, or an ammonium or quaternary ammonium cation, and more preferably Li, Na, K, or NH₄.

(G) R₁₁ and R₁₂ may be the same or different from each other, and preferable examples thereof include an —OM group (wherein M is a hydrogen atom or cation), a substituted or unsubstituted amino group (an alkylamino group having 1 to 12 carbon atoms, an arylamino group having 6 to 18 carbon atoms, etc.), a substituted or unsubstituted alkylthio group having 1 to 12 carbon atoms, or a substituted or unsubstituted arylthio group having 6 to 18 carbon atoms. Among the above, an unsubstituted amino group, an alkylamino group having 1 to 12 carbon atoms, an arylamino group having 6 to 18 carbon atoms, a substituted or unsubstituted alkylthio group having 1 to 12 carbon atoms, or a substituted or unsubstituted arylthio group having 6 to 18 carbon atoms is preferable. In particular, an unsubstituted amino group, a dialkylamino group having 1 to 12 carbon atoms, an arylamino group having 6 to 18 carbon atoms, or a substituted or unsubstituted alkylthio group having 1 to 12 carbon atoms is more preferable.

(H) L₁ is preferably an alkylene group having 10 or less carbon atoms, an alkenylene group having 10 or less carbon atoms, an alkynylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), more preferably an alkylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), and particularly preferably an alkylene group having 10 or less carbon atoms, —SCH₂CH₂S—, or —SCH₂CH₂CH₂S—.

Hereinafter, Formula (Y-3) will be described in detail.

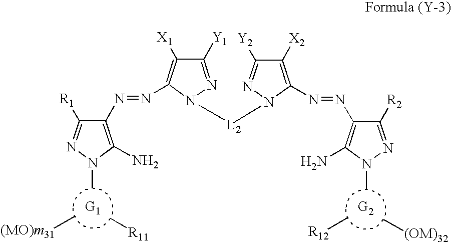

R₁, R₂, R₁₁, R₁₂, X₁, X₂, Y₁, and Y₂ each represent a monovalent group. The monovalent group represents a hydrogen atom or a monovalent substituent. L₂ represents a divalent linking group.

G₁ and G₂ each independently represent an atomic group forming a 5- to 8-membered nitrogen-containing heterocyclic group. m₃₁ and m₃₂ each independently represent an integer from 0 to 3. M represents a hydrogen atom or a cation.

Hereinafter, Formula (Y-3) mentioned above will be described in more detail. In Formula (Y-3), preferable examples of the substituents of R₁, R₂, Y₁, and Y₂ are the same as the examples of the substituents of R₁, R₂, Y₁, and Y₂ described for Formula (Y-1), and preferable examples thereof are also the same.

In Formula (Y-3), preferable examples of the substituents of X₁ and X₂ are the same as the examples of the substituents of X₁ and X₂ described for Formula (Y-1), and preferable examples thereof are also the same.

In Formula (Y-3), preferable examples of G₁ and G₂ are the same as the examples of G described for Formula (Y-1), and preferable examples thereof are also the same.

In Formula (Y-3), preferable examples of m₃₁ and m₃₂ are the same as the examples of m₃₁ and m₃₂ described for Formula (Y-2), and preferable examples thereof are also the same.

In Formula (Y-3), preferable examples of M are the same as the examples of M described for Formula (Y-1), and preferable examples thereof are also the same.

In Formula (Y-3), preferable examples of the substituents of R₁₁ and R₁₂ are the same as the examples of the substituents of R₁₁ and R₁₂ described for Formula (Y-2), and preferable examples thereof are also the same.

In Formula (Y-3), the divalent linking groups represented by L₂ are the same as the examples of L₁ described for Formula (Y-2), and the preferable examples thereof are also the same.

As the combination of the preferable substituents of the dye represented by Formula (Y-3) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-3) of the invention include the following (A) to (H):

(A) R₁ and R₂ may be the same or different from each other. Preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Among the above, a straight chain or branched alkyl group having a total number of carbon atoms of from 1 to 8 is preferable, a secondary or tertiary alkyl group is particularly preferable, and a t-butyl group is most preferable.

(B) X₁ and X₂ may be the same or different from each other. Preferably, X₁ and X₂ each independently represent an electron attracting group having a Hammett's substituent constant δp value of 0.20 or more. Further, an electron attracting group having a δp value of 0.30 or more is more preferable. The upper limit of the δp value of the electron attracting group is 1.0. Among the above, a cyano group, an alkylsulfonyl group having 1 to 12 carbon atoms, an arylsulfonyl group having 6 to 18 carbon atoms, or a sulfamoyl group having 0 to 12 carbon atoms is preferable, and a cyano group or an alkylsulfonyl group having 1 to 12 carbon atoms is most preferable.

(C) Y₁ and Y₂ may be the same or different from each other. Preferable examples thereof include a hydrogen atom, a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. A hydrogen atom or a substituted or unsubstituted alkyl group is more preferable. Among the above, a hydrogen atom is most preferable.

(D) G₁ and G₂ may be the same or different from each other, and represent an atomic group forming a 5- to 8-membered nitrogen-containing heterocyclic group. Preferable examples of the 5- to 8-membered nitrogen-containing heterocycle include an s-triazine ring, a pyrimidine ring, a pyridazine ring, a pyrazine ring, a pyridine ring, an imidazole ring, a pyrazole ring, and a pyrrole ring. Among the above, an s-triazine ring, a pyrimidine ring, a pyridazine ring, or a pyrazine ring is more preferable, and an s-triazine ring is most preferable.

(E) m₃₁ and m₃₂ each independently represent an integer from 0 to 3. When an —OM group may be substituted to a structure of a preferable example of the 5- to 8-membered nitrogen-containing heterocyclic group represented by G₁ or G₂, m₃₁ and m₃₂ each independently is preferably from 0 to 2 and more preferably 0 or 1. In particular, it is most preferable that m₃₁ is 1 and m₃₂ is also 1.

(F) M is preferably a hydrogen atom or a cation, particularly preferably a hydrogen atom, an alkali metal ion, or an ammonium or quaternary ammonium cation, and more preferably Li, Na, K, or NH₄.

(G) R₁₁ and R₁₂ may be the same or different from each other. Preferable examples thereof include an —OM group (M represents a hydrogen atom or cation), a substituted or unsubstituted amino group (an alkylamino group having 1 to 12 carbon atoms, an arylamino group having 6 to 18 carbon atoms, etc.), a substituted or unsubstituted alkylthio group having 1 to 12 carbon atoms, or a substituted or unsubstituted arylthio group having 6 to 18 carbon atoms. Among the above, an unsubstituted amino group, an alkylamino group having 1 to 12 carbon atoms, an arylamino group having 6 to 18 carbon atoms, a substituted or unsubstituted alkylthio group having 1 to 12 carbon atoms, or a substituted or unsubstituted arylthio group having 6 to 18 carbon atoms is preferable. In particular, an unsubstituted amino group, a dialkylamino group having 1 to 12 carbon atoms, an arylamino group having 6 to 18 carbon atoms, or a substituted or unsubstituted alkylthio group having 1 to 12 carbon atoms is more preferable.

(H) L₂ is preferably an alkylene group having 10 or less carbon atoms, an alkenylene group having 10 or less carbon atoms, an alkynylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), more preferably an alkylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), and particularly preferably an alkylene group having 10 or less carbon atoms, —SCH₂CH₂S—, or —SCH₂CH₂CH₂S—.

Hereinafter, Formula (Y-4) will be described in detail.

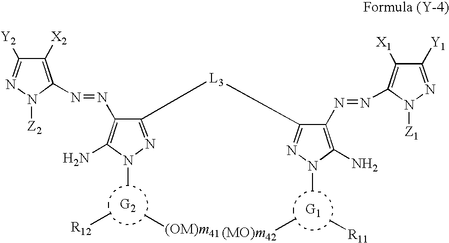

R₁₁, R₁₂, X₁, X₂, Y₁, and Y₂ represent a monovalent group. The monovalent group represents a hydrogen atom or a monovalent substituent. L₃ represents a divalent linking group.

G₁ and G₂ each independently represent an atomic group forming a 5- to 8-membered nitrogen-containing heterocyclic group. m₄₁ and m₄₂ each independently represent an integer from 0 to 3. M represents a hydrogen atom or a cation.

Hereinafter, Formula (Y-4) mentioned above will be described in more detail. In Formula (Y-4), preferable examples of the substituents of Y₁ and Y₂ are the same as the examples of the substituents of R₁, R₂, Y₁, and Y₂ described for Formula (Y-1), and preferable examples thereof are also the same.

In Formula (Y-4), preferable examples of the substituents of X₁ and X₂ are the same as the examples of the substituents of X₁ and X₂ described for Formula (Y-1), and preferable examples thereof are also the same.

In Formula (Y-4), preferable examples of G₁ and G₂ are the same as the examples of G described for Formula (Y-1), and preferable examples thereof are also the same.

In Formula (Y-4), preferable examples of m₄₁ and m₄₂ are the same as the examples of m₂₁ and m₂₂ described for Formula (Y-2), and preferable examples thereof are also the same.

In Formula (Y-4), preferable examples of M are the same as the examples of M described for Formula (Y-1), and preferable examples thereof are also the same.

In Formula (Y-4), preferable examples of the substituents of R₁₁ and R₁₂ are the same as the examples of the substituents of R₁₁ and R₁₂ described for Formula (Y-2), and preferable examples thereof are also the same.

In Formula (Y-4), the divalent linking groups represented by L₃ are the same as the examples of L₁ described for Formula (Y-2), and the preferable examples thereof are also the same.

As the combination of the preferable substituents of the dye represented by Formula (Y-4) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-4) of the invention include the following (A) to (H):

(A) Y₁ and Y₂ may be the same or different from each other. Preferable examples thereof include a hydrogen atom, a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Further, a hydrogen atom or a substituted or unsubstituted alkyl group is preferable. Among the above, a hydrogen atom is most preferable.

(B) X₁ and X₂ may be the same or different from each other. Preferably, X₁ and X₂ each independently represent an electron attracting group having a Hammett's substituent constant δp value of 0.20 or more. An electron attracting group having a δp value of 0.30 or more is more preferable. The upper limit of the δp value of the electron attracting group is 1.0. Among the above, a cyano group, an alkylsulfonyl group having 1 to 12 carbon atoms, an arylsulfonyl group having 6 to 18 carbon atoms, or a sulfamoyl group having 0 to 12 carbon atoms is preferable, and a cyano group or an alkylsulfonyl group having 1 to 12 carbon atoms is most preferable.

(C) Z₁ and Z₂ may be the same or different from each other. Preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Further, a substituted or unsubstituted aryl group or a substituted or unsubstituted heterocyclic group is preferable, and particularly, a substituted aryl group is most preferable.

(D) G₁ and G₂ may be the same or different from each other, and represent an atomic group forming a 5- to 8-membered nitrogen-containing heterocyclic group. Preferable examples of the 5- to 8-membered nitrogen-containing heterocycle include an S-triazine ring, a pyrimidine ring, a pyridazine ring, a pyrazine ring, a pyridine ring, an imidazole ring, a pyrazole ring, and a pyrrole ring. Among the above, an S-triazine ring, a pyrimidine ring, a pyridazine ring, or a pyrazine ring is more preferable, and an S-triazine ring is most preferable.

(E) m₄₁ and m₄₂ each independently represent an integer from 0 to 3. When an —OM group may be substituted on a structure of a preferable example of a 5- to 8-membered nitrogen-containing heterocyclic ring represented by G₁ or G₂, m₄₁ and m₄₂ each independently is preferably from 0 to 2 and more preferably 0 or 1. In particular, it is most preferable that m₄₁ is 1 and m₄₂ is also 1.

(F)M is preferably a hydrogen atom or a cation, particularly preferably a hydrogen atom, an alkali metal ion, or an ammonium or quaternary ammonium cation, and more preferably Li, Na, K, or NH₄.

(G) R₁₁ and R₁₂ may be the same or different from each other. Preferable examples thereof include an —OM group (M represents a hydrogen atom or cation), a substituted or unsubstituted amino group (an alkylamino group having 1 to 12 carbon atoms, an arylamino group having 6 to 18 carbon atoms, etc.), a substituted or unsubstituted alkylthio group having 1 to 12 carbon atoms, and a substituted or unsubstituted arylthio group having 6 to 18 carbon atoms. Among the above, an unsubstituted amino group, an alkylamino group having 1 to 12 carbon atoms, an arylamino group having 6 to 18 carbon atoms, a substituted or unsubstituted alkylthio group having 1 to 12 carbon atoms, or a substituted or unsubstituted arylthio group having 6 to 18 carbon atoms is preferable. In particular, an unsubstituted amino group, a dialkylamino group having 1 to 12 carbon atoms, an arylamino group having 6 to 18 carbon atoms, or a substituted or unsubstituted alkylthio group having 1 to 12 carbon atoms is more preferable.

(H) L₃ is preferably an alkylene group having 10 or less carbon atoms, an alkenylene group having 10 or less carbon atoms, an alkynylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), more preferably an alkylene group having 10 or less carbon atoms, an arylene group having 6 to 10 carbon atoms, —S—, —SO—, —SO₂—, or a combination thereof (e.g., —SCH₂CH₂S— or —SCH₂CH₂CH₂S—), and particularly preferably an alkylene group having 10 or less carbon atoms, —SCH₂CH₂S—, or —SCH₂CH₂CH₂S—.

Hereinafter, Formula (Y-5) will be described in detail.

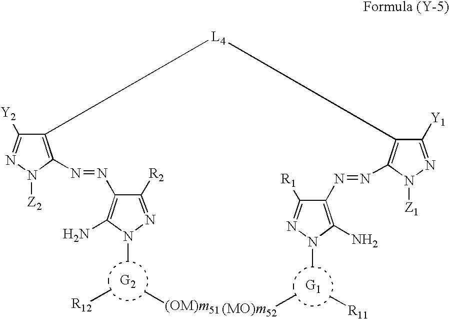

R₁, R₂, R₁₁, R₁₂, Y₁, Y₂, Z₁, and Z₂ represent a monovalent group. The monovalent group represents a hydrogen atom or a monovalent substituent. L₄ represents a divalent linking group.

G₁ and G₂ each independently represent an atomic group forming a 5- to 8-membered nitrogen-containing heterocyclic group. m₅₁ and m₅₂ each independently represent an integer from 0 to 3. M represents a hydrogen atom or a cation.

Hereinafter, Formula (Y-5) mentioned above will be described in more detail. In Formula (Y-5), preferable examples of the substituents of R₁, R₂, Y₁, and Y₂ are the same as the examples of the substituents of R₁, R₂, Y₁, and Y₂ described for Formula (Y-1), and preferable examples thereof are also the same.

In Formula (Y-5), preferable examples of the substituents of Z₁ and Z₂ are the same as the examples of the substituents of Z₁ and Z₂ described for Formula (Y-1), and preferable examples thereof are also the same.

In Formula (Y-5), preferable examples of G₁ and G₂ are the same as the examples of G described for Formula (Y-1), and preferable examples thereof are also the same.

In Formula (Y-5), preferable examples of m₅₁ and m₅₂ are the same as the examples of m₂₁ and m₂₂ described for Formula (Y-1), and preferable examples thereof are also the same.

In Formula (Y-5), preferable examples of M are the same as the examples of M described for Formula (Y-2), and preferable examples thereof are also the same.

In Formula (Y-5), preferable examples of the substituents of R₁₁ and R₁₂ are the same as the examples of the substituents of R₁₁ and R₁₂ described for Formula (Y-2), and preferable examples thereof are also the same.

In Formula (Y-5), the divalent linking group represented by L₄ is the same as the examples of L₁ described for Formula (Y-2), and the preferable examples thereof are also the same.

As the combination of the preferable substituents of the dye represented by Formula (Y-5) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-5) of the invention include the following (A) to (H):

(A) R₁ and R₂ may be the same or different from each other. Preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Among the above, a straight chain or branched alkyl group having a total number of carbon atoms of from 1 to 8 is preferable, a secondary or tertiary alkyl group is particularly preferable, and a t-butyl group is most preferable.

(B) Y₁ and Y₂ may be the same or different from each other. Preferable examples thereof include a hydrogen atom, a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. A hydrogen atom or a substituted or unsubstituted alkyl group is more preferable. Among the above, a hydrogen atom is most preferable.

(C) Z₁ and Z₂ may be the same or different from each other. A substituted or unsubstituted alkyl group having a total number of carbon atoms of from 1 to 12, a substituted or unsubstituted aryl group having a total number of carbon atoms of from 6 to 18, or a substituted or unsubstituted heterocyclic group having a total number of carbon atoms of from 4 to 12 is preferable. A substituted or unsubstituted aryl group or a substituted or unsubstituted heterocyclic group is more preferable. In particular, a substituted aryl group is most preferable.

(D) G₁ and G₂ may be the same or different, and represent an atomic group forming a 5- to 8-membered nitrogen-containing heterocyclic group. Preferable examples of the 5- to 8-membered nitrogen-containing heterocycle include an S-triazine ring, a pyrimidine ring, a pyridazine ring, a pyrazine ring, a pyridine ring, an imidazole ring, a pyrazole ring, and a pyrrole ring. Among the above, an S-triazine ring, a pyrimidine ring, a pyridazine ring, or a pyrazine ring is more preferable, and an S-triazine ring is most preferable.

(E) m₅₁ and m₅₂ each independently represent an integer of 0 to 3. When an —OM group may be substituted on a structure of a preferable example of the 5- to 8-membered nitrogen-containing heterocyclic group represented by G₁ or G₂, m₅₁ and m₅₂ each independently is preferably from 0 to 2 and more preferably 0 or 1. In particular, it is most preferable that m₄₁ is 1 and m₄₂ is also 1.

(F) M is preferably a hydrogen atom or a cation, particularly preferably a hydrogen atom, an alkali metal ion, or an ammonium or quaternary ammonium cation, and more preferably Li, Na, K, or NH₄.

(G) R₁₁ and R₁₂ may be the same or different from each other. Preferable examples thereof include an —OM group (M represents a hydrogen atom or cation), a substituted or unsubstituted amino group; an alkylamino group having 1 to 12 carbon atoms, an arylamino group having 6 to 18 carbon atoms, a substituted or unsubstituted alkylthio group having 1 to 12 carbon atoms, or a substituted or unsubstituted arylthio group having 6 to 18 carbon atoms. Among the above, an unsubstituted amino group, an alkylamino group having 1 to 12 carbon atoms, an arylamino group having 6 to 18 carbon atoms, a substituted or unsubstituted alkylthio group having 1 to 12 carbon atoms, or a substituted or unsubstituted arylthio group having 6 to 18 carbon atoms is preferable. In particular, an unsubstituted amino group, a dialkylamino group having 1 to 12 carbon atoms, an arylamino group having 6 to 18 carbon atoms, or a substituted or unsubstituted alkylthio group having 1 to 12 carbon atoms is more preferable.

(H) L₄ is a divalent linking group, and preferably an electron attracting group having a Hammett's substituent constant δp value of 0.20 or more, and more preferably an electron attracting group having a δp value of 0.30 or more. L₄ is an electron attracting group with a δp value of 1.0 as the upper limit. Among the above, an alkylsulfonyl group having 1 to 12 carbon atoms: {—SO₂—CH₂)ₙ—O₂S—; n=integer of 1 to 10} or an arylsulfonyl group having 6 to 18 carbon atoms: {—SO₂—Ar—O₂S—; preferably Ar is a substituted or unsubstituted aryl group) and most preferably, an alkylsulfonyl group having 1 to 12 carbon atoms: {—SO₂—(CH₂)ₙ—O₂S—; n=integer of 1 to 5}.

In Formulae (Y-1), (Y-2), (Y-3), (Y-4), and (Y-5), the nitrogen-containing heterocycle represented by G, G₁ and G₂ each independently is preferably a S-triazine ring, from the viewpoint of storage stability of the dye in the ink composition.

Among the water soluble yellow dyes represented by Formula (Y-1), the dye represented by Formula (Y-6) is preferable.

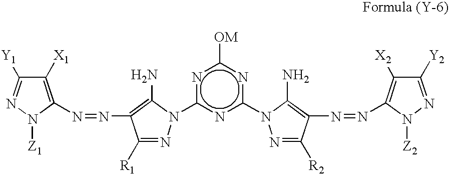

Hereinafter, Formula (Y-6) will be described in detail.

R₁, R₂, Y₁, and Y₂ each represent a monovalent group, X₁ and X₂ each independently represent an electron attracting group with a Hammett's substituent constant δp value of 0.20 or more. Z₁ and Z₂ each independently represent a hydrogen atom, a substituted or unsubstituted alkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. M represents a hydrogen atom or cation.

Hereinafter, R₁, R₂, X₁, X₂, Y₁, Y₂, Z₁, Z₂, and M will be described in detail.

Examples of the substituents of R₁, R₂, Y₁, and Y₂ are the same as the examples of the substituents of R₁, R₂, Y₁, and Y₂ described for Formula (Y-1), and preferable examples thereof are also the same.

Examples of the substituents of X₁ and X₂ are the same as the examples of the substituents of X₁ and X₂ described for Formula (Y-1), and preferable examples thereof are also the same.

Examples of the substituents of Z₁ and Z₂ are the same as the examples of the substituents of Z₁ and Z₂ described for Formula (Y-1), and preferable examples thereof are also the same.

Examples of M are the same as the examples of M described for Formula (Y-1), and preferable examples thereof are also the same.

As the combination of the preferable substituents of the dye represented by Formula (Y-6) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The particularly preferable combinations for the dye represented by Formula (Y-6) of the invention include the following (A) to (E):

(A) R₁ and R₂ may be the same or different from each other. Preferable examples thereof include a substituted or unsubstituted alkyl group having a total number of carbon atoms of from 1 to 12, a substituted or unsubstituted aryl group having a total carbon number of 6 to 18, and a substituted or unsubstituted heterocyclic group having a total number of carbon atoms of from 4 to 12. Among the above, a straight chain or branched alkyl group having a total number of carbon atoms of from 1 to 8 is preferable, a secondary or tertiary alkyl group is particularly preferable, and a t-butyl group is most preferable.

(B) X₁ and X₂ may be the same or different from each other. Preferably, X₁ and X₂ each independently represent an electron attracting group having a Hammett's substituent constant δp value of 0.20 or more is preferable. An electron attracting group having a δp value of 0.30 or more is more preferable. The upper limit of the δp value of the electron attracting group is 1.0. Among the above, a cyano group, an alkylsulfonyl group having 1 to 12 carbon atoms, an arylsulfonyl group having 6 to 18 carbon atoms, or a sulfamoyl group having 0 to 12 carbon atoms is preferable, and a cyano group or an alkylsulfonyl group having 1 to 12 carbon atoms is most preferable.

(C) Y₁ and Y₂ may be the same or different from each other. Preferably examples thereof include a hydrogen atom, a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. A hydrogen atom or a substituted or unsubstituted alkyl group is preferable. Among the above, a hydrogen atom is most preferable.

(D) Z₁ and Z₂ may be the same or different from each other. Preferable examples thereof include a substituted or unsubstituted alkyl group having a total number of carbon atoms of from 1 to 12, a substituted or unsubstituted aryl group having a total number of carbon atoms of from 6 to 18, and a substituted or unsubstituted heterocyclic group having a total number of carbon atoms of from 4 to 12. Further, a substituted or unsubstituted aryl group or a substituted or unsubstituted heterocyclic group is preferable. In particular, a substituted aryl group is most preferable.

(E) M is preferably a hydrogen atom or a cation, particularly preferably a hydrogen atom, an alkali metal ion, ammonium, or quaternary ammonium cation, and more preferably Li, Na, K, or NH₄.

In the invention, when the compounds represented by Formulae (I), (Y-1), (Y-2), (Y-3), (Y-4), (Y-5), and (Y-6) are required to have hydrophilicity, each compound preferably has 2 or more ionic hydrophilic groups in the molecule, more preferably 2 to 10 ionic hydrophilic groups in the molecule, and particularly preferably 3 to 6 ionic hydrophilic groups in the molecule.

As the ionic hydrophilic group, any group is acceptable insofar as it is an ionic dissociation group. Specific examples may include a sulfo group, a carboxy group (including salts thereof), a hydroxy group (which may be in the form of a salt), a phosphono group (which may be in the form of a salt), and quaternary ammonium.

A sulfo group, a carboxy group, or a hydroxy group (including salts thereof) is preferable. When the ionic hydrophilic group is a salt, preferable countercations may include an alkali metal (e.g., lithium, sodium, or potassium), ammonium, and an organic cation (e.g., pyridinium, tetramethyl ammonium, or guadinium). Among the above, an alkali metal is preferable. In particular, in the case of a sulfo group, a lithium salt is preferable, and in the case of a carboxy group, a sodium salt and/or a potassium salt are/is preferable.

As the combination of the preferable substituents of the dye represented by Formula (Y-6) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

In the invention, among the compounds represented by Formula (Y-6), the compound represented by Formula (Y-6-I) is preferable.

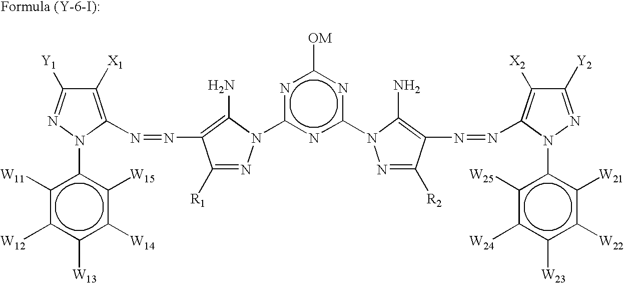

In Formula (Y-64), R₁, R₂, Y₁, Y₂, W₁₁, W₁₂, W₁₃, W₁₄, W₁₅, W₂₁m W₂₂, W₂₃, W₂₄, and W₂₅ each represent a monovalent group, and X₁ and X₂ each independently represent an electron attracting group with a Hammett's substituent constant δp value of 0.20 or more. M represents a hydrogen atom or cation. At least one of W₁₁, W₁₂, W₁₃, W₁₄, W₁₅, W₂₁, W₂₂, W₂₃, W₂₄, and W₂₅ is an ionic hydrophilic group or a group having an ionic hydrophilic group as a substituent.

In the invention, Formula (Y-6-I) mentioned above will be described in detail. In the invention, in Formula (Y-64), W₁₁, W₁₂, W₁₃, W₁₄, W₁₅, W₂₁, W₂₂, W₂₃, W₂₄, and W₂₅ are the same as the examples of the monovalent group described for Y₁, Y₂, Z₁, and Z₂ in Formula (Y-6).

Preferable W₁₁, W₁₂, W₁₃, W₁₄, W₁₅, W₂₁, W₂₂, W₂₃, W₂₄, and W₂₅ include a hydrogen atom, a halogen atom, an alkyl group, an aryl group, a heterocyclic group, a cyano group, an alkoxy group, an amido group, a ureido group, an alkylsulfonylamino group, an arylsulfonylamino group, a sulfamoyl group, an alkylsulfonyl group, an arylsulfonyl group, a carbamoyl group, an alkoxycarbonyl group, a sulfo group (including salts thereof), a carboxy group (including salts thereof), a hydroxy group (which may be in the form of a salt), a phosphono group (which may be in the form of a salt), and quaternary ammonium.

Among the above, a hydrogen atom, a halogen atom, an alkyl group, a sulfo group (including salts thereof), a carboxy group (including salts thereof), or a hydroxy group (which may be in the form of a salt) (including salts thereof) is preferable. A hydrogen atom, a sulfo group (including salts thereof), or a carboxy group (including salts thereof) is more preferable. In particular, it is preferable that at least one of W₁₁, W₁₂, W₁₃, W₁₄, and W₁₅ is a sulfo group (including salts thereof) or a carboxy group (including salts thereof) and that at least one of W₂₁, W₂₂, W₂₃, W₂₄, and W₂₅ is a sulfo group (including salts thereof) or a carboxy group (including salts thereof).

In the invention, in Formula (Y-64), X₁ and X₂ are the same as X₁ and X₂ in Formula (Y-6), and preferable examples thereof are also the same.

In the invention, in Formula (Y-64), Y₁ and Y₂ are the same as Y₁ and Y₂ in Formula (Y-6), and preferable examples thereof are also the same.

In the invention, in Formula (Y-64), R₁ and R₂ are the same as R₁ and R₂ in Formula (Y-6), and preferable examples thereof are also the same.

In the invention, in Formula (Y-64), M is the same as M in Formula (Y-6), and preferable examples thereof are also the same.

The particularly preferable combinations for the compounds represented by Formula (Y-6-1) of the invention include the following (A) to (F):

(A) R₁ and R₂ may be the same or different from each other. Preferable examples thereof include a straight chain or branched alkyl group having a total number of carbon atoms of from 1 to 8, particularly preferably a secondary alkyl group or a tertiary alkyl group, and most preferably a t-butyl group.

(B) X₁ and X₂ may be the same or different from each other. Preferable examples thereof include a cyano group, an alkylsulfonyl group having 1 to 12 carbon atoms, an arylsulfonyl group having 6 to 18 carbon atoms, or a sulfamoyl group having 0 to 12 carbon atoms, and most preferably a cyano group.

(C) Y₁ and Y₂ may be the same or different from each other. Preferable examples thereof include a hydrogen atom, a substituted or unsubstituted alkyl group having a total number of carbon atoms of from 1 to 12, a substituted or unsubstituted aryl group having a total number of carbon atoms of from 6 to 18, or a substituted or unsubstituted heterocyclic group having a total number of carbon atoms of from 4 to 12, and more preferably a hydrogen atom or a substituted or unsubstituted alkyl group. Among the above, a hydrogen atom and a methyl group are most preferable.

(D) Examples of W₁₁, W₁₂, W₁₃, W₁₄, W₁₅, W₂₁, W₂₂, W₂₃, W₂₄, and W₂₅, include a hydrogen atom, a halogen atom, an alkyl group, a sulfo group (including salts thereof), a carboxy group (including salts thereof), and a hydroxy group (which may be in the form of a salt) (including salts thereof) is preferable. A hydrogen atom, a sulfo group (including salts thereof), or a carboxy group (including salts thereof) is more preferable. In particular, it is preferable that at least one of W₁₁, W₁₂, W₁₃, W₁₄, and W₁₅ is a sulfo group (including salts thereof) or a carboxy group (including salts thereof) and that at least one of W₂₁, W₂₂, W₂₃, W₂₄, and W₂₅ is a sulfo group (including salts thereof) or a carboxy group (including salts thereof).

(E) M is preferably a hydrogen atom or a cation, particularly preferably a hydrogen atom, an alkali metal ion, or an ammonium or quaternary ammonium cation, and more preferably Li, Na, K, or NH₄.

(F) In the invention, the compound represented by Formulae (Y-3-I) preferably has 2 or more ionic hydrophilic groups in the molecule, more preferably 2 to 16 ionic hydrophilic groups in the molecule, and particularly preferably 3 to 5 ionic hydrophilic groups in the molecule.

As the ionic hydrophilic group, any group is acceptable insofar as it is an ionic dissociation group. Specific examples may include a sulfo group, a carboxy group (including salts thereof), a hydroxy group (which may be in the form of a salt), a phosphono group (which may be in the form of a salt), and quaternary ammonium. A sulfo group, a carboxy group, or a hydroxy group (including salts thereof) is preferable.

When the ionic hydrophilic group is a salt, preferable counter cations may include an alkali metal (e.g., lithium, sodium, or potassium), ammonium, and organic cation (e.g., pyridinium, tetramethyl ammonium, or guadinium). Among the above, an alkali metal is preferable. In particular, in the case of a sulfo group, a lithium salt is preferable, and in the case of a carboxy group, a sodium salt and/or a potassium salt are/is preferable.

As the combination of the preferable substituents of the dye represented by Formula (Y-6-I) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

The water-soluble dyes represented by Formulae (Y-I), (Y-1), (Y-2), (Y-3), (Y-4), (Y-5), (Y-6), and (Y-6-I) preferably have a maximum absorption wavelength (λmax) of 380 to 490 nm in H₂O, more preferably a λmax of 400 to 480 nm, and particularly preferably a λmax of 420 to 460 nm from the viewpoint of color reproduction.

Preferable examples of the compound represented by Formula (Y-I) include compounds described in JP-A No. 2007-138124, [0150] to [0470].

The yellow ink composition of the invention may be produced by dissolving the water soluble azo dye represented by Formula (Y-I) above in a water-based medium. As required, other additives may be contained in a range such that the effects of the invention are not adversely affected.

Examples of other additives include known additives, such as an anti-drying agent (wetting agent), a fading inhibitor, an emulsion stabilizer, a penetration accelerator, a UV absorber, an antiseptic agent, an antifungal agent, a pH adjuster, a surface tension adjuster, an antifoaming agent, a viscosity modifier, a dispersant, a dispersion stabilizer, a rust inhibitor, and a chelating agent. These various additives are directly added to an ink solution.

The anti-drying agent is preferably used for preventing clogging caused when the inkjet ink dries at an ink ejecting opening of a nozzle for use in an inkjet recording method.

As the anti-drying agent, a water-soluble organic solvent whose vapor pressure is lower than that of water is preferable. Specific example include polyhydric alcohols typified by ethylene glycol, propylene glycol, diethylene glycol, polyethylene glycol, thiodiglycol, dithio diglycol, 2-methyl-1,3-propanediol, 1,2,6-hexanetriol, acetylene glycol derivatives, glycerol, trimethylolpropane, etc.; lower alkyl ethers of polyhydric alcohols, such as ethylene glycol monomethyl (or ethyl)ether, diethylene glycol monomethyl (or ethyl)ether, and triethylene glycol monoethyl (or butyl)ether; heterocycles, such as 2-pyrrolidone, N-methyl-2-pyrrolidone, 1,3-dimethyl-2-imidazolidinone, and N-ethylmorpholine; sulfur-containing compounds, such as sulfolane, dimethyl sulfoxide, and 3-sulfolene; polyfunctional compounds, such as diacetone alcohol and diethanolamine, and urea derivatives. Among the above, polyhydric alcohols, such as glycerol and diethylene glycol, are more preferable. The above-mentioned anti-drying agents may be used singly or in a combination of two or more kinds. The anti-drying agents are preferably contained in the ink in a proportion of 10% by mass to 50% by mass.

The penetration accelerator is used in order for an ink jetink to permeate in paper in a better manner. Examples of the penetration accelerator may include alcohols, such as ethanol, isopropanol, butanol, di(tri)ethylene glycol monobutyl ether, and 1,2-hexanediol, sodium lauryl sulfate, sodium oleate, and a nonionic surfactant. When the penetration accelerators are contained in the ink in a proportion of 5% by mass to 30% by mass, sufficient effects are obtained. It is preferable to add the penetration accelerators in a range such that printing blur and print through do not occur.

The UV absorber is used for increasing storability of images. As the UV absorber, benzotriazole compounds described in JP-A Nos. 58-185677, 61-190537, 2-782, 5-197075, 9-34057, etc., benzophenone compounds described in JP-A Nos. 46-2784 and 5-194483, U.S. Pat. No. 3,214,463, etc., cinnamic acid compounds described in JP-B Nos. 48-30492 and 56-21141, JP-A No. 10-88106, etc., triazine compounds described in JP-A Nos. 4-298503, 8-53427, 8-239368, and 10-182621, JP-A (Translation of PCT Application) No. 8-501291, etc., compounds described in Research Disclosure No. 24239, and compounds which absorb ultraviolet rays to emit fluorescence, i.e., a so-called fluorescent whitening agent, typified stilbene compounds or benzoxazole compounds may be used.

The fading inhibitor is used for increasing storability of images. As the fading inhibitor, various organic-based and metal complex-based fading inhibitors may be used. Examples of organic-based fading inhibitors include hydroquinones, alkoxyphenols, dialkoxyphenols, phenols, anilines, amines, indans, chromans, alkoxyanilines, and heterocycles, and examples of metal complex-based fading inhibitors include a nickel complex and a zinc complex. More specifically, compounds described in patent publications cited in Research disclosure Nos. 17643 (VII-I or J), 15162, 18716, p. 650, left column, 36544, p. 527, 307105, p. 872, and 15162 or compounds included in compounds represented by Formulae of typical compounds and examples of the compounds described in JP-A 62-215272, pp. 127 to 137 may be used.

Examples of the antifungal agent include sodium dehydroacetate, sodium benzoate, sodium pyridinethiol-1-oxide, ethyl p-hydroxybenzoate, and 1,2-benzisothiazoline-3-one, and salts thereof. The antifungal agents are preferably used in a proportion of 0.02% by mass to 1.00% by mass in the ink.

As the pH adjustor, the neutralizer (an organic base, inorganic alkali) may be used. The pH adjustor is added for increasing storage stability of the inkjet ink in such a manner that the pH of the ink jetink is preferably from 6 to 10, and more preferably from 7 to 10.

Examples of the surface tension adjuster include nonionic surfactants, cationic surfactants, and anionic surfactants. The surface tension of the ink jetink of the invention is preferably from 25 mN/m to 70 mN/m, more preferably from 25 mN/m to 60 mN/m. The viscosity of the inkjet ink of the invention is preferably 30 mPa·s or lower. It is more preferable to adjust the viscosity of the inkjet ink to 20 mPa·s or lower. Preferable examples of the surfactant include anionic surfactants, such as fatty acid salt, alkyl sulfate, alkylbenzene sulfonate, alkylnaphthalene sulfonate, dialkyl sulfosuccinate, alkyl phosphate, a naphthalenesulfonic acid formalin condensate, and a polyoxyethylene alkyl sulfate and nonionic surfactants, such as polyoxyethylene alkyl ether, polyoxyethylene alkyl aryl ether, polyoxyethylene fatty acid ester, sorbitan fatty acid ester, polyoxyethylene sorbitan fatty acid ester, polyoxyethylene alkylamine, glycerin fatty acid ester, and an oxyethylene oxypropylene block copolymer. It is also preferable to use SURFYNOLS (product of Air Products & Chemicals Co.), which is an acetylene type polyoxyethylene oxide surfactant. It is also preferable to use an amineoxide type amphoteric surfactant, such as N,N-dimethyl-N-alkylamineoxide. Surfactants described in JP-A No. 59-157636, pp. 37 to 38 and Research Disclosure No. 308119 (1989) may be used.

As the antifoaming agent, fluorine compounds, silicone compounds, and chelating agents typified by EDTA, etc., may be used, as required.

As the water-based medium, a mixture containing water as a main component, and containing a water soluble organic solvent (in some case referred as a water-miscible organic solvent) added therein can be used. The water soluble organic solvent includes the specific water soluble organic solvent. Examples of the water-miscible organic solvent include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethyl propylenediamine), and other polar solvents (e.g., formamide, N,N dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The water-miscible organic solvents may be used in a combination of two or more of them.

A content of the water soluble azo dye represented by Formula (Y-I) in the yellow ink of the present invention is preferably in the range of from 0.1 parts by mass to 20 parts by mass with respect to 100 parts by mass of the yellow ink.

Moreover, the yellow ink composition of the invention may contain two or more dyes in combination. In such a case, it is preferable that the oxidation potential of the dye of which content is 50% or more in the yellow dyes, in each ink be more noble than 1.0 V.

In the yellow ink composition of the invention, polyethyleneimine, polyamines, polyvinyl pyrrolidone, polyethylene glycol, cellulose derivatives such as ethyl cellulose and carboxyethyl cellulose, polysaccharides and derivative thereof, other water-soluble polymers, polymer emulsions, cyclodextrin, macrocyclic amines, dendrimers, crown ethers, urea and derivatives thereof, or acetamide, etc., may be used.

Examples of the chelating agent include ethylene diamine tetraacetic acid (EDTA), iminodiacetic acid (IDA), ethylene diamine-di(o-hydroxyphenyl acetic acid) (EDDHA), nitrilotriacetic acid (NTA), dihydroxyethyl glycine (DHEG), trans-1,2-cyclohexanediaminetetraacetic acid (CyDTA), diethylenetriamine-N,N,N′,N′,N′-pentaacetic acid (DTPA), and glycol ether diamine-N,N,N′,N′,-tetraacetic acid (GEDTA).

Examples of a viscosity controlling agent include methylcellulose, ethyl cellulose and derivatives thereof, glycerols, polyglycerin and a polyethylene oxide adduct thereof and a polypropylene oxide adduct thereof, and polysaccharides and derivatives thereof. Specific examples thereof include glucose, fructose, mannite, D-sorbit, dextran, xanthan gum, curdlan, cycloamylose, maltitol, and derivatives thereof.

It is preferable that the ink for use in the inkjet recording method in the invention contains a betaine compound in the ink, according to necessity, and the betaine compound is especially preferably a betaine-type surfactant having an oil-soluble group. Among the betaine compounds, a compound represented by the later-described Formula (W-1) is preferably used in the invention.

It is preferable that betaine compounds preferably used in the invention are betaine-type surfactants having a surface activation property.

The betaine compound used here means a compound having both a cationic site and an anionic site in the molecule.

As the cationic site, a nitrogen atom in an amine-based compound, a nitrogen atom in a hetero-aromatic ring, a boron atom having four bonds to carbons, and a phosphorus atom are exemplified. Among these, a nitrogen atom in an amine-based compound and a nitrogen atom in a hetero-aromatic ring are preferable. Quaternary nitrogen atoms are especially preferable.

As the anionic site, a hydroxy group, a thio group, a sulfonamido group, a sulfo group, a carboxy group, an imido group, a phosphoric acid group, and a phosphonic acid group are exemplified. Of these groups, a carboxy group and a sulfo group are especially preferable. The charge as the molecule at large may be any of cationic, anionic and neutral, but neutral is preferable.

As the betaine compound, a compound represented by the following formula (W-1) is preferably used.

(R)ₚ—N-[L-(COOM)_{q}]ᵣ Formula (W-1)

In formula (W-1), R represents a hydrogen atom, an alkyl group, an aryl group, or a heterocyclic group; L represents a divalent linking group; M represents a hydrogen atom, an alkali metal atom, an ammonium group, a protonated organic amine or a nitrogen-containing heterocyclic group, or a quaternary ammonium ion group, and when M becomes the counter ion of the ammonium ion of N atom in the formula, M represents a group which does not present as cation. q represents an integer of 1 or more, and r represents an integer of 1 or more and 4 or less. p represents an integer of 0 or more and 4 or less, and p+r is 3 or 4. When p+r is 4, the N atom becomes a protonated ammonium atom (═N⁺═). When q is 2 or more, COOM may be the same with or different from each other. When r is 2 or more, L-(COOM)_{q} may be the same or different. When p is 2 or more, R may be the same or different.

As the preferable specific examples of the betaine compounds, the compounds disclosed in JP-A No. 2007-138124, paragraphs [0810] to [0822] are exemplified.

The addition amount of the betaine compound may be any amount so long as the effects of the invention are exhibited, and preferably in the range of from 0.001% by mass to 50% by mass in the ink composition, and more preferably from 0.01% by mass to 20% by mass.

A pH buffering agent may be added to the inks of the invention. Any pH buffering agent may be used insofar as the pH of ink can be stably maintained at 7.0 to 9.5. When the pH of ink is lower than 7.0, blur between colors and uneven coloring are likely to occur, resulting in deteriorated image fixability. When the pH of ink exceeds 9.5, a head member may be damaged. Preferable examples of a pH buffering agent include potassium dihydrogenphosphate/sodium hydroxide, sodium tetraborate/hydrochloric acid, potassium dihydrogenphosphate/disodium hydrogenphosphate, ammonium chloride/ammonia, trisaminomethane/hydrochloric acid, and combinations of ACES, ADA, BES, Bicine, Bis-Tris, CHES, DISPO, EPPS, HEPES, HEPPSO, MES, MOPS, MOPSO, POPSO, TAPS, TAPSO, TES, and Tricine, which are good buffers, and sodium hydroxide, potassium hydroxide, and ammonia. Among the above, a pH buffering agent containing sodium hydroxide, potassium hydroxide, and ammonia as alkali is particularly preferable. Effects of these pH buffering agents are remarkably demonstrated when the amount of ink drops is from 1 pL to 20 pL, and preferably 2 pL to 18 pL. The effects are favorably demonstrated in a thermal inkjet system.

The surface tension of the yellow ink composition of the invention is preferably in the range of from 20 mN/m to 70 mN/m, and more preferably from 25 mN/m to 60 mN/m, at 20° C. When the surface tension is lower than 20 mN/m, blur on paper becomes remarkable, and stable ejection is hard to achieve. Thus, such surface tension is not preferable. When the surface tension is larger than 70 mN/m, ink does not sufficiently penetrate into paper, which deteriorates color development properties of secondary colors, such as blue, red, and green. Thus, such surface tension is not likely preferable.

The viscosity of the yellow ink of the invention is preferably 30 mPa·s or lower, and more preferably in the range of from 1.5 mPa·s to 20 mPa·s, at 20° C. In a case where the viscosity of the ink of the invention is within the above-mentioned ranges, most favorable results are obtained. When the viscosity of the ink is lower than 1.5 mPa·s, ejection stability is hard to achieve. When the viscosity of the ink is higher than 20 mPa·s, clogging is likely to occur. Thus, such viscosities are not preferable.

An inkjet recording method of the invention preferably uses an ink set containing the yellow ink, a cyan ink where a water soluble phthalocyanine dye represented by the following Formula (C-1) is contained in an amount of 50% by mass or more with respect to a total amount of cyan dye, a magenta ink where a water soluble azo dye represented by Formula (M-1) described below is contained in an amount of 50% by mass or more with respect to a total amount of magenta dye, and a black ink where a water soluble azo dye represented by Formula (B-1) described below is contained in an amount of 50% by mass or more with respect to a total amount of black dye.

Thereby, a full-color image in which a coloring density is high and discoloration (color drift) after image formation is suppressed may be formed.

The cyan ink in the invention contains a water soluble phthalocyanine dye represented by the following Formula (C-I) in an amount of 50% by mass or more with respect to the total amount of cyan dye. However, the amount of the phthalocyanine dye contained in the cyan ink, with respect to the total amount of cyan dye, is preferably 60% by mass or more and more preferably 70% by mass or more, from the viewpoint of storage stability of image.

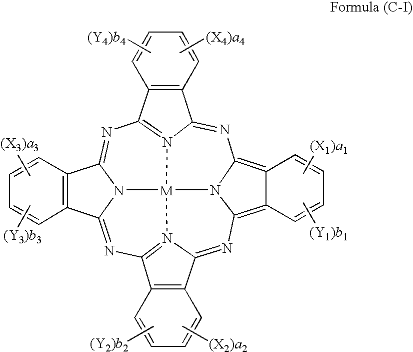

In Formula (C-I), each of X₁, X₂, X₃ and X₄ independently represents any of SO-Z, —SO₂-Z, —SO₂NV₁V₂, —CONV₁V₂, —CO₂Z, —CO-Z, or a sulfo group. Z independently represents an alkyl group, a cycloalkyl group, an alkenyl group, an alkynyl group, an aralkyl group, an aryl group, or a heterocyclic group. V₁ and V₂, which may be the same or different, each represent a hydrogen atom, an alkyl group, a cycloalkyl group, an alkenyl group, an alkynyl group, an aralkyl group, an aryl group, or a heterocyclic group. Each of Y₁, Y₂, Y₃ and Y₄ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group. Each group thereof may further have a substituent. a₁ to a₄ and b₁ to b₄ respectively represent numbers of substituents of X₁ to X₄ and Y₁ to Y₄. Each of a₁ to a₄ independently represents an integer of from 0 to 4, provided that all of a₁ to a₄ do not represent 0 at the same time, and each of b₁ to b₄ independently represents an integer of from 0 to 4. M represents a hydrogen atom, a metal atom or an oxide thereof, a hydroxide thereof, or a halide thereof. At least one of X₁, X₂, X₃, X₄, Y₁, Y₂, Y₃ or Y₄ represents an ionic hydrophilic group, or a group having an ionic hydrophilic group as a substituent.

In Formula (C-I) in the invention, it is preferable that a₁, a₂, a₃, and a₄ are each independently 0 or 1; two or more of a₁, a₂, a₃, and a₄ are 1; and b₁, b₂, b₃, and b₄ are each independently an integer which satisfies the equation of a₁+b₁=4, a₂+b₂=4, a₃+b₃=4, and a₄+b₄=4, respectively.

As described above, in Formula (C-I), each of X₁, X₂, X₃ and X₄ independently represents any of SO-Z, —SO₂-Z, —SO₂NV₁V₂, —CONV₁V₂, —CO₂Z, —CO-Z, or a sulfo group.

Z, which may be the same or different, each represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

Z preferably represents a substituted or unsubstituted alkyl group, a substituted or unsubstituted aryl group, or a substituted or unsubstituted heterocyclic group, more preferably represents a substituted alkyl group, a substituted aryl group, or a substituted heterocyclic group, and most preferably represents a substituted alkyl group.

V₁ and V₂, which may be the same or different, each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. Each of V₁ and V₂ preferably represents a hydrogen atom, a substituted or unsubstituted alkyl group, a substituted or unsubstituted aryl group, or a substituted or unsubstituted heterocyclic group, and most preferably represents a hydrogen atom, a substituted alkyl group, a substituted aryl group, or a substituted heterocyclic group.

Z, V₁ and V₂ may further have a substituent. As the substituents that Z, V₁ and V₂ may have independently, a halogen atom (e.g., a chlorine atom, a bromine atom), a straight chain or branched alkyl group having from 1 to 12 carbon atoms, an aralkyl group having from 7 to 18 carbon atoms, an alkenyl group having from 2 to 12 carbon atoms, a straight chain or branched alkynyl group having from 2 to 12 carbon atoms, a cycloalkyl group having from 3 to 12 carbon atoms that may have a side chain, a cycloalkenyl group having from 3 to 12 carbon atoms that may have a side chain (as these groups, e.g., methyl, ethyl, propyl, isopropyl, t-butyl, 2-methanesulfonylethyl, 3-phenoxypropyl, trifluoromethyl, cyclopentyl); an aryl group (e.g., phenyl, 4-t-butylphenyl, 2,4-di-t-amylphenyl); a heterocyclic group (e.g., imidazolyl, pyrazolyl, triazolyl, 2-furyl, 2-thienyl, 2-pyrimidinyl, 2-benzothiazolyl); an alkyloxy group (e.g., methoxy, ethoxy, 2-methoxyethoxy, 2-methanesulfonylethoxy); an aryloxy group (e.g., phenoxy, 2-methylphenoxy, 4-t-butylphenoxy, 3-nitrophenoxy, 3-t-butyloxycarbamoylphenoxy, 3-methoxycarbamoyl); an acylamino group (e.g., acetamido, benzamido, 4-(3-t-butyl-4-hydroxyphenoxy)butaneamido); an alkylamino group (e.g., methylamino, butylamino, diethylamino, methylbutylamino); an anilino group (e.g., phenylamino, 2-chloroanilino); a ureido group (e.g., phenylureido, methylureido, N,N-dibutylureido); a sulfamoylamino group (e.g., N,N-dipropylsulfamoylamino); an alkylthio group (e.g., methylthio, octylthio, 2-phenoxyethylthio); an arylthio group (e.g., phenylthio, 2-butoxy-5-t-octylphenylthio, 2-carboxyphenylthio); an alkyloxycarbonylamino group (e.g., methoxycarbonylamino); a sulfonamido group (e.g., methanesulfonamido, benzenesulfonamido, p-toluenesulfonamido, octadecane); a carbamoyl group (e.g., N-ethylcarbamoyl, N,N-dibutylcarbamoyl); a sulfamoyl group (e.g., N-ethylsulfamoyl, N,N-dipropylsulfamoyl, N,N-diethylsulfamoyl); a sulfonyl group (e.g., methanesulfonyl, octanesulfonyl, benzenesulfonyl, toluenesulfonyl); an alkyloxycarbonyl group (e.g., methoxycarbonyl, butyloxycarbonyl); a heterocyclic oxy group (e.g., 1-phenyltetrazol-5-oxy, 2-tetrahydropyranyloxy); an azo group (e.g., phenylazo, 4-methoxyphenylazo, 4-pivaloylaminophenylazo, 2-hydroxy-4-propanoylphenylazo); an acyloxy group (e.g., acetoxy); a carbamoyloxy group (e.g., N-methylcarbamoyloxy, N-phenylcarbamoyloxy); a silyloxy group (e.g., trimethylsilyloxy, dibutylmethylsilyloxy); an aryloxycarbonylamino group (e.g., phenoxycarbonylamino); an imido group (e.g., N-succinimido, N-phthalimido); a heterocyclic thio group (e.g., 2-benzothiazolylthio, 2,4-di-phenoxy-1,3,5-triazole-6-thio, 2-pyridylthio); a sulfinyl group (e.g., 3-phenoxypropylsulfinyl); a phosphonyl group (e.g., phenoxyphosphonyl, octyloxyphosphonyl, phenylphosphonyl); an aryloxycarbonyl group (e.g., phenoxycarbonyl); an acyl group (e.g., acetyl, 3-phenylpropanoyl, benzoyl); an ionic hydrophilic group (e.g., a carboxy group, a sulfo group, and a quaternary ammonium group); a cyano group; a hydroxy group; a nitro group; and an amino group are exemplified.

As the substituted or unsubstituted alkyl group represented by Z, V₁ and V₂, an alkyl group having from 1 to 30 carbon atoms is preferable. A branched alkyl group is preferable for the reason that solubility of the dye and stability of the ink can be increased, and the case of having asymmetric carbon atoms (the use as racemic body) is especially preferable. As the examples of the substituents, the substituents that the compound represented by Formula (C-I) described later may have can be exemplified. Among the substituents, a hydroxy group, an ether group, an ester group, a cyano group, an amino group, an amido group, and a sulfonamido group are especially preferable for the reason of capable of improving an associating property and fastness of the dye. Besides the above, the substituted or unsubstituted alkyl group represented by Z, V₁ and V₂ may have a halogen atom or an ionic hydrophilic group.

As the substituted or unsubstituted cycloalkyl group represented by Z, V₁ and V₂, a cycloalkyl group having from 5 to 30 carbon atoms is preferable. The case of having asymmetric carbon atoms (used as racemic body) is especially preferable for the reason that solubility of the dye and stability of the ink can be increased. As the examples of the substituents, the substituents that the compound represented by Formula (C-I) may have can be exemplified. Among the substituents, a hydroxy group, an ether group, an ester group, a cyano group, an amino group, an amido group, and a sulfonamido group are especially preferable for the reason of capable of improving an associating property and fastness of the dye. Besides the above, the substituted or unsubstituted cycloalkyl group represented by Z, V₁ and V₂ may have a halogen atom or an ionic hydrophilic group.

As the substituted or unsubstituted alkenyl group represented by Z, V₁ and V₂, an alkenyl group having from 2 to 30 carbon atoms is preferable. A branched alkenyl group is preferable for the reason that solubility of the dye and stability of the ink can be increased, and the case of having asymmetric carbon atoms (the use as racemic body) is especially preferable. As the examples of the substituents, the substituents that the compound represented by Formula (C-I) described later may have can be exemplified. Among the substituents, a hydroxy group, an ether group, an ester group, a cyano group, an amino group, an amido group, and a sulfonamido group are especially preferable for the reason of capable of improving an associating property and fastness of the dye. Besides the above, the substituted or unsubstituted alkenyl group represented by Z, V₁ and V₂ may have a halogen atom or an ionic hydrophilic group.

As the substituted or unsubstituted alkynyl group represented by Z, V₁ and V₂, an alkynyl group having from 2 to 30 carbon atoms is preferable. A branched alkynyl group is preferable for the reason that solubility of the dye and stability of the ink can be increased, and the case of having asymmetric carbon atoms (the use as racemic body) is especially preferable. As the examples of the substituents, the substituents that the compound represented by Formula (C-I) may have can be exemplified. Among the substituents, a hydroxy group, an ether group, an ester group, a cyano group, an amino group, an amido group, and a sulfonamido group are especially preferable for the reason of capable of improving an associating property and fastness of the dye. Besides the above, the substituted or unsubstituted alkynyl group represented by Z, V₁ and V₂ may have a halogen atom or an ionic hydrophilic group.

As the substituted or unsubstituted aralkyl group represented by Z, V₁ and V₂, an aralkyl group having from 7 to 30 carbon atoms is preferable. A branched aralkyl group is preferable for the reason that solubility of the dye and stability of the ink can be increased, and the case of having asymmetric carbon atoms (the use as racemic body) is especially preferable. As the examples of the substituents, the substituents that the compound represented by Formula (C-I) may have can be exemplified. Among the substituents, a hydroxy group, an ether group, an ester group, a cyano group, an amino group, an amido group, and a sulfonamido group are especially preferable for the reason of capable of improving an associating property and fastness of the dye. Besides the above, the substituted or unsubstituted aralkyl group represented by Z, V₁ and V₂ may have a halogen atom or an ionic hydrophilic group.

As the substituted or unsubstituted aryl group represented by Z, V₁ and V₂, an aryl group having from 6 to 30 carbon atoms is preferable. As the examples of the substituents, the substituents that the compound represented by Formula (C-I) described later may have can be exemplified. Above all, an electron-attracting group is especially preferable for the reason of capable of making oxidation potential of the dye noble and improving fastness.

As the heterocyclic group represented by Z, V₁ and V₂, 5- or 6-membered rings are preferable, and they may be further condensed. The heterocyclic group may be an aromatic heterocyclic group or a non-aromatic heterocyclic group. The heterocyclic groups represented by Z, V₁ and V₂ are shown in the form of heterocycle omitting the positions of substitution. The positions of substitution are not restricted and, for example, pyridine can be substituted on the 2-, 3- and 4-positions. As the examples of the heterocyclic groups, pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, and thiazoline are exemplified. Aromatic heterocyclic groups are especially preferable and the preferable examples are shown below similarly to the above, e.g., pyridine, pyrazine, pyrimidine, pyridazine, triazine, pyrazole, imidazole, benzimidazole, triazole, thiazole, benzothiazole, isothiazole, benzisothiazole, and thiadiazole. Each of them may have a substituent, and as the examples of the substituents, the substituents that the compound represented by Formula (C-I) described later may have can be exemplified. The preferable substituents are the same as the preferable substituents of the aryl group, and more preferable substituents are the same as the more preferable substituents of the aryl group, respectively.

When the phthalocyanine dye of the invention is water-soluble, it is preferable to have an ionic hydrophilic group. The examples of the ionic hydrophilic groups include a sulfo group, a carboxy group, a phosphono group and a quaternary ammonium group. As the ionic hydrophilic groups, a carboxy group, a phosphono group, and a sulfo group are preferable, and a carboxy group and a sulfo group are especially preferable. The carboxy group, phosphono group and sulfo group may take the state of a salt. The examples of counter ions to form a salt include an ammonium ion, an alkali metal ion (e.g., a lithium ion, a sodium ion, a potassium ion) and an organic cation (e.g., a tetramethylammonium ion, a tetramethylguanidinium ion, a tetramethylphosphonium ion). Of the counter ions, alkali metal salts are preferable, and lithium salts are especially preferable from points of heightening solubility of dyes and improving stability of inks. The most preferable ionic hydrophilic group is a lithium salt of a sulfo group.

As the number of ionic hydrophilic groups, it is preferable to have at least two ionic hydrophilic groups in one molecule of the phthalocyanine dye of the invention, and it is especially preferable to have at least two sulfo groups and/or carboxy groups.

M is preferably a hydrogen atom, and as the metal atoms, Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, Bi and the like are exemplified. As the oxides, VO, GeO and the like are exemplified. As the hydroxides, Si(OH)₂, Cr(OH)₂, Sn(OH)₂ and the like are exemplified. Further, as the halides, AlCl, SiCl₂, VCl, VCl₂, VOCl, FeCl, GaCl, ZrCl and the like are exemplified. Of the above, Cu, Ni, Zn and Al are especially preferable as M, and Cu is most preferable.

Pc (a phthalocyanine ring) may form a dimer (e.g., Pc-M-L-M-Pc) or a trimer via L (a divalent linking group), and M at that time may be the same or different from each other.

The divalent linking group represented by L is preferably an oxy group (—O—), a thio group (—S—), a carbonyl group (—CO—), a sulfonyl group (—SO₂—), an imino group (—NH—), a methylene group (—CH₂—), or a group formed by combination of these divalent linking groups.

As the chemical structure of the phthalocyanine dye in the invention, it is especially preferable to introduce an electron-attracting group such as a sulfinyl group (—SO-Z), a sulfonyl group (—SO₂-Z), a sulfamoyl group (—SO₂NV₁V₂), a carbamoyl group (—CONV₁V₂), an alkoxycarbonyl group, an aryloxycarbonyl group, a heterocyclic oxycarbonyl group (—CO₂Z), an acyl group (—CO-Z), or a sulfo group, at least one to every benzene ring of the phthalocyanine dye in the invention, so as to reach the total of σp values of the substituents of the phthalocyanine structure at 1.2 or more. Among the above electron-attracting groups, a sulfinyl group (—SO-Z), a sulfonyl group (—SO₂-Z), and a sulfamoyl group (—SO₂NV₁V₂) are preferable, a sulfonyl group (—SO₂-Z) and a sulfamoyl group (—SO₂NV₁V₂) are more preferable, and a sulfonyl group (—SO₂-Z) is most preferable.

Hammett's substituent constant σp value will be described briefly below. Hammett's rule is a rule of thumb advocated by L. P. Hammett in 1935 to discuss quantitatively the influence of a substituent on the reaction or equilibrium of a benzene derivative, and the validity of which is widely recognized today. There are a σp value and a σm value in the substituent constant required of Hammett's rule, and these values can be found in various ordinary publications, and described in detail in, for example, compiled by J. A. Dean, Lange's Handbook of Chemistry, 12^{th} Edition, McGraw-Hill (1979), and Kagaku no Ryoiki (The Region of Chemistry), Extra Issue, No. 122, pages 96-103, Nankodo Co., Ltd. (1979).

With respect to preferable combinations of substituents of the compound represented by Formula (C-I), the compound in which at least one of various substituents is the above preferable group is preferable, the compound in which various more substituents are the above preferable groups is more preferable, and the compound in which all the substituents are the above preferable groups is most preferable.

A cyan-based dye used as the colorant in the cyan ink composition represented by Formula (C-I) is preferably a compound selected from the group consisting of a compound represented by the following Formula (C-1) and the salts thereof.

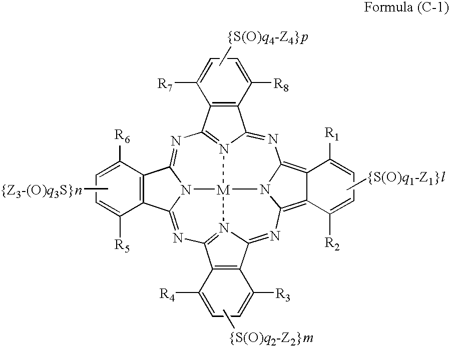

In Formula (C-1), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, and these groups may further have a substituent.

Each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃ or Z₄ has an ionic hydrophilic group as the substituent.

Each of l, m, n, p, q₁, q₂, q₃ and q₄ independently represents 1 or 2.

M has the same meaning as in Formula (C-I). In Formula (C-1) in the invention, each of l, m, n and p independently represents 1 or 2, preferably two or more of l, m, n and p represent 1, and most preferably l=m=n=p=1.

In Formula (C-1), each of q₁, q₂, q₃ and q₄ independently represents 1 or 2, preferably two or more of q₁, q₂, q₃ and q₄ represent 2, and most preferably q₁=q₂=q₃=q₄=2.

In Formula (C-1), each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, preferably a substituted or unsubstituted alkyl group, a substituted or unsubstituted aryl group, or a substituted or unsubstituted heterocyclic group, more preferably a substituted alkyl group, a substituted aryl group, or a substituted heterocyclic group, and most preferably a substituted alkyl group, provided that at least one of Z₁, Z₂, Z₃ or Z₄ has an ionic hydrophilic group as the substituent.

In Formula (C-1), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group. Among the above, a hydrogen atom, a halogen atom, an alkyl group, an aryl group, a heterocyclic group, a cyano group, a hydroxy group, a nitro group, a carbamoyl group, a sulfamoyl group, a sulfinyl group, a sulfonyl group, an alkoxycarbonyl group, an aryloxycarbonyl group, a phosphoryl group, an acyl group, or an ionic hydrophilic group is preferable; a hydrogen atom, a halogen atom, a cyano group, a hydroxy group, a sulfamoyl group, a sulfinyl group, a sulfonyl group, or an ionic hydrophilic group is more preferable; and a hydrogen atom is particularly preferable.

In Formula (C-1), M has the same meaning as M in Formula (C-I), and the preferable examples thereof are also the same.

As the combination of the preferable substituents of the cyan dye represented by Formula (C-1) of the invention, a compound in which at least one of various substituents is the above mentioned preferable group is preferable, a compound in which a larger number of various substituents are the above mentioned preferable groups is more preferable, and a compound in which all the substituents are the above mentioned preferable substituents is most preferable.

In the invention, the water soluble phthalocyanine dye represented by Formula (C-1) is preferably a compound selected from the group consisting of a compound represented by the following Formula (C-2) and the salts thereof

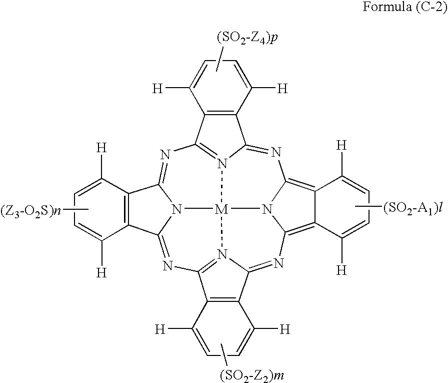

In Formula (C-2), Z₁, Z₂, Z₃, Z₄, l, m, n, p and M respectively have the same meaning as Z₁, Z₂, Z₃, Z₄, l, m, n, p and M in Formula (C-1).

In the invention, in Formula (C-2), each of l, m, n and p independently represents 1 or 2, preferably two or more of l, m, n and p represent 1, and most preferably l=m=n=p=1.

In Formula (C-2), each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, preferably a substituted or unsubstituted alkyl group, a substituted or unsubstituted aryl group, or a substituted or unsubstituted heterocyclic group, more preferably a substituted alkyl group, a substituted aryl group, or a substituted heterocyclic group, and most preferably a substituted alkyl group.

In detail, each of Z₁, Z₂, Z₃ and Z₄ independently represents Z₁₁ (where Z₁₁ represents —(CH₂)₃SO₃M₂, here M₂ represents an alkali metal atom) and/or Z₁₂ (where Z₁₂ represents —(CH₂)₃SO₂NHCH₂CH(OH)CH₃). In particular, a dye mixture in which the molar ratio of Z₁₁ to Z₁₂ contained in the cyan dye represented by Formula (C-2) at large of Z₁₁/Z₁₂ is 4/0, 3/1, 2/2, or 1/3 is preferable, and a dye mixture mainly comprising Z₁₁/Z₁₂ of 3/1 and/or a dye mixture mainly comprising Z₁₁/Z₁₂ of 2/2 are most preferable, provided that at least one of Z₁, Z₂, Z₃ and Z₄ has an ionic hydrophilic group as the substituent.

In —(CH₂)₃SO₃M₂ represented by Z₁ₗ, M₂ is preferably an alkali metal atom, more preferably a lithium, sodium, or potassium ion, and most preferably a lithium ion.

In Formula (C-2), M has the same meaning as M in Formula (C-1), and preferable examples are also the same.

With respect to preferable combinations of substituents of the compound represented by Formula (C-2), the compound in which at least one of various substituents is the above preferable group is preferable, the compound in which various more substituents are the above preferable groups is more preferable, and the compound in which all the substituents are the above preferable groups is most preferable.

The content of the cyan-based dye contained in the cyan ink composition is determined depending upon the kinds of X₁ to X₄ and Y₁ to Y₄ in Formula (C-I), and the kinds of the solvent components used in the manufacture of the ink composition, but it is preferable in the invention that the cyan-based dyes represented by Formula (C-I) (the water soluble phthalocyanine dye) are contained in the cyan ink composition in an amount of from 1% by mass to 10% by mass with respect to the total mass of the cyan ink composition, and more preferably from 2% by mass to 6% by mass.

By making the amount of the dyes of Formula (C-I) contained in the cyan ink composition in total of 1% by mass or more, a coloring property of the ink on a recording medium when printed can be made good, and required image density can be secured. Further, by making the amount of the dyes of Formula (C-I) contained in the cyan ink composition in total of 10% by mass or less, good ejection of the cyan ink composition can be attained when used in an ink jet recording method, and the effect that the nozzles are difficult to be clogged can be obtained.

In the ink set in the invention, it is possible to include a cyan ink composition high in color density (a dark cyan ink composition) and a cyan ink composition low in color density (a light cyan ink composition) as the cyan ink compositions.

When the dark cyan ink composition and the light cyan ink composition are contained in the ink set in the invention, it is preferable that at least one of the dark cyan ink composition and the light cyan ink composition contains at least one dye represented by Formula (C-I), (C-1) or (C-2) as a colorant.

Of the two kinds of cyan ink compositions different in color density, the cyan ink composition having low color density is preferably a mixture selected from the group consisting of a compound represented by Formula (C-1) and the salts thereof wherein Z₁, Z₂, Z₃ and Z₄ independently represent Z₁₁ (where Z₁₁ represents —(CH₂)₃SO₃M₂, here M₂ represents an alkali metal atom) and/or Z₁₂ (where Z₁₂ represents —(CH₂)₃SO₂NHCH₂CH(OH)CH₃), in particular, a dye mixture in which the molar ratio of Z₁₁ and Z₁₂ contained in the cyan dye represented by Formula (C-2) at large of Z₁₁/Z₁₂ is 4/0, 3/1, 2/2, or 1/3 is preferable, and a dye mixture mainly comprising Z₁₁/Z₁₂ of 2/2 is most preferable.

On the other hand, it is also preferable that, of the two kinds of cyan ink compositions different in color density, the cyan ink composition having low color density uses at least a compound selected from the group consisting of a compound represented by the following Formula (C-3) and the salts thereof

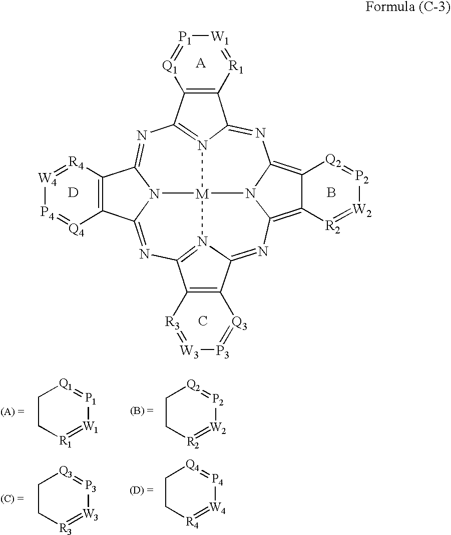

In Formula (C-3), each of Q₁ to Q₄, P₁ to P₄, W₁ to W₄, and R₁ to R₄ independently represents (═C(J₁)- and/or —N═), (═C(J₂)- and/or —N═), (═C(J₃)- and/or —N═), or (═C(J₄)- and/or —N═). Each of J₁ to J₄ independently represents a hydrogen atom and/or a substituent. Of four rings [ring A (A), ring B (B), ring C(C), and ring D (D)] comprising (Q₁, P₁, W₁, R₁), (Q₂, P₂, W₂, R₂), (Q₃, P₃, W₃, R₃), or (Q₄, P₄, W₄, R₄), at least one ring is a heterocycle.

In further detail, in the cyan ink composition including the cyan dye represented by Formula (C-3), of four rings [ring A (A), ring B (B), ring C(C), and ring D (D)] comprising (Q₁, P₁, W₁, R₁), (Q₂, P₂, W₂, R₂), (Q₃, P₃, W₃, R₃), or (Q₄, P₄, W₄, R₄), at least one heterocycle is preferably a nitrogen-containing heterocycle.

The heterocycle is preferably a pyridine ring, a pyrazine ring, a pyrimidine ring, or a pyridazine ring, more preferably the heterocycle is a pyridine ring or a pyrazine ring, and most preferably a pyridine ring.

Still more preferably, in the cyan ink composition including the cyan dye represented by Formula (C-3), of four rings [ring A (A), ring B (B), ring C(C), and ring D (D)] comprising (Q₁, P₁, W₁, R₁), (Q₂, P₂, W₂, R₂), (Q₃, P₃, W₃, R₃), or (Q₄, P₄, W₄, R₄), when any ring represents an aromatic ring, the aromatic ring is preferably represented by the following Formula (I).

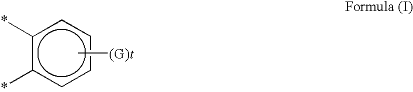

In Formula (I), * represents a bonding position to a phthalocyanine structure. G represents —SO-Z₁, —SO₂-Z₁, —SO₂NZ₂Z₃, —CONZ₂Z₃, —CO₂Z₁, —COZ₁, or a sulfo group. t represents an integer of from 1 to 4.

Z₁, which may be the same or different, each represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), Z₁ preferably represents a substituted or unsubstituted alkyl group, a substituted or unsubstituted aryl group, or a substituted or unsubstituted heterocyclic group, more preferably a substituted alkyl group or a substituted aryl group, and most preferably a substituted alkyl group.

Z₂ and Z₃, which may be the same or different, each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), each of Z₁ and Z₂ preferably independently represents a hydrogen atom, a substituted or unsubstituted alkyl group, a substituted or unsubstituted aryl group, or a substituted or unsubstituted heterocyclic group, more preferably a hydrogen atom, a substituted alkyl group or a substituted aryl group, and most preferably one of Z₁ and Z₂ represents a hydrogen atom and the other represents a substituted alkyl group or a substituted aryl group.

In Formula (I), G preferably represents —SO-Z₁, —SO₂-Z₁, —SO₂NZ₂Z₃, —CONZ₂Z₃, —CO₂Z₁ or —COZ₁, more preferably —SO-Z₁, —SO₂-Z₁, or —SO₂NZ₂Z₃, and most preferably —SO₂-Z₁.

In Formula (I), t preferably represents an integer of from 1 to 3, more preferably 1 or 2, and most preferably 1.

In further detail, in the cyan ink composition including the cyan dye represented by Formula (C-3), when any arbitrary ring of ring A, ring B, ring C and ring D is an aromatic ring, it is preferable that at least one aromatic ring is a ring represented by the following Formula (II).

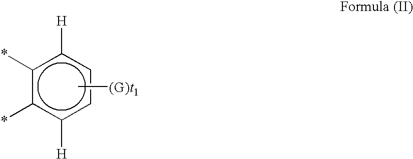

In Formula (II), * represents a bonding position to a phthalocyanine structure.

G in Formula (II) has the same meaning as G in Formula (I), and preferable examples are also the same.

In Formula (II), t₁ represents 1 or 2, and especially preferably t₁=1.

As the preferable specific examples of the dyes represented by Formula (C-I), the compounds disclosed in JP-A No. 2007-138124, paragraphs [0582] to [0652] are exemplified.

The cyan ink composition of the invention may be produced by dissolving the water soluble phthalocyanine dye represented by Formula (C-1) above in a water-based medium. As required, other additives may be contained in a range such that the effects of the invention are not adversely affected. Examples of other additives applicable to the cyan ink composition include the other additives described for the yellow ink composition. With respect to preferable ranges of surface tension and viscosity in the cyan ink composition are same as the ranges described for the yellow ink composition respectively.

The cyan ink in the invention may contain a colorless water-soluble planar compound having 10 or more delocalization π electrons in one molecule as a bronzing improver. As the preferable specific examples of the bronzing improvers, the compounds disclosed in JP-A No. 2005-105261, paragraphs from [0017] to [0025], and JP-A No. 2006-249275, paragraph [0032] are exemplified.

The preferable addition amount of the bronzing improvers may be any amount so long as the effects of the invention are exhibited, and is preferably from 0.001% by mass to 50% by mass in the ink composition, and more preferably from 0.01% by mass to 20% by mass.

(Magenta Ink)

A content of the water soluble azo dye represented by Formula (M-I) in a magenta ink of the present invention is 50% by mass or more with respect to the total mass of the magenta dye, preferably 60% by mass or more, and more preferably 70% by mass or more from the viewpoint of storage stability of an image formed with the ink.

Moreover, it is preferable that the oxidation potential of the water soluble azo dye (magenta dye) represented by Formula (M-I) in the ink be more noble than 1.0 V (vs. SCE).

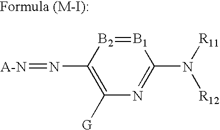

In Formula (M-I), A represents a residue of a 5-membered heterocyclic diazo component A-NH₂. Each of B₁ and B₂ independently represents —CR₁₃═ or —CR₁₄═, or either one represents a nitrogen atom and the other represents —CR₁₃═ or —CR₁₄═. Each of R₁₁ and R₁₂ independently represents a hydrogen atom, an alkyl group, a cycloalkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, an arylsulfonyl group, or a sulfamoyl group, and each group may further have a substituent.

Each of G, R₁₃ and R₁₄ independently represents a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, a nitro group, an alkylthio group, an arylthio group, an alkylsulfonyl group, an arylsulfonyl group, an alkylsulfinyl group, an arylsulfinyl group, a sulfamoyl group, a heterocyclic thio group, or an ionic hydrophilic group, and each group may further have a substituent. R₁₃ and R₁₁, or R₁₁ and R₁₂ may bond to each other to form a 5- or 6-membered ring, provided that Formula (M-1) has at least one ionic hydrophilic group.

In the invention, as preferable A in Formula (M-1), N, O and S can be exemplified as the examples of the hetero atoms of the 5-membered heterocyclic group. A nitrogen-containing 5-membered heterocyclic group is preferable, and the heterocyclic group may be condensed with an aliphatic ring, an aromatic ring or other heterocycle. Preferable examples of the heterocyclic group represented by A, include a group formed from a pyrazole ring, an imidazole ring, a triazole ring, a thiazole ring, an isothiazole ring, a thiadiazole ring, a benzothiazole ring, a benzoxazole ring, or a benzisothiazole ring. Each heterocyclic group may further have a substituent. Heterocyclic groups represented by any of the following Formulae (a) to (i) are preferable.

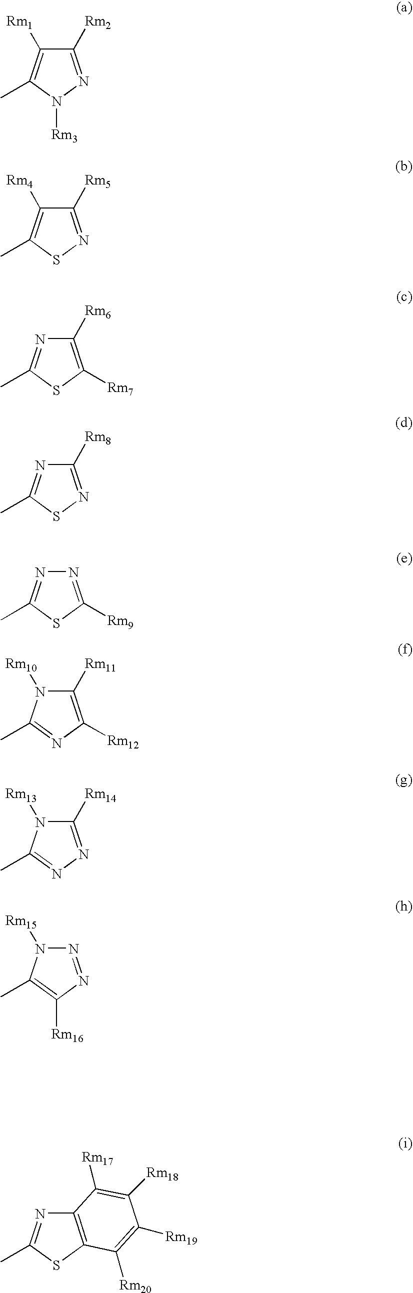

In Formulae (a) to (i), Rm₁ to Rm₂₀ each have the same meaning as R₁₃ or R₁₄ in Formula (M-I).

In Formula (M-I), each of B₁ and B₂ represents —CR₁₃═ or —CR₁₄═, or either one represents a nitrogen atom and the other represents —CR₁₃═ or —CR₁₄═, but the case where B₁ and B₂ represent —CR₁₃═ or —CR₁₄═ is preferable in the aspect of capable of exhibiting more excellent performances.

In Formula (M-I), each of R₁₁ and R₁₂ independently preferably represents a hydrogen atom, a substituted or unsubstituted cycloalkyl group, a substituted or unsubstituted aryl group, a substituted or unsubstituted heterocyclic group, a substituted or unsubstituted acyl group, a substituted or unsubstituted alkylsulfonyl group, or a substituted or unsubstituted arylsulfonyl group, more preferably a hydrogen atom, a substituted aryl group, or a substituted heterocyclic group, and especially preferably a substituted aryl group, or a substituted heterocyclic group, provided that R₁₁ and R₁₂ do not represent a hydrogen atom at the same time.

In Formula (M-I), G represents a hydrogen atom, a halogen atom, an alkyl group, an alkenyl group, an alkynyl group, an aralkyl group, an aryl group, a hydroxy group, an alkoxy group, an aryloxy group, an acyloxy group, a heterocyclic oxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, an alkylthio group, an arylthio group, a heterocyclic thio group, or an ionic hydrophilic group. Each group may further be substituted.

Of the above groups, a hydrogen atom, a halogen atom, an alkyl group, a hydroxy group, an alkoxy group, an aryloxy group, an acyloxy group, an amino group substituted by an alkyl group or an aryl group or a heterocyclic group, and an acylamino group are preferable.

Among the above groups, a hydrogen atom, an amino group substituted by an aryl group or a heterocyclic group, and an acylamino group are especially preferable. An amino group substituted by an aryl group having a substituent is most preferable.

In Formula (M-I), each of R₁₃ and R₁₄ independently preferably represents a hydrogen atom, an alkyl group, a cyano group, a carboxy group, a carbamoyl group, or an alkoxycarbonyl group. Each group may further be substituted.

In further detail, a hydrogen atom, an alkyl group, a cyano group, and a carboxy group are preferable, it is especially preferable that R₁₃ represents a hydrogen atom and R₁₄ represents an alkyl group, and it is most preferable for R₁₃ to represent a hydrogen atom and R₁₄ represent a methyl group.

With respect to preferable combinations of substituents of the compound represented by Formula (M-I), the compound in which at least one of various substituents is the above preferable group is preferable, the compound in which various more substituents are the above preferable groups is more preferable, and the compound in which all the substituents are the above preferable groups is most preferable.

In the invention, the compound represented by Formula (M-I) is preferably represented by the following Formula (M-1).

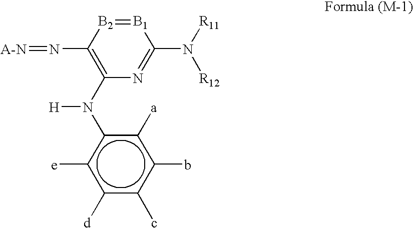

In the invention, A, B₁, B₂, R₁₁ and R₁₂ in Formula (M-1) each have the same meaning as A, B₁, B₂, R₁₁ and R₁₂ in Formula (M-I) respectively, and preferable examples for each are also the same.

In the invention, each of a and e in Formula (M-1) independently represents an alkyl group, an alkoxy group or a halogen atom, and in a case where both a and e represent an alkyl group, the total number of carbon atoms constituting the alkyl groups represented by a and e is 3 or more, which may further be substituted.

Each of b, c and d independently has the same meaning as R₁₁ and R₁₂ in Formula (M-I), and a and b, or e and d may be condensed to each other, provided that the dye represented by Formula (M-1) has at least one ionic hydrophilic group.

In the invention, A in Formula (M-1) has the same meaning as A in Formula (M-I), and preferable examples are also the same.

In the invention, B₁ and B₂ in Formula (M-1) each have the same meaning as B₁ and B₂ in Formula (M-I) respectively, and preferable examples are also the same.

In the invention, R₁₁ and R₁₂ in Formula (M-1) each have the same meaning as R₁₁ and R₁₂ in Formula (M-I) respectively, and preferable examples are also the same.

In the invention, each of a and e in Formula (M-1) independently represents an alkyl group, an alkoxy group or a halogen atom, and in a case where both a and e represent an alkyl group, the total amount of the carbon atoms constituting the alkyl group represented by a and e is 3 or more, which may further be substituted.

More preferably each of a and e independently represents a methyl group, an ethyl group, or an isopropyl group, more preferably an ethyl group or an isopropyl group, and most preferably a=b=an ethyl group or an isopropyl group.

Each of b, c and d independently has the same meaning as R₁₃ and R₁₄ in Formula (M-I), and a and b, or e and d may be condensed to each other, provided that the dye represented by Formula (M-1) has at least one ionic hydrophilic group.

More preferably c represents a hydrogen atom or an alkyl group, and especially preferably represents a hydrogen atom or a methyl group.

b and d preferably represent a hydrogen atom or an ionic hydrophilic group, and especially preferably represent a hydrogen atom, a sulfo group or a carboxy group.

The combination of b and d is most preferably a hydrogen atom and a sulfo group.

With respect to preferable combinations of substituents of the compound represented by Formula (M-1), the compound in which at least one of various substituents is the above preferable group is preferable, the compound in which various more substituents are the above preferable groups is more preferable, and the compound in which all the substituents are the above preferable groups is most preferable.

In the invention, the compound represented by Formula (M-1) is preferably represented by the following Formula (M-2).

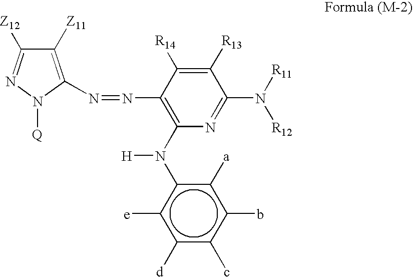

In Formula (M-2), Z₁₁ represents an electron-attracting group having a Hammett's substituent constant σp value of 0.20 or more. Z₁₂ represents a hydrogen atom, an alkyl group, an alkenyl group, an alkynyl group, an aralkyl group, an aromatic group, a heterocyclic group, or an acyl group. Each of R₁₁, R₁₂, R₁₃, R₁₄, a, b, c, d and e has the same meaning as in Formula (M-1).

Q represents a hydrogen atom, an alkyl group, an alkenyl group, an alkynyl group, an aralkyl group, an aromatic group, or a heterocyclic group. Each of the groups represented by Z₁₁, Z₁₂ and Q may further have a substituent, provided that the compound represented by Formula (M-2) has at least one ionic hydrophilic group.

In the invention, A in Formula (M-2) has the same meaning as A in Formula (M-I), and preferable examples are also the same.

In the invention, R₁₃ and R₁₄ in Formula (M-2) each have the same meaning as R₁₃ and R₁₄ in Formula (M-I), and preferable examples are also the same.

In the invention, R₁₁ and R₁₂ in Formula (M-2) each have the same meaning as R₁₁ and R₁₂ in Formula (M-I), and preferable examples are also the same.

In the invention, a, b, c, d and e in Formula (M-2) each have the same meaning as a, b, c, d and e in Formula (M-1) respectively, and preferable examples are also the same.

In the invention, the electron-attracting group represented by Z₁₁ in Formula (M-2) is an electron-attracting group having a Hammett's substituent constant σp value of 0.20 or more, and preferably 0.30 or more. The least upper limit of the σp value is preferably 1.0.

Specific examples of electron-attracting groups having σp value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, a halogenated alkyl group, a halogenated alkoxy group, a halogenated aryloxy group, a halogenated alkylamino group, a halogenated alkylthio group, a heterocyclic group, a halogen atom, an azo group, a selenocyanate group, and an aryl group substituted by other electron-attracting group having a σp value of 0.20 or more are exemplified.

Z₁₁ preferably represents a cyano group, an alkylsulfonyl group, an arylsulfonyl group, a nitro group, or a halogen atom, more preferably a cyano group, an alkylsulfonyl group, or an arylsulfonyl group, and most preferably a cyano group.

Z₁₂ preferably represents a hydrogen atom, an alkyl group, a cycloalkyl group, an aralkyl group, an aryl group, a heterocyclic group, or an acyl group, and more preferably represents an alkyl group. Each substituent may further be substituted.

In further detail, an alkyl group having a substituent and an unsubstituted alkyl group are included in the alkyl group represented by Z₁₂. As the alkyl group, an alkyl group having from 1 to 12 carbon atoms exclusive of the carbon atoms of the substituent is preferable, and an alkyl group having from 1 to 6 carbon atoms is more preferable.

The examples of the substituents include a hydroxy group, an alkoxy group, a cyano group, a halogen atom, and an ionic hydrophilic group.

The examples of the alkyl groups include methyl, ethyl, butyl, isopropyl, t-butyl, hydroxyethyl, methoxyethyl, cyanoethyl, trifluoromethyl, 3-sulfopropyl, and 4-sulfobutyl, and among these alkyl groups, methyl, ethyl, isopropyl and t-butyl are preferable, isopropyl and t-butyl are especially preferable, and t-butyl is most preferable.

A cycloalkyl group having a substituent and an unsubstituted cycloalkyl group are included in the cycloalkyl group represented by Z₁₂. As the cycloalkyl group, a cycloalkyl group having from 5 to 12 carbon atoms exclusive of the carbon atoms of the substituent is preferable. The examples of the substituents include an ionic hydrophilic group. The examples of the cycloalkyl group include a cyclohexyl group.

An aralkyl group having a substituent and an unsubstituted aralkyl group are included in the aralkyl group represented by Z₁₂. As the aralkyl group, an aralkyl group having from 7 to 12 carbon atoms exclusive of the carbon atoms of the substituent is preferable. The examples of the substituents include an ionic hydrophilic group. The examples of the aralkyl group include a benzyl group and a 2-phenethyl group.

An aryl group having a substituent and an unsubstituted aryl group are included in the aryl group represented by Z₁₂. As the aryl group, an aryl group having from 6 to 12 carbon atoms exclusive of the carbon atoms of the substituent is preferable. The examples of the substituents include an alkyl group, an alkoxy group, a halogen atom, an alkylamino group, an amido group, a carbamoyl group, a sulfamoyl group, a sulfonamido group, a hydroxy group, an ester group, and an ionic hydrophilic group. The examples of the aryl group include phenyl, p-tolyl, p-methoxyphenyl, o-chlorophenyl, and m-(3-sulfopropylamino)phenyl.

A heterocyclic group having a substituent and an unsubstituted heterocyclic group are included in the heterocyclic group represented by Z₁₂. As the heterocyclic group, a 5- or 6-membered heterocyclic group is preferable. The examples of the substituents include an amido group, a carbamoyl group, a sulfamoyl group, a sulfonamido group, a hydroxy group, an ester group, and an ionic hydrophilic group. The examples of the heterocyclic group include a 2-pyridyl group, a 2-thienyl group, a 2-thiazolyl group, a 2-benzothiazolyl group, and a 2-furyl group.

An acyl group having a substituent and an unsubstituted acyl group are included in the acyl group represented by Z₁₂. As the acyl group, an acyl group having from 1 to 12 carbon atoms exclusive of the carbon atoms of the substituent is preferable. The examples of the substituents include an ionic hydrophilic group. The examples of the acyl group include an acetyl group and a benzoyl group.

In the invention, Q in Formula (M-2) represents a hydrogen atom, an alkyl group, an alkenyl group, an alkynyl group, an aralkyl group, an aromatic group, or a heterocyclic group. These substituents may further be substituted. The details of these substituents are the same as the case of R₁₃ and R₁₄.

Q preferably represents an aryl group or heterocyclic group substituted by an electron-attracting group. The electron-attracting group of the substituents of Q is an electron-attracting group having a Hammett's substituent constant σp value of 0.20 or more, and preferably 0.30 or more. The upper limit of the σp value is preferably 1.0.

The specific examples of electron-attracting groups having σp value of 0.20 or more are the same as the case of Z₁₁ in Formula (M-2).

In further detail, Q preferably represents a heterocyclic group substituted by an electron-attracting group, preferably represents a sulfo group, a substituted or unsubstituted carbamoyl group or a benzoxazole ring and a benzothiazole ring substituted by a substituted or unsubstituted sulfamoyl group, and most preferably a sulfo group, or a benzothiazole ring substituted by a substituted sulfamoyl group.

With respect to preferable combinations of substituents of the compound represented by Formula (C-2), the compound in which at least one of various substituents is the above preferable group is preferable, the compound in which various more substituents are the above preferable groups is more preferable, and the compound in which all the substituents are the above preferable groups is most preferable.

Especially, preferable combinations of the compound represented by Formula (M-I) in the invention include the following (A) to (D).

(A) The preferable examples of the heterocyclic groups represented by A include a group formed from a pyrazole ring, an imidazole ring, a triazole ring, a thiazole ring, an isothiazole ring, a thiadiazole ring, a benzothiazole ring, a benzoxazole ring, or a benzisothiazole ring, more preferably a group derived from a pyrazole ring, an imidazole ring, a triazole ring, a thiazole ring, an isothiazole ring, and a thiadiazole ring, still more preferably a group derived from a pyrazole ring, a triazole ring, a thiazole ring, an isothiazole ring, and a thiadiazole ring, and most preferably a group derived from a pyrazole ring.

(B) Each of B₁ and B₂ represents —CR₁₃═ or —CR₁₄═, or either one represents a nitrogen atom, and the other represents —CR₁₃═ or —CR₁₄═, preferably each of B₁ and B₂ represents —CR₁₃═ or —CR₁₄═, more preferably R₁₃ represents a hydrogen atom (B₁ is an unsubstituted carbon atom), and R₁₄ represents a hydrogen atom or an alkyl group (B₂ is an unsubstituted carbon atom or a carbon atom substituted by an alkyl group), and especially preferably R₁₃ represents a hydrogen atom (B₁ is an unsubstituted carbon atom), and R₁₄ represents a methyl group (B₂ is a carbon atom substituted by a methyl group).

(C) Each of R₁₁ and R₁₂ independently preferably represents a hydrogen atom, a substituted or unsubstituted cycloalkyl group, a substituted or unsubstituted aryl group, a substituted or unsubstituted heterocyclic group, a substituted or unsubstituted acyl group, a substituted or unsubstituted alkylsulfonyl group, or a substituted or unsubstituted arylsulfonyl group, more preferably a hydrogen atom, a substituted aryl group, or a substituted heterocyclic group, and especially preferably a substituted aryl group, or a substituted heterocyclic group, and most preferably an aryl group substituted by a sulfo group, or a heterocyclic group substituted by a sulfo group.

(D) G preferably represents a hydrogen atom, a halogen atom, an alkyl group, an alkenyl group, an alkynyl group, an aralkyl group, an aryl group, a hydroxy group, an alkoxy group, an aryloxy group, an acyloxy group, a heterocyclic oxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, an alkylthio group, an arylthio group, a heterocyclic thio group, or an ionic hydrophilic group, more preferably represents a hydrogen atom, a halogen atom, an alkyl group, a hydroxy group, an alkoxy group, an aryloxy group, an acyloxy group, an amino group substituted by an alkyl group or an aryl group or a heterocyclic group, or an acylamino group, especially preferably a hydrogen atom, an amino group substituted by an aryl group or a heterocyclic group, or an acylamino group, and most preferably an amino group substituted by an aryl group having a substituent.

Formula (M-I) is especially preferably represented by Formula (M-1).

Especially preferable combinations of the compound represented by Formula (M-1) in the invention include the following (A) to (D).

(A) The examples of the heterocyclic groups represented by A are the same as A in Formula (M-I), and preferable examples are also the same.

(B) Each of B₁ and B₂ has the same meaning as B₁ and B₂ in Formula (M-I), and preferable examples are also the same.

(C) Each of R₁₁ and R₁₂ has the same meaning as R₁₁ and R₁₂ in Formula (M-I), and preferable examples are also the same.

(D) Each of a and e preferably represents an alkyl group or a halogen atom, and when both a and e represent an alkyl group, the alkyl group is an unsubstituted alkyl group, and the total number of carbon atoms of a and e is 3 or more (preferably 5 or less). Each of a, b, c and d preferably represents a hydrogen atom, a halogen atom, an alkyl group, or an ionic hydrophilic group (preferably each of them represents a hydrogen atom, an alkyl group having from 1 to 4 carbon atoms, or an ionic hydrophilic group), more preferably each of a and e independently represents a methyl group, an ethyl group, or an isopropyl group, especially preferably represents an ethyl group or an isopropyl group, and most preferably a=b=an ethyl group or an isopropyl group. Further, c preferably represents a hydrogen atom or an alkyl group, and especially preferably a hydrogen atom or a methyl group. Each of b and d preferably represents a hydrogen atom or an ionic hydrophilic group, especially preferably a hydrogen atom, a sulfo group, or a carboxy group, and it is most preferable that the combination of b and d is a hydrogen atom and a sulfo group.

Formula (M-1) is especially preferably represented by formula (M-2).

Especially preferable combinations of the compound represented by Formula (M-2) in the invention include the following (A) to (F).

(A) Z₁₁ represents an electron-attracting group having a Hammett's substituent constant σp value of 0.20 or more, and preferably 0.30 or more. The upper limit of the σp value is preferably 1.0. Z₁₁ more preferably represents a cyano group, an alkylsulfonyl group, an arylsulfonyl group, a nitro group, or a halogen atom, still more preferably a cyano group, an alkylsulfonyl group, or an arylsulfonyl group, and especially preferably a cyano group.

(B) As Z₁₂, a hydrogen atom, an alkyl group, a cycloalkyl group, an aralkyl group, an aryl group, a heterocyclic group, and an acyl group are preferable, and an alkyl group is more preferable. Each substituent may further be substituted. In more detail, in the alkyl group represented by Z₁₂, an alkyl group having a substituent and an unsubstituted alkyl group are included. As the alkyl group, an alkyl group having from 1 to 12 carbon atoms exclusive of the carbon atoms of the substituent is preferable, and more preferably an alkyl group having from 1 to 6 carbon atoms. The examples of the substituents include a hydroxy group, an alkoxy group, a cyano group, a halogen atom, and an ionic hydrophilic group. Among these groups, methyl, ethyl, butyl, isopropyl, t-butyl, hydroxyethyl, methoxyethyl, cyanoethyl, trifluoromethyl, 3-sulfopropyl, and 4-sulfobutyl are preferable, isopropyl and t-butyl are especially preferable, and t-butyl is most preferable.

(C) Q represents a hydrogen atom, an alkyl group, an alkenyl group, an alkynyl group, an aralkyl group, an aromatic group, or a heterocyclic group. Each of the substituents may further be substituted. Further, Q is preferably an aryl group or heterocyclic group substituted by an electron-attracting group. The electron-attracting group to be a substituent of Q is an electron-attracting group having a Hammett's substituent constant σp value of 0.20 or more, and preferably 0.30 or more. The upper limit of the σp value is preferably 1.0. In further detail, Q is more preferably a heterocyclic group substituted by an electron-attracting group, especially preferably a sulfo group, a substituted or unsubstituted carbamoyl group, a benzoxazole ring and benzothiazole ring substituted by a substituted or unsubstituted sulfamoyl group, and most preferably a sulfo group, and a benzothiazole ring substituted by a substituted sulfamoyl group.

(D) Each of a, b, c, d and e has the same meaning as a, b, c, d and e in Formula (M-1), and preferable examples are also the same.

(E) Each of R₁₃ and R₁₄ has the same meaning as R₁₃ and R₁₄ in Formula (M-1), and preferable examples are also the same.

(F) Each of R₁₁ and R₁₂ has the same meaning as R₁₁ and R₁₂ in Formula (M-1), and preferable examples are also the same.

Each of the compounds represented by any of Formulae (M-I), (M-1) and (M-2) (azo dyes) has at least one ionic hydrophilic group in the molecule (preferably 3 or more and 6 or less). The examples of the ionic hydrophilic groups include a sulfo group, a carboxy group, a phosphono group, and a quaternary ammonium group. As the ionic hydrophilic groups, a carboxy group, a phosphono group, and a sulfo group are preferable, and a carboxy group and a sulfo group are preferable above all. In particular, it is most preferable that at least one of the ionic hydrophilic groups is a sulfo group. The carboxy group, phosphono group and sulfo group may be in the state of a salt. The examples of counter ions to form a salt include an ammonium ion, an alkali metal ion (e.g., a lithium ion, a sodium ion, a potassium ion) and an organic cation (e.g., a tetramethylammonium ion, a tetramethylguanidinium ion, a tetramethylphosphonium ion). Among the counter ions, alkali metal salts are preferable, and among the alkali metal salts, a potassium ion, a sodium ion, or a lithium ion are preferable, and a lithium ion is most preferable. In view of the improvement of solubility and suppression of bronzing in ink jet printing, the combination of a sulfo group as the ionic hydrophilic group with a lithium ion as the counter ion is most preferable.

It is preferable that the azo dyestuffs have 3 to 6 of hydrophilic groups in the molecule, more preferably to have 3 to 6 of sulfo groups, and still more preferably to have 3 to 5 of sulfo groups.

As the preferable specific examples of the dyes represented by Formula (M-I), the compounds disclosed in JP-A No. 2007-138124, paragraphs from [0489] to [0563] are exemplified.

The magenta ink composition of the invention may be produced by dissolving the water soluble azo dye represented by Formula (M-I) above in a water-based medium. As required, other additives may be contained in a range such that the effects of the invention are not adversely affected. Examples of other additives applicable to the magenta ink composition include the other additives described for the yellow ink composition. With respect to preferable ranges of surface tension and viscosity in the magenta ink composition are same as the ranges described for the yellow ink composition respectively.

A content of the water soluble azo dye represented by Formula (B-I) in a black ink of the present invention is 50% by mass or more with respect to the total mass of the black dye, preferably 55% by mass or more, and more preferably 60% by mass or more from the viewpoint of storage stability of an image formed with the ink.

Moreover, it is also preferable that the oxidation potential of the dye in the ink be more noble than 1.0 V (vs. SCE) as the black dye in the invention.

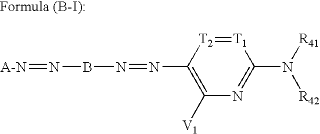

In Formula (B-1), A represents a monovalent aromatic group or heterocyclic group, and B represents a divalent aromatic group or heterocyclic group.

T₁ and T₂ each represent ═CR₄₃— or —CR₄₄═, or either one of them represents a nitrogen atom and the other one represents ═CR₄₃— or —CR₄₄═. V₁, R₄₃, and R₄₄ each independently represent a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, a heterocyclic oxycarbonyl group, an acyl group, a hydroxy group, an alkoxy group, an aryloxy group, a heterocyclic oxy group, a silyloxy group, an acyloxy group, a carbamoyloxy group, an alkoxycarbonyloxy group, an aryloxycarbonyloxy group,

an amino group (including an alkylamino group, an arylamino group, and a heterocyclic amino group), an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfo group. Each group may be further substituted. R₄₁ and R₄₂ each independently represent a hydrogen atom, an alkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, arylsulfonyl group, or a sulfamoyl group. Each group may further have a substituent. R₄₁ and R₄₂ are not simultaneously hydrogen atoms. R₄₃ and R₄₁ or R₄₁ and R₄₂ may be bonded to each other to form a 5- to 6-membered ring.

As the preferable specific examples of the dyes represented by Formula (B-1), the compounds disclosed in JP-A No. 2007-138124, paragraphs from [0669] to [0772] are exemplified.

The black ink composition of the invention may be produced by dissolving the water soluble azo dye represented by Formula (B-I) above in a water-based medium. As required, other additives may be contained in a range such that the effects of the invention are not adversely affected. Examples of other additives applicable to the black ink composition include the other additives described for the yellow ink composition. With respect to preferable ranges of surface tension and viscosity in the black ink composition are same as the ranges described for the yellow ink composition respectively.

To the above yellow dyes, magenta dyes, cyan dyes and black dyes, other dyes may be used in combination for the purpose of regulation of hue and regulation of discoloring speed. As the specific examples of the dyes preferable for combination, the compounds disclosed in JP-A No. 2007-138124, paragraphs from [0473] to [0481] (combination dyes for yellow dyes), paragraphs from [0507] to [0578] (combination dyes for magenta dyes), paragraphs from [0660] to [0664] (combination dyes for cyan dyes), and paragraphs from [0779] to [0792] (combination dyes for black dyes) are exemplified.

### EXAMPLES

The invention will be described more specifically with reference to examples, but the scope of the invention is by no means restricted to the following specific examples. In the examples “parts” and “%” are based on mass unless otherwise indicated.

<Preparation of Ink Set 1>

(Preparation of Yellow Ink Y-101)

Ion exchanged water was added to the following components to make 1 liter, and the mixture was stirred for 1 hour with heating at 30° C. to 40° C. After that, the solution was filtered under reduced pressure through a micro filter having an average pore diameter of 0.25 μm to prepare yellow ink (Y-101).

[Prescription of Yellow Ink Y-101]

| (Solids Content) | | |
|---|---|---|
| Yellow dye (potassium salt of yellow dye Y-1 represented by the following structural | 60.0 | g/liter |
| formula) | | |
| PROXEL XL-2 (trade name, manufactured by Avecia Inkjet Limited) | 1.0 | g/liter |
| (Liquid Components) | | |
| Glycerol | 81 | g/liter |
| Triethylene glycol | 96 | g/liter |
| Triethylene glycol monobutyl ether | 94 | g/liter |
| OLFINE E1010 (trade name, manufactured by Shin-Etsu Chemical Co., Ltd.) | 20 | g/liter |

Yellow Dye Y-1

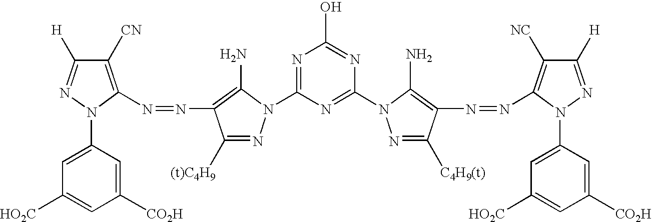

(Preparation of Cyan Ink C-101)

Ion exchanged water was added to the following components to make 1 liter, and the mixture was stirred for 1 hour with heating at 30° C. to 40° C. After that, the solution was filtered under reduced pressure through a micro filter having an average pore diameter of 0.25 μm to prepare cyan ink (C-101).

(Prescription of Cyan Ink C-101)

| | | |
|---|---|---|
| (Solids Content) | | |
| Cyan dye (cyan dye C-1 represented by the following | 54.0 | g/liter |
| structural formula) | | |
| Urea | 41.0 | g/liter |
| PROXEL XL-2 (trade name, manufactured by Avecia | 1.0 | g/liter |
| Inkjet Limited) | | |
| (Liquid Components) | | |
| Glycerol | 91 | g/liter |
| Triethylene glycol | 18 | g/liter |
| Triethylene glycol monobutyl ether | 97 | g/liter |
| 1,2-Hexanediol | 12 | g/liter |
| 2-Pyrrolidone | 27 | g/liter |
| OLFINE E1010 (trade name, manufactured by Shin-Etsu | 10 | g/liter |
| Chemical Co., Ltd.) | | |

Cyan dye C-1:

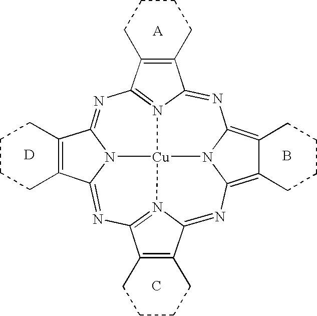

one of the rings A to D is

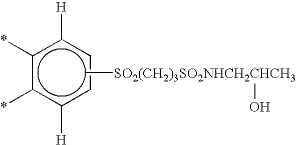

the other three rings are

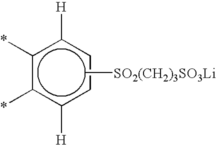

* represents the bonding positions on the phthalocyanine ring.

(Preparation of Magenta Ink M-101)

Ion exchanged water was added to the following components to make 1 liter, and the mixture was stirred for 1 hour with heating at 30° C. to 40° C. After that, the solution was filtered under reduced pressure through a micro filter having an average pore diameter of 0.25 μm to prepare magenta ink (M-101).

[Prescription of Magenta Ink M-101]

(Solids Content)

| | | |
|---|---|---|
| Magenta dye (compound MAGENTA-1 described in JP-A | 30.0 | g/liter |
| No. 2007-138124, paragraph [0887]) | | |
| PROXEL XL-2 (trade name, manufactured by Avecia | 1.0 | g/liter |
| Inkjet Limited) | | |
| Urea | 48 | g/liter |

(Liquid Components)

| | | |
|---|---|---|
| Glycerol | 84 | g/liter |
| Triethylene glycol | 122 | g/liter |
| Betaine compound (Betaine-1, described in JP-A | 17 | g/liter |
| No. 2007-138124, paragraph [0901]) | | |

(Preparation of Black Ink Bk-101)

Ion exchanged water was added to the following components to make 1 liter, and the mixture was stirred for 1 hour with heating at 30° C. to 40° C. After that, the solution was filtered under reduced pressure through a micro filter having an average pore diameter of 0.25 μm to prepare black ink (Bk-101).

[Prescription of Black Ink Bk-101]

| (Solids Content) | | |
|---|---|---|
| Black dye 1 (main dye Bk-1 for black shown below) | 62.0 | g/liter |
| Black dye 2 (complementary dye Bk-2 for black shown below) | 10.0 | g/liter |
| PROXEL XL-2 (trade name, manufactured by Avecia Inkjet Limited) | 1.0 | g/liter |
| (Liquid Components) | | |
| Glycerol | 83 | g/liter |
| Triethylene glycol | 11 | g/liter |
| Triethylene glycol monobutyl ether | 84 | g/liter |
| 1,2-Hexanediol | 16 | g/liter |
| OLFINE E1010 (trade name, manufactured by Shin-Etsu Chemical Co., Ltd.) | 10 | g/liter |

Main dye Bk-1 for black

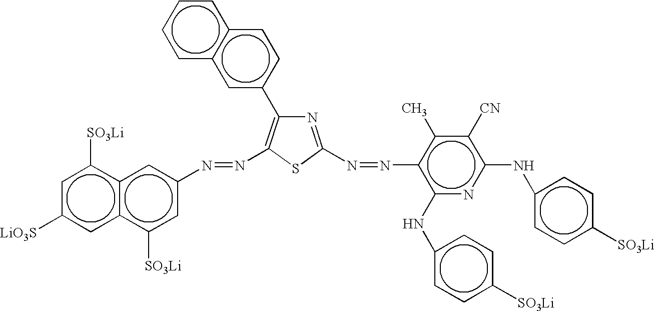

Complementary dye Bk-2 for black

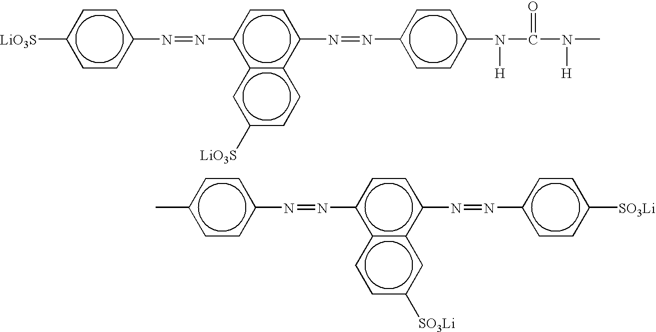

<Preparation of Ink Sets 2 to 4>

An ink set 2 was prepared in a manner similar to that in the preparation of the an ink set 1 except that, in the preparation of the ink set 1, DIRECT YELLOW 86 was used as a yellow dye.

Furthermore, an ink set 3 was prepared in a manner similar to that in the preparation of the ink set 1 except that DIRECT BLUE 86 was used as a cyan dye.

An ink set 4 was prepared in a manner similar to that in the preparation of the ink set 1 except that DIRECT RED 227 was used as a magenta dye.

### Example 1

### Preparation of Support

A wood pulp made of 100 parts of LBKP was beaten with a double disc-refiner so that the Canadian freeness may be 300 mL, followed by adding 0.5 parts of epoxidized behenic amide, 1.0 parts of anionic polyacrylamide, 0.1 parts of polyamide polyamine epichlorohydrin and 0.5 parts of cationic polyacrylamide all by absolute dry mass ratio to the pulp. A Fourdrinier paper machine was used to weight the resultant and to make base paper having basis weight of 170 g/m².

In order to adjust a surface size of the base paper, 0.04% of a fluorescent whitening agent (trade name: WHITEX BB, manufactured by Sumitomo Chemical Co., Ltd.) was added to a 4% aqueous solution of polyvinyl alcohol, followed by impregnating the solution in the base paper so as to be 0.5 g/m² in terms of the absolute dry mass, further followed by drying, still further followed by applying a calendar process, and thereby base paper of which density was adjusted to 1.05 g/cc was obtained.

After the corona discharge treatment was applied on a wire surface (back surface) side of the paper base, high-density polyethylene was coated so that a thickness thereof might be 19 μm with a melt extrusion machine, and thereby a resin layer having a matted surface was formed (hereinafter, the resin layer surface is referred to as a “back surface”). The corona discharge treatment was further applied on a resin layer on the back surface side, followed by coating, as an anti-static agent, a dispersion in which aluminum oxide (trade name: ALUMINASOL 100, manufactured by Nissan Chemical Industries Ltd) and silicon dioxide (trade name: SNOWTEX 0, manufactured by Nissan Chemical Industries Ltd) were dispersed at a mass ratio of 1:2 so that a dry mass might be 0.2 g/m².

Furthermore, a felt surface (front surface) side on a side where a resin layer was not disposed was subjected to the corona discharge treatment. Thereafter, low-density polyethylene containing 10% of anatase-type titanium dioxide, a trace of ultramarine blue, and a 0.01% (with respect to the polyethylene) of a fluorescent whitening agent, and having a MFR (melt flow rate) of 3.8 was extruded from a melt-extruder so as to be a thickness of 29 μm to form a high gloss thermoplastic resin layer onto a front surface side of the base paper (Hereinafter, the high gloss layer is called a “front surface”). In this way, a support was produced.

<Preparation of Coating Solution A for Ink receiving Layer >

(1) Particles of vapor phase process silica, (2) ion-exchanged water and (3) “SHAROLL DC902P” in a composition shown below were mixed and dispersed with a ultrasonic dispersing device (manufactured by SMT Co., Ltd.), followed by heating the dispersion to 45° C. and keeping there for 20 hr. Thereto, a solution containing (4) polyvinyl alcohol, (5) boric acid, (6) polyoxyethylene lauryl ether and (7) ion-exchanged water was added, and thereby a coating solution A for the ink receiving layer was prepared.

<Composition of Coating Solution A for Ink receiving Layer>

| | | |
|---|---|---|
| (1) | Particles of vapor-phase process silica | 10.0 parts, |
| | (inorganic particle) (trade name: AEROSIL | |
| | 300SV, manufactured by Nippon Aerosil Co., Ltd.) | |
| (2) | Ion-exchanged water | 56.0 parts, |
| (3) | “SHAROLL DC-902P” (trade name, manufactured | 0.8 parts, |
| | by Dai-ichi Kogyo Seiyaku Co., Ltd.) | |
| | (dispersant, 51% aqueous solution) | |
| (4) | 7% aqueous solution of polyvinyl alcohol | 50.8 parts, |
| | (water soluble resin) (trade name: JM33, manufactured | |
| | by The Nippon Synthetic Chemical Industry Co., Ltd., | |
| | saponification degree: 95%, average polymerization | |
| | degree: 3300) | |
| (5) | Boric acid (crosslinking agent) | 0.37 parts, |
| (6) | Polyoxyethylene lauryl ether (surfactant) | 0.6 parts, |
| | (trade name: “Emulgen 109P”, 10% aqueous solution, | |
| | HLB value: 13.6, manufactured by Kao Corporation) | |
| (7) | Ion-exchanged water | 56.0 parts |

<Preparation of Basic Coating Solution B>

(1) to (4) shown below were sequentially added and mixed while confirming of dissolution of the respective compounds, thereby a basic coating solution B was prepared.

<Composition of Basic Coating Solution B>

| | | |
|---|---|---|
| (1) | Ion-exchanged water | 86.7 parts |
| (2) | 20% aqueous solution of polyallylamine “PAAH10” | 3.3 parts |
| | (trade name, manufactured by Nittobo; | |
| | weight average molecular weight 60,000) | |
| (3) | Ammonium carbonate | 4.0 parts |
| (4) | Polyoxyethylene lauryl ether (surfactant) | 6.0 parts |
| | (trade name: EMULGEN 109P, manufactured by Kao | |
| | Corporation, 2% aqueous solution, HLB value 13.6) | |

<Preparation of Inkjet Recording Sheet>

After the corona discharge treatment was applied on a front surface of the support, the coating solution A for the colorant-receiving layer obtained above was coated on the front surface of the support with an extrusion die coater at a coating amount of 170 mL/m² and dried at 80° C. (air speed 3 msec to 8 msec) with a hot-air dryer until a solid concentration in the coated layer was 20%. The coated layer showed a constant-rate drying during the period. Immediately thereafter, the coated layer was dipped in a basic coating solution B having the above-mentioned composition for 30 sec to attach the coating solution B at an amount of 15 g/m² on the coated layer, followed by drying at 80° C. for 10 min. Thereby, a recording medium (1) having a colorant-receiving layer having a dry film thickness of 32 μm was prepared.

<Evaluation>

The resulting recording medium was evaluated as shown below. Results of evaluation are shown in Table 1 below.

(pH)

The surface pH of the ink receiving layer was measured in accordance with an A method (coating method) of surface pH measurement methods determined by Technical Association of the Pulp and Paper Industry (J. TAPPI) by use of a paper surface pH measurement set “Form MPC” (trade name, manufactured by Kyoritsu Chemical-Check Lab., Corp.).

(Printing Density)

Under an environment of 23° C. and 50% RH, by use of an inkjet printer A700 (trade name, manufactured by Epson Co., Ltd.), the above-obtained ink set 1 was used to print a solid image of each of yellow (Y), magenta (M), cyan (C) and black (K) on the above-obtained recording medium (1), followed by measuring the optical density (O.D.) using a reflection densitometer (trade name: XRITE 938, manufactured by Xrite Inc.).

(Color Drift)

The color drift (discoloration) was evaluated as shown below. Under an environment of 23° C. and 50% RH, by use of an inkjet printer A700 (trade name, manufactured by Epson Co., Ltd.), the above-obtained ink set 1 was used to print a grey solid image on the obtained recording medium (1) by controlling a tone of image data so that dry reflection density might be 1.0±0.1. Hue (L*a*b*) immediately after printing (within 1 min) was measured using SPECTROLINO (trade name, manufactured by Gretag Macbeth) under an observation condition (light source: F8, viewing angle: 2°. Furthermore, after the printed recording medium was dried for 24 hr under an environment of 23° C. and 50% RH, hue after 24 hr was measured. Color difference (ΔE) was calculated as a difference of hue immediately after printing and hue after 24 hr and the color difference was taken as color drift.

(Bronzing)

Bronzing was evaluated as shown below.

The obtained recording medium (1) was humidity-conditioned under 23° C. and 80% RH for 16 hr, thereafter, under the environment of 23° C. and 80% RH, by use of an inkjet printer A700 (trade name, manufactured by Epson Co., Ltd.), the above-obtained ink set 1 was used to print a cyan solid image on the recording medium (1) by controlling a tone of image data so that dry reflection density might be 1.0±0.1.

Thereafter, whether bronze gloss was generated in a cyan solid part or not was visually observed, followed by judging based on criteria shown below.

### ˜Evaluation Criteria˜

A: Bronze gloss is not at all generated.
B: Bronze gloss is generated at a hardly conspicuous and not-practically problematic level.
C: Bronze gloss is generated at a practically problematic level.
D: Bronze gloss is generated and glossiness is deteriorated.

### Example 2

A recording medium (2) was prepared in a manner substantially similar to that in Example 1 except that in the preparation of the recording medium of Example 1, the polyallylamine derivative added to the basic coating solution B was changed to PAA03 (trade name, manufactured by Nittobo, weight-average molecular weight: 3,000), followed by evaluating similarly using the ink set 1.

### Example 3

A recording medium (3) was prepared in a manner substantially similar to that in Example 1 except that in the preparation of the recording medium of Example 1, the polyallylamine derivative added to the basic coating solution B was changed to PAA01 (trade name, manufactured by Nittobo, polyallylamine, weight-average molecular weight: 1,000), followed by evaluating similarly using the ink set 1.

### Example 4

A recording medium (4) was prepared in a manner substantially similar to that in Example 1 except that in the preparation of the recording medium of Example 1, the polyallylamine derivative added to the basic coating solution B was changed to PAA005 (trade name, manufactured by Nittobo, polyallylamine, weight-average molecular weight: 500), followed by evaluating similarly using the ink set 1.

### Example 5

A recording medium (5) was prepared in a manner substantially similar to that in Example 1 except that in the preparation of the recording medium of Example 1, the polyallylamine derivative added to the basic coating solution B was changed to PAA1112 (trade name, manufactured by Nittobo, allylamine-dimethylallylamine copolymer, weight-average molecular weight: 1,000), followed by evaluating similarly using the ink set 1.

### Comparative Example 1

A recording medium (6) was prepared in a manner substantially similar to that in Example 1 except that in the preparation of the recording medium of Example 1, in place of the polyallylamine derivative added to the basic coating solution B, polydiallyldimethyl ammonium chloride (weight-average molecular weight: 9,000, manufactured by Dai-ichi Kogyo Seiyaku Co., Ltd.) was used, followed by evaluating similarly using the ink set 1.

### Comparative Example 2

A recording medium (7) was prepared in a manner substantially similar to that in Example 1 except that in the preparation of the recording medium of Example 1, in place of the polyallylamine derivative added to the basic coating solution B, ZIRCOSOL AC-7 (trade name, manufactured by Daiichi Kigenso Kagaku Kogyo Co., Ltd., ammonium zirconyl carbonate) was used, followed by evaluating similarly using the ink set 1.

### Comparative Example 3

Evaluation was conducted in a manner substantially similar to that in Example 2 except that in place of the ink set 1 in Example 2, the ink set 2 was used.

### Comparative Example 4

Evaluation was conducted in a manner substantially similar to that in Example 2 except that in place of the ink set 1 in Example 2, the ink set 3 was used.

### Comparative Example 5

Evaluation was conducted in a manner substantially similar to that in Example 2 except that in place of the ink set 1 in Example 2, the ink set 4 was used.

### Comparative Example 6

A recording medium (8) was prepared in a manner substantially similar to that in Example 1 except that in the preparation of the recording medium of Example 1, the polyallylamine derivative was not added to the basic coating solution B, followed by evaluating similarly using the ink set 1.

TABLE 1

| | | Recording Medium | | | | | | | | | | |
|---|---|---|---|---|---|---|---|---|---|---|---|---|
| | | | Mordant | | | | | | | | | |
| | Ink Set | | | Molecular | Content | | Print Density | | | | Color | Bronze |
| | No. | No. | Kind | Weight | (g/m²) | pH | Y | M | C | K | Drift | Gloss |
| Example 1 | 1 | (1) | Polyallylamine | 60,000 | 0.1 | 5.7 | 2.08 | 2.18 | 2.15 | 2.46 | 2.2 | C |
| Example 2 | 1 | (2) | Polyallylamine | 3,000 | 0.1 | 5.7 | 2.06 | 2.16 | 2.20 | 2.47 | 2.5 | B |
| Example 3 | 1 | (3) | Polyallylamine | 1,000 | 0.1 | 5.6 | 2.05 | 2.16 | 2.19 | 2.41 | 2.6 | A |
| Example 4 | 1 | (4) | Polyallylamine | 500 | 0.1 | 5.8 | 2.06 | 2.14 | 2.20 | 2.43 | 3.0 | A |
| Example 5 | 1 | (5) | Allylamine/dimethylallyl- | 1,000 | 0.1 | 6.6 | 2.02 | 2.15 | 2.21 | 2.45 | 2.0 | A |
| | | | amine copolymer | | | | | | | | | |
| Comparative | 1 | (6) | Polydiallyldimethyl | 9,000 | 0.1 | 4.7 | 1.82 | 1.91 | 2.13 | 2.31 | 6.0 | B |
| Example 1 | | | ammonium chloride | | | | | | | | | |
| Comparative | 1 | (7) | Ammonium zirconyl | — | 0.1 | 5.0 | 1.86 | 1.99 | 2.10 | 2.30 | 6.5 | A |
| Example 2 | | | carbonate | | | | | | | | | |
| Comparative | 2 | (2) | Polyallylamine | 3,000 | 0.1 | 5.7 | 1.73 | 2.16 | 2.20 | 2.47 | 8.0 | B |
| Example 3 | | | | | | | | | | | | |
| Comparative | 3 | (2) | Polyallylamine | 3,000 | 0.1 | 5.7 | 2.06 | 2.16 | 1.90 | 2.47 | 4.5 | B |
| Example 4 | | | | | | | | | | | | |
| Comparative | 4 | (2) | Polyallylamine | 3,000 | 0.1 | 5.7 | 2.06 | 1.81 | 2.20 | 2.47 | 4.5 | B |
| Example 5 | | | | | | | | | | | | |
| Comparative | 1 | (8) | — | — | — | 4.5 | 1.86 | 1.93 | 2.12 | 2.34 | 7.0 | A |
| Example 6 | | | | | | | | | | | | |

From Table 1, it is found that in an inkjet recording method of the invention, an image density is high and discoloration after image recording is inhibited from occurring.

According to the invention, an inkjet recording method that is high in the image density and capable of inhibiting discoloration (color drift) after image recording from occurring may be provided.

The present invention may namely provide the following items <1> to <13>:

<1> An inkjet recording method including recording an image, on a recording medium containing a support and an ink receiving layer that is disposed on the support and contains a polyallylamine derivative, by imparting a yellow ink that contains a water soluble azo dye represented by the following Formula (Y-I) in an amount of 50% by mass or more with respect to a total amount of yellow dye in the yellow ink by use of an inkjet method.

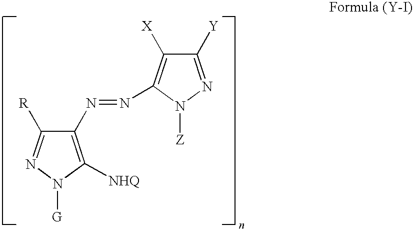

In Formula (Y-I), G represents a heterocyclic group; R, X, Y, Z and Q each independently represent a substituent; n represents an integer of 1 to 3; in a case where n is 1, R, X, Y, Z, Q and G each independently represent a monovalent substituent; in a case where n is 2, R, X, Y, Z, Q and G each independently represent a monovalent substituent or a divalent substituent, provided that at least one of R, X, Y, Z, Q and G represents a divalent substituent; and in a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

<2> The inkjet recording method of the item <1>, wherein the recording includes recording an image by use of an ink set that contains: the yellow ink; a cyan ink that contains a water soluble phthalocyanine dye represented by the following Formula (C-I) in an amount of 50% by mass or more with respect to a total amount of cyan dye in the cyan ink;

a magenta ink that contains a water soluble azo dye represented by the following Formula (M-I) in an amount of 50% by mass or more with respect to a total amount of magenta dye in the magenta ink; and

a black ink that contains a water soluble azo dye represented by the following Formula (B-I) in an amount of 50% by mass or more with respect to a total amount of black dye in the black ink.

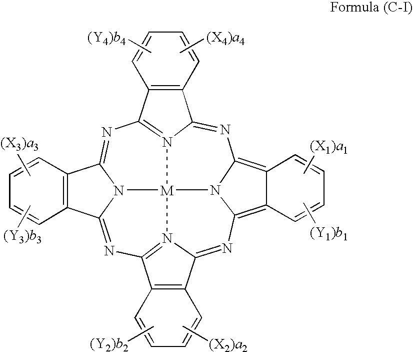

In Formula (C-I), each of X₁, X₂, X₃ and X₄ independently represents any of —SO-Z, —SO₂-Z, —SO₂NV₁V₂, —CONV₁V₂, —CO₂Z, —CO-Z, or a sulfo group; Z independently represents an alkyl group, a cycloalkyl group, an alkenyl group, an alkynyl group, an aralkyl group, an aryl group, or a heterocyclic group; V₁ and V₂, which may be the same or different, each represent a hydrogen atom, an alkyl group, a cycloalkyl group, an alkenyl group, an alkynyl group, an aralkyl group, an aryl group, or a heterocyclic group; each of Y₁, Y₂, Y₃ and Y₄ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, of which each group may further have a substituent; a₁ to a₄ and b₁ to b₄ respectively represent numbers of substituents of X₁ to X₄ and Y₁ to Y₄; each of a₁ to a₄ independently representing an integer of from 0 to 4, provided that all of a₁ to a₄ do not represent 0 at the same time, and each of b₁ to b₄ independently representing an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent.

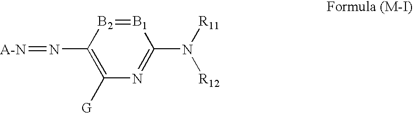

In Formula (M-I), A represents a residue of a 5-membered heterocyclic diazo component A-NH₂; each of B₁ and B₂ independently represents —CR₁₃═ or —CR₁₄═, or either one represents a nitrogen atom and the other represents —CR₁₃═ or —CR₁₄═; each of R₁₁ and R₁₂ independently represents a hydrogen atom, an alkyl group, a cycloalkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, an arylsulfonyl group, or a sulfamoyl group, of which each group may further have a substituent; each of G, R₁₃ and R₁₄ independently represents a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, a nitro group, an alkylthio group, an arylthio group, an alkylsulfonyl group, an arylsulfonyl group, an alkylsulfinyl group, an arylsulfinyl group, a sulfamoyl group, a heterocyclic thio group, or an ionic hydrophilic group, of which each group may further have a substituent; and R₁₃ and R₁₁, or R₁₁ and R₁₂ may be bonded each other to form a 5- or 6-membered ring, provided that the dye represented by Formula (M-I) has at least one ionic hydrophilic group.

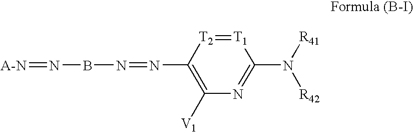

In Formula (B-I), A represents a monovalent aromatic group or heterocyclic group, and B represents a divalent aromatic group or heterocyclic group; T₁ and T₂ each independently represent ═CR₄₃— or —CR₄₄═, or either one of them represents a nitrogen atom and the other one represents ═CR₄₃— or —CR₄₄═; V₁, R₄₃, and R₄₄ each independently represent a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, a heterocyclic oxycarbonyl group, an acyl group, a hydroxy group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an alkylamino group, an arylamino group, and a heterocyclic amino group), an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfo group, of which each group may be further substituted; R₄₁ and R₄₂ each independently represent a hydrogen atom, an alkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, arylsulfonyl group, or a sulfamoyl group, of which each group may further have a substituent; R₄₁ and R₄₂ are not simultaneously hydrogen atoms; and R₄₃ and R₄₁ or R₄₁ and R₄₂ may be bonded to each other to form a 5- to 6-membered ring.

<3> The inkjet recording method of the items <1> or <2>, wherein the polyallylamine derivative comprises a structural unit derived from allylamine and a structural unit derived from dialkylallylamine.

<4> The inkjet recording method of any one of the items <1> to <3>, wherein a weight-average molecular weight of the polyallylamine derivative is 2,000 or less.

<5> The inkjet recording method of any one of the items <1> to <4>, wherein a content of the polyallylamine derivative in the ink receiving layer is in a range of from 0.01 g/m² to 2 g/m².

<6> The inkjet recording method of any one of the items <1> to <5>, wherein an oxidation potential of the water soluble azo dye represented by Formula (Y-I) is more noble than 1.0 V (vs SCE).

<7> The inkjet recording method of item <2>, wherein an oxidation potential of each of the water soluble phthalocyanine dye represented by Formula (C-I), the water soluble azo dye represented by Formula (M-I) and the water soluble azo dye represented by Formula (B-I) is more noble than 1.0 V (vs SCE).

<8> The inkjet recording method of any one of the items <1> to <7>, wherein, in Formula (Y-I), G represents a group derived from an S-triazine ring, a pyrimidine ring, a pyridazine ring, or a pyrazine ring; R represents a straight chain or branched alkyl group having 1 to 8 carbon atoms; X represents a cyano group or an alkylsulfonyl group having 1 to 12 carbon atoms; Y represents a hydrogen atom or a straight chain or branched alkyl group having 1 to 8 carbon atoms; Z represents a substituted aryl group or a substituted heterocyclic group; Q represents a hydrogen atom, a substituted or unsubstituted alkyl group or a substituted or unsubstituted acyl group; and n represents 1 or 2.

<9> The inkjet recording method of any one of the items <1> to <8>, wherein a surface tension of the yellow ink at 20° C. is in a range of 20 mN/m to 70 mN/m.

<10> The inkjet recording method of item <2>, wherein Formula (C-I) is the following Formula (C-1).

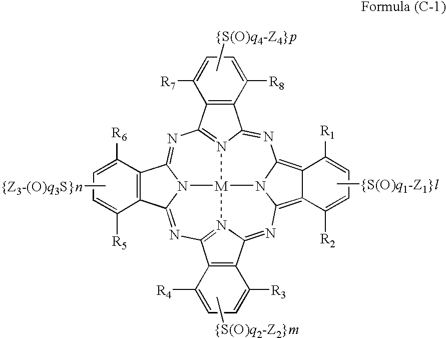

In Formula (C-1), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃ or Z₄ has an ionic hydrophilic group as a substituent; each of l, m, n, p, q₁, q₂, q₃ and q₄ independently represents 1 or 2; and M has the same meaning as in Formula (C-I).

<11> The inkjet recording method of item <2>, wherein Formula (M-I) is the following Formula (M-1).

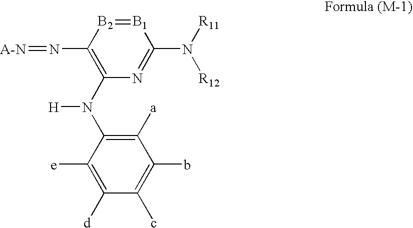

In Formula (M-1), A, B₁, B₂, R₁₁ and R₁₂ each have the same meaning as A, B₁, B₂, R₁₁ and R₁₂ in Formula (M-I) respectively; each of a and e independently represents an alkyl group, an alkoxy group or a halogen atom, and in a case where both a and e represent an alkyl group, the total number of carbon atoms constituting the alkyl groups represented by a and e is 3 or more, which may further be substituted; each of b, c and d independently has the same meaning as R₁₁ and R₁₂ in Formula (M-I); and a and b, or e and d may be condensed to each other, provided that the dye represented by Formula (M-1) has at least one ionic hydrophilic group.

<12> The inkjet recording method of any one of the items <1> to <11>, wherein 50% by mass or more of the total amount of the polyallylamine derivative is contained in a region of the ink receiving layer extending to a depth of 10 μm from a surface of the ink receiving layer.

<13> The inkjet recording method of any one of the items <1> to <12>, wherein the recording medium is produced according to a producing method that includes: coating a coating solution containing fine particles and a water soluble resin on the support; and coating a basic coating solution containing the polyallylamine derivative on the coated layer either (1) simultaneously with coating of the coating solution or (2) during drying of the coating solution coated on the support before a decreasing rate of drying exhibited.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording method comprising recording an image, on a recording medium containing a support and an ink receiving layer that is disposed on the support and contains a polyallylamine derivative, by imparting a yellow ink that contains a water soluble azo dye represented by the following Formula (Y-I) in an amount of 50% by mass or more with respect to a total amount of yellow dye in the yellow ink by use of an inkjet method: 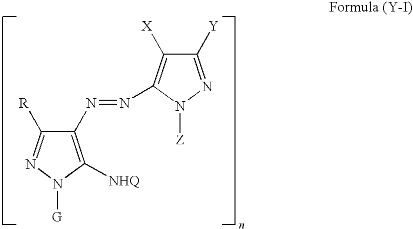
wherein, in Formula (Y-I), G represents a heterocyclic group; R, X, Y, Z and Q each independently represent a substituent; n represents an integer of 1 to 3; in a case where n is 1, R, X, Y, Z, Q and G each independently represent a monovalent substituent; in a case where n is 2, R, X, Y, Z, Q and G each independently represent a monovalent substituent or a divalent substituent, provided that at least one of R, X, Y, Z, Q and G represents a divalent substituent; and in a case where n is 3, R, X, Y, Z, Q and G each independently represent a monovalent substituent, a divalent substituent or a trivalent substituent, provided that at least two of R, X, Y, Z, Q and G represent a divalent substituent or at least one of R, X, Y, Z, Q and G represents a trivalent substituent.

2. The inkjet recording method of claim 1, wherein the recording includes recording an image by use of an ink set that contains:
the yellow ink;
a cyan ink that contains a water soluble phthalocyanine dye represented by the following Formula (C-I) in an amount of 50% by mass or more with respect to a total amount of cyan dye in the cyan ink;
a magenta ink that contains a water soluble azo dye represented by the following Formula (M-I) in an amount of 50% by mass or more with respect to a total amount of magenta dye in the magenta ink; and
a black ink that contains a water soluble azo dye represented by the following Formula (B-I) in an amount of 50% by mass or more with respect to a total amount of black dye in the black ink: 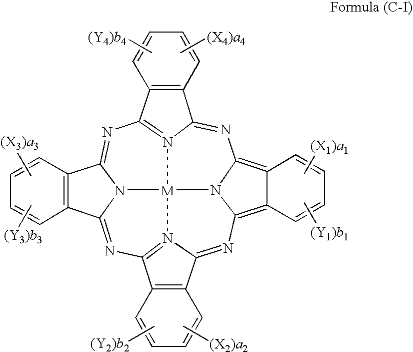
wherein, in Formula (C-I), each of X₁, X₂, X₃ and X₄ independently represents any of —SO-Z, —SO₂-Z, —SO₂NV₁V₂, —CONV₁V₂, —CO₂Z, —CO-Z, or a sulfo group; Z independently represents an alkyl group, a cycloalkyl group, an alkenyl group, an alkynyl group, an aralkyl group, an aryl group, or a heterocyclic group; V₁ and V₂, which may be the same or different, each represent a hydrogen atom, an alkyl group, a cycloalkyl group, an alkenyl group, an alkynyl group, an aralkyl group, an aryl group, or a heterocyclic group;
each of Y₁, Y₂, Y₃ and Y₄ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, of which each group may further have a substituent; a₁ to a₄ and b₁ to b₄ respectively represent numbers of substituents of X₁ to X₄ and Y₁ to Y₄, each of a₁ to a₄ independently representing an integer of from 0 to 4, provided that all of a₁ to a₄ do not represent 0 at the same time, and each of b₁ to b₄ independently representing an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent; 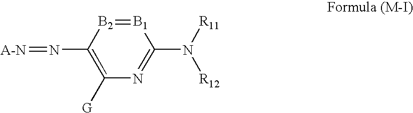
wherein, in Formula (M-I), A represents a residue of a 5-membered heterocyclic diazo component A-NH₂; each of B₁ and B₂ independently represents —CR₁₃═ or —CR₁₄═, or either one represents a nitrogen atom and the other represents —CR₁₃═ or —CR₁₄═; each of R₁₁ and R₁₂ independently represents a hydrogen atom, an alkyl group, a cycloalkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, an arylsulfonyl group, or a sulfamoyl group, of which each group may further have a substituent; each of G, R₁₃ and R₁₄ independently represents a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, an acyl group, a hydroxy group, an alkoxy group, an aryloxy group, a silyloxy group, an acyloxy group, a carbamoyloxy group, a heterocyclic oxy group, an alkoxycarbonyloxy group, an aryloxycarbonyloxy group, an amino group substituted by an alkyl group or an aryl group or a heterocyclic group, an acylamino group, a ureido group, a sulfamoylamino group, an alkoxycarbonylamino group, an aryloxycarbonylamino group, an alkylsulfonylamino group, an arylsulfonylamino group, a nitro group, an alkylthio group, an arylthio group, an alkylsulfonyl group, an arylsulfonyl group, an alkylsulfinyl group, an arylsulfinyl group, a sulfamoyl group, a heterocyclic thio group, or an ionic hydrophilic group, of which each group may further have a substituent; and R₁₃ and R₁₁, or R₁₁ and R₁₂ may be bonded each other to form a 5- or 6-membered ring, provided that the dye represented by Formula (M-I) has at least one ionic hydrophilic group; 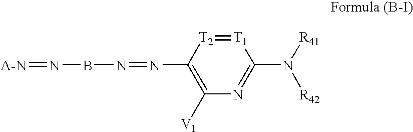
wherein, in Formula (B-I), A represents a monovalent aromatic group or heterocyclic group, and B represents a divalent aromatic group or heterocyclic group; T₁ and T₂ each independently represent ═CR₄₃— or —CR₄₄═, or either one of them represents a nitrogen atom and the other one represents ═CR₄₃— or —CR₄₄═; V₁, R₄₃, and R₄₄ each independently represent a hydrogen atom, a halogen atom, an alkyl group, an alkenyl group, an alkynyl group, an aralkyl group, an aryl group, a heterocyclic group, a cyano group, a carboxy group, a carbamoyl group, an alkoxycarbonyl group, an aryloxycarbonyl group, a heterocyclic oxycarbonyl group, an acyl group, a hydroxy group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an alkylamino group, an arylamino group, and a heterocyclic amino group), an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfo group, of which each group may be further substituted; R₄₁ and R₄₂ each independently represent a hydrogen atom, an alkyl group, an alkenyl group, an alkynyl group, an aralkyl group, an aryl group, a heterocyclic group, an acyl group, an alkoxycarbonyl group, an aryloxycarbonyl group, a carbamoyl group, an alkylsulfonyl group, arylsulfonyl group, or a sulfamoyl group, of which each group may further have a substituent; R₄₁ and R₄₂ are not simultaneously hydrogen atoms; and R₄₃ and R₄₁, or R₄₁ and R₄₂ may be bonded to each other to form a 5- to 6-membered ring.

3. The inkjet recording method of claim 1, wherein the polyallylamine derivative comprises a structural unit derived from allylamine and a structural unit derived from dialkylallylamine.

4. The inkjet recording method of claim 1, wherein a weight-average molecular weight of the polyallylamine derivative is 2,000 or less.

5. The inkjet recording method of claim 1, wherein a content of the polyallylamine derivative in the ink receiving layer is in a range of from 0.01 g/m² to 2 g/m²

6. The inkjet recording method of claim 1, wherein an oxidation potential of the water soluble azo dye represented by Formula (Y-I) is more noble than 1.0 V (vs SCE).

7. The inkjet recording method of claim 2, wherein an oxidation potential of each of the water soluble phthalocyanine dye represented by Formula (C-I), the water soluble azo dye represented by Formula (M-I) and the water soluble azo dye represented by Formula (B-I) is more noble than 1.0 V (vs SCE).

8. The inkjet recording method of claim 1, wherein, in Formula (Y-I), G represents a group derived from an S-triazine ring, a pyrimidine ring, a pyridazine ring, or a pyrazine ring; R represents a straight chain or branched alkyl group having 1 to 8 carbon atoms; X represents a cyano group or an alkylsulfonyl group having 1 to 12 carbon atoms; Y represents a hydrogen atom or a straight chain or branched alkyl group having 1 to 8 carbon atoms; Z represents a substituted aryl group or a substituted heterocyclic group; Q represents a hydrogen atom, a substituted or unsubstituted alkyl group or a substituted or unsubstituted acyl group; and n represents 1 or 2.

9. The inkjet recording method of claim 1, wherein a surface tension of the yellow ink at 20° C. is in a range of 20 mN/m to 70 mN/m.

10. The inkjet recording method of claim 2, wherein Formula (C-I) is the following Formula (C-1); 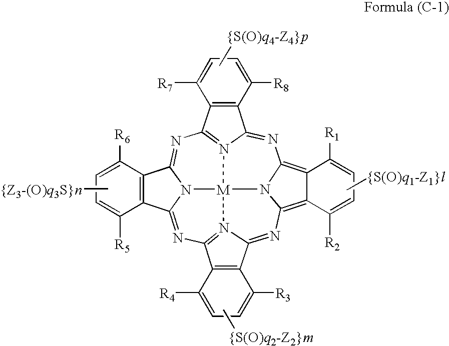
wherein in Formula (C-1), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃ or Z₄ has an ionic hydrophilic group as a substituent; each of l, m, n, p, q₁, q₂, q₃ and q₄ independently represents 1 or 2; and M has the same meaning as in Formula (C-I).

11. The inkjet recording method of claim 2, wherein Formula (M-I) is the following Formula (M-1); 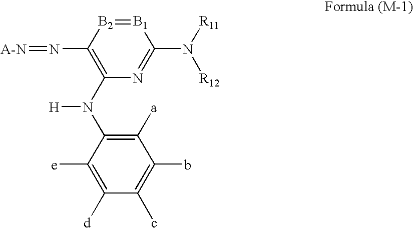
wherein, in Formula (M-1), A, B₁, B₂, R₁₁ and R₁₂ each have the same meaning as A, B₁, B₂, R₁₁ and R₁₂ in Formula (M-I) respectively; each of a and e independently represents an alkyl group, an alkoxy group or a halogen atom, and in a case where both a and e represent an alkyl group, the total number of carbon atoms constituting the alkyl groups represented by a and e is 3 or more, which may further be substituted; each of b, c and d independently has the same meaning as R₁₁ and R₁₂ in Formula (M-I); and a and b, or e and d may be condensed to each other, provided that the dye represented by Formula (M-1) has at least one ionic hydrophilic group.

12. The inkjet recording method of claim 1, wherein 50% by mass or more of the total amount of the polyallylamine derivative is contained in a region of the ink receiving layer extending to a depth of 10 μm from a surface of the ink receiving layer.

13. The inkjet recording method of claim 1, wherein the recording medium is produced according to a producing method that includes:
coating a coating solution containing fine particles and a water soluble resin on the support; and
coating a basic coating solution containing the polyallylamine derivative on the coated layer either (1) simultaneously with coating of the coating solution or (2) during drying of the coating solution coated on the support before a decreasing rate of drying is exhibited.
